(19) United States
(12) Patent Application Publication
(10) Pub. No.: US 2026/0267582 A1
(43) Pub. Date: Sep. 10, 2026

(54) MANAGING AN ENVIRONMENT

(71) Applicant: APPLE INC., Cupertino, CA (US)

(72) Inventors: Vincenzo O. GIULIANI, Thousand Oaks, CA (US); Joshua D. DEITEL, San Francisco, CA (US); Mischa K. MCLACHLAN, San Francisco, CA (US); Sung Min K. ARENA, Mill Valley, CA (US); William N. DANNER, Santa Cruz, CA (US)

(21) Appl. No.: 19/462,324

(22) Filed: Jan. 28, 2026

Related U.S. Application Data
(60) Provisional application No. 63/751,258, filed on Jan. 29, 2025.
(60) Provisional application No. 63/754,560, filed on Feb. 6, 2025.
(60) Provisional application No. 63/870,781, filed on Aug. 26, 2025.

(51) Int. Cl. G06F 3/14

(52) U.S. Cl. CPC G06F 3/14

(57) ABSTRACT

The present disclosure generally relates to managing an environment. Some techniques are for providing guest access to an environment while on a call in accordance with some embodiments. Other techniques are for displaying status of an environment in accordance with some embodiments. Other techniques are for providing access to accessories in an environment in accordance with some embodiments. Other techniques are for displaying a live feed of various cameras in accordance with some embodiments. Other techniques are for assisting a subject with an authentication process in accordance with some embodiments. Other techniques are for initiating an automation in accordance with some embodiments.

### CROSS-REFERENCE TO RELATED APPLICATIONS

This application claims priority to U.S. Provisional Patent Application Ser. No. 63/870,781, entitled “MANAGING AN ENVIRONMENT” filed Aug. 26, 2025, and to U.S. Provisional Patent Application Ser. No. 63/754,560, entitled “MANAGING AN ENVIRONMENT” filed Feb. 6, 2025, and to U.S. Provisional Patent Application Ser. No. 63/751,258, entitled “MANAGING AN ENVIRONMENT” filed Jan. 29, 2025. The content of these applications is hereby incorporated by reference in their entirety.

### BACKGROUND

Homes are becoming increasingly populated with devices. For example, devices are often utilized to increase security and/or provide monitoring of a home. Handling alerts and/or configuring security permissions is difficult as devices often require separate applications that can be cumbersome. Thus, there is a need to improve techniques for managing an environment.

### SUMMARY

Some techniques described herein enable electronic devices to be faster, more efficient, and/or more effective for managing an environment. Such techniques can replace and/or work in conjunction with existing techniques for managing an environment.

In some embodiments, a method that is performed at a first computer system that is in communication with one or more output devices and one or more input devices is described. In some embodiments, the method comprises: displaying, via the one or more output devices, a call user interface corresponding to a connection with a second computer system external to the first computer system, wherein the call user interface includes a user interface element for providing guest access to an environment; detecting, via the one or more input devices, a set of one or more inputs that includes: a first input that corresponds to a request to provide a respective level of guest access to the environment; and a second input that is directed to the user interface element for providing guest access to the environment; and in response to detecting the set of one or more inputs: in accordance with a determination that the respective level of guest access to the environment is a first level of guest access to the environment, providing the first level of guest access to the environment; and in accordance with a determination that the respective level of guest access to the environment is a second level of guest access to the environment, providing the second level of guest access to the environment, wherein the second level of guest access to the environment is different from the first level of guest access to the environment.

In some embodiments, a non-transitory computer-readable storage medium storing one or more programs configured to be executed by one or more processors of a first computer system that is in communication with one or more output devices and one or more input devices is described. In some embodiments, the one or more programs includes instructions for: displaying, via the one or more output devices, a call user interface corresponding to a connection with a second computer system external to the first computer system, wherein the call user interface includes a user interface element for providing guest access to an environment; detecting, via the one or more input devices, a set of one or more inputs that includes: a first input that corresponds to a request to provide a respective level of guest access to the environment; and a second input that is directed to the user interface element for providing guest access to the environment; and in response to detecting the set of one or more inputs: in accordance with a determination that the respective level of guest access to the environment is a first level of guest access to the environment, providing the first level of guest access to the environment; and in accordance with a determination that the respective level of guest access to the environment is a second level of guest access to the environment, providing the second level of guest access to the environment, wherein the second level of guest access to the environment is different from the first level of guest access to the environment.

In some embodiments, a transitory computer-readable storage medium storing one or more programs configured to be executed by one or more processors of a first computer system that is in communication with one or more output devices and one or more input devices is described. In some embodiments, the one or more programs includes instructions for: displaying, via the one or more output devices, a call user interface corresponding to a connection with a second computer system external to the first computer system, wherein the call user interface includes a user interface element for providing guest access to an environment; detecting, via the one or more input devices, a set of one or more inputs that includes: a first input that corresponds to a request to provide a respective level of guest access to the environment; and a second input that is directed to the user interface element for providing guest access to the environment; and in response to detecting the set of one or more inputs: in accordance with a determination that the respective level of guest access to the environment is a first level of guest access to the environment, providing the first level of guest access to the environment; and in accordance with a determination that the respective level of guest access to the environment is a second level of guest access to the environment, providing the second level of guest access to the environment, wherein the second level of guest access to the environment is different from the first level of guest access to the environment.

In some embodiments, a first computer system configured to communicate with one or more output devices and one or more input devices is described. In some embodiments, the first computer system comprises one or more processors and memory storing one or more programs configured to be executed by the one or more processors. In some embodiments, the one or more programs includes instructions for: displaying, via the one or more output devices, a call user interface corresponding to a connection with a second computer system external to the first computer system, wherein the call user interface includes a user interface element for providing guest access to an environment; detecting, via the one or more input devices, a set of one or more inputs that includes: a first input that corresponds to a request to provide a respective level of guest access to the environment; and a second input that is directed to the user interface element for providing guest access to the environment; and in response to detecting the set of one or more inputs: in accordance with a determination that the respective level of guest access to the environment is a first level of guest access to the environment, providing the first level of guest access to the environment; and in accordance with a determination that the respective level of guest access to the environment is a second level of guest access to the environment, providing the second level of guest access to the environment, wherein the second level of guest access to the environment is different from the first level of guest access to the environment.

In some embodiments, a first computer system configured to communicate with one or more output devices and one or more input devices is described. In some embodiments, the first computer system comprises means for performing each of the following steps: displaying, via the one or more output devices, a call user interface corresponding to a connection with a second computer system external to the first computer system, wherein the call user interface includes a user interface element for providing guest access to an environment; detecting, via the one or more input devices, a set of one or more inputs that includes: a first input that corresponds to a request to provide a respective level of guest access to the environment; and a second input that is directed to the user interface element for providing guest access to the environment; and in response to detecting the set of one or more inputs: in accordance with a determination that the respective level of guest access to the environment is a first level of guest access to the environment, providing the first level of guest access to the environment; and in accordance with a determination that the respective level of guest access to the environment is a second level of guest access to the environment, providing the second level of guest access to the environment, wherein the second level of guest access to the environment is different from the first level of guest access to the environment.

In some embodiments, a computer program product is described. In some embodiments, the computer program product comprises one or more programs configured to be executed by one or more processors of a first computer system that is in communication with one or more output devices and one or more input devices. In some embodiments, the one or more programs include instructions for: displaying, via the one or more output devices, a call user interface corresponding to a connection with a second computer system external to the first computer system, wherein the call user interface includes a user interface element for providing guest access to an environment; detecting, via the one or more input devices, a set of one or more inputs that includes: a first input that corresponds to a request to provide a respective level of guest access to the environment; and a second input that is directed to the user interface element for providing guest access to the environment; and in response to detecting the set of one or more inputs: in accordance with a determination that the respective level of guest access to the environment is a first level of guest access to the environment, providing the first level of guest access to the environment; and in accordance with a determination that the respective level of guest access to the environment is a second level of guest access to the environment, providing the second level of guest access to the environment, wherein the second level of guest access to the environment is different from the first level of guest access to the environment.

In some embodiments, a method that is performed at a computer system is described. In some embodiments, the method comprises: detecting that a set of one or more subjects has left an environment; and in response to detecting that the set of one or more subjects has left the environment: in accordance with a determination that a subject is not detected in the environment, outputting a notification corresponding to the environment; and in accordance with a determination that a subject is detected in the environment, forgoing output of the notification corresponding to the environment.

In some embodiments, a non-transitory computer-readable storage medium storing one or more programs configured to be executed by one or more processors of a computer system is described. In some embodiments, the one or more programs includes instructions for: detecting that a set of one or more subjects has left an environment; and in response to detecting that the set of one or more subjects has left the environment: in accordance with a determination that a subject is not detected in the environment, outputting a notification corresponding to the environment; and in accordance with a determination that a subject is detected in the environment, forgoing output of the notification corresponding to the environment.

In some embodiments, a transitory computer-readable storage medium storing one or more programs configured to be executed by one or more processors of a computer system is described. In some embodiments, the one or more programs includes instructions for: detecting that a set of one or more subjects has left an environment; and in response to detecting that the set of one or more subjects has left the environment: in accordance with a determination that a subject is not detected in the environment, outputting a notification corresponding to the environment; and in accordance with a determination that a subject is detected in the environment, forgoing output of the notification corresponding to the environment.

In some embodiments, a computer system is described. In some embodiments, the computer system comprises one or more processors and memory storing one or more programs configured to be executed by the one or more processors. In some embodiments, the one or more programs includes instructions for: detecting that a set of one or more subjects has left an environment; and in response to detecting that the set of one or more subjects has left the environment: in accordance with a determination that a subject is not detected in the environment, outputting a notification corresponding to the environment; and in accordance with a determination that a subject is detected in the environment, forgoing output of the notification corresponding to the environment.

In some embodiments, a computer system is described. In some embodiments, the computer system comprises means for performing each of the following steps: detecting that a set of one or more subjects has left an environment; and in response to detecting that the set of one or more subjects has left the environment: in accordance with a determination that a subject is not detected in the environment, outputting a notification corresponding to the environment; and in accordance with a determination that a subject is detected in the environment, forgoing output of the notification corresponding to the environment.

In some embodiments, a computer program product is described. In some embodiments, the computer program product comprises one or more programs configured to be executed by one or more processors of a computer system. In some embodiments, the one or more programs include instructions for: detecting that a set of one or more subjects has left an environment; and in response to detecting that the set of one or more subjects has left the environment: in accordance with a determination that a subject is not detected in the environment, outputting a notification corresponding to the environment; and in accordance with a determination that a subject is detected in the environment, forgoing output of the notification corresponding to the environment.

In some embodiments, a method that is performed at a computer system that is in communication with one or more input devices and one or more output devices including one or more display components is described. In some embodiments, the method comprises: displaying, via the one or more display components, a call user interface corresponding to a connection with a resource for emergency assistance; while displaying the call user interface corresponding to the connection with the resource for emergency assistance, outputting, via the one or more output devices, a prompt to share access to one or more other computer systems with the resource for emergency assistance; in conjunction with outputting the prompt, detecting, via the one or more input devices, an input corresponding to a request to share access to one or more other computer systems with the resource for emergency assistance; and in response to detecting the input corresponding to the request to share access to one or more other computer systems with the resource for emergency assistance, sharing, to the resource for emergency assistance, access to a respective set of one or more other computer systems, wherein the respective set of one or more other computer systems do not include the computer system.

In some embodiments, a non-transitory computer-readable storage medium storing one or more programs configured to be executed by one or more processors of a computer system that is in communication with one or more input devices and one or more output devices including one or more display components is described. In some embodiments, the one or more programs includes instructions for: displaying, via the one or more display components, a call user interface corresponding to a connection with a resource for emergency assistance; while displaying the call user interface corresponding to the connection with the resource for emergency assistance, outputting, via the one or more output devices, a prompt to share access to one or more other computer systems with the resource for emergency assistance; in conjunction with outputting the prompt, detecting, via the one or more input devices, an input corresponding to a request to share access to one or more other computer systems with the resource for emergency assistance; and in response to detecting the input corresponding to the request to share access to one or more other computer systems with the resource for emergency assistance, sharing, to the resource for emergency assistance, access to a respective set of one or more other computer systems, wherein the respective set of one or more other computer systems do not include the computer system.

In some embodiments, a transitory computer-readable storage medium storing one or more programs configured to be executed by one or more processors of a computer system that is in communication with one or more input devices and one or more output devices including one or more display components is described. In some embodiments, the one or more programs includes instructions for: displaying, via the one or more display components, a call user interface corresponding to a connection with a resource for emergency assistance; while displaying the call user interface corresponding to the connection with the resource for emergency assistance, outputting, via the one or more output devices, a prompt to share access to one or more other computer systems with the resource for emergency assistance; in conjunction with outputting the prompt, detecting, via the one or more input devices, an input corresponding to a request to share access to one or more other computer systems with the resource for emergency assistance; and in response to detecting the input corresponding to the request to share access to one or more other computer systems with the resource for emergency assistance, sharing, to the resource for emergency assistance, access to a respective set of one or more other computer systems, wherein the respective set of one or more other computer systems do not include the computer system.

In some embodiments, a computer system configured to communicate with one or more input devices and one or more output devices including one or more display components is described. In some embodiments, the computer system comprises one or more processors and memory storing one or more programs configured to be executed by the one or more processors. In some embodiments, the one or more programs includes instructions for: displaying, via the one or more display components, a call user interface corresponding to a connection with a resource for emergency assistance; while displaying the call user interface corresponding to the connection with the resource for emergency assistance, outputting, via the one or more output devices, a prompt to share access to one or more other computer systems with the resource for emergency assistance; in conjunction with outputting the prompt, detecting, via the one or more input devices, an input corresponding to a request to share access to one or more other computer systems with the resource for emergency assistance; and in response to detecting the input corresponding to the request to share access to one or more other computer systems with the resource for emergency assistance, sharing, to the resource for emergency assistance, access to a respective set of one or more other computer systems, wherein the respective set of one or more other computer systems do not include the computer system.

In some embodiments, a computer system configured to communicate with one or more input devices and one or more output devices including one or more display components is described. In some embodiments, the computer system comprises means for performing each of the following steps: displaying, via the one or more display components, a call user interface corresponding to a connection with a resource for emergency assistance; while displaying the call user interface corresponding to the connection with the resource for emergency assistance, outputting, via the one or more output devices, a prompt to share access to one or more other computer systems with the resource for emergency assistance; in conjunction with outputting the prompt, detecting, via the one or more input devices, an input corresponding to a request to share access to one or more other computer systems with the resource for emergency assistance; and in response to detecting the input corresponding to the request to share access to one or more other computer systems with the resource for emergency assistance, sharing, to the resource for emergency assistance, access to a respective set of one or more other computer systems, wherein the respective set of one or more other computer systems do not include the computer system.

In some embodiments, a computer program product is described. In some embodiments, the computer program product comprises one or more programs configured to be executed by one or more processors of a computer system that is in communication with one or more input devices and one or more output devices including one or more display components. In some embodiments, the one or more programs include instructions for: displaying, via the one or more display components, a call user interface corresponding to a connection with a resource for emergency assistance; while displaying the call user interface corresponding to the connection with the resource for emergency assistance, outputting, via the one or more output devices, a prompt to share access to one or more other computer systems with the resource for emergency assistance; in conjunction with outputting the prompt, detecting, via the one or more input devices, an input corresponding to a request to share access to one or more other computer systems with the resource for emergency assistance; and in response to detecting the input corresponding to the request to share access to one or more other computer systems with the resource for emergency assistance, sharing, to the resource for emergency assistance, access to a respective set of one or more other computer systems, wherein the respective set of one or more other computer systems do not include the computer system.

In some embodiments, a method that is performed at a computer system that is in communication with one or more output devices is described. In some embodiments, the method comprises: receiving an indication that a set of one or more operations is performed based on a subject entering an environment; and in response to receiving the indication that the set of one or more operations is performed based on the subject entering the environment: in accordance with a determination that a first set of one or more criteria is satisfied, outputting, via the one or more output devices, an indication that includes a first explanation regarding performance of the set of one or more operations; and in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

In some embodiments, a non-transitory computer-readable storage medium storing one or more programs configured to be executed by one or more processors of a computer system that is in communication with one or more output devices is described. In some embodiments, the one or more programs includes instructions for: receiving an indication that a set of one or more operations is performed based on a subject entering an environment; and in response to receiving the indication that the set of one or more operations is performed based on the subject entering the environment: in accordance with a determination that a first set of one or more criteria is satisfied, outputting, via the one or more output devices, an indication that includes a first explanation regarding performance of the set of one or more operations; and in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

In some embodiments, a transitory computer-readable storage medium storing one or more programs configured to be executed by one or more processors of a computer system that is in communication with one or more output devices is described. In some embodiments, the one or more programs includes instructions for: receiving an indication that a set of one or more operations is performed based on a subject entering an environment; and in response to receiving the indication that the set of one or more operations is performed based on the subject entering the environment: in accordance with a determination that a first set of one or more criteria is satisfied, outputting, via the one or more output devices, an indication that includes a first explanation regarding performance of the set of one or more operations; and in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

In some embodiments, a computer system configured to communicate with one or more output devices is described. In some embodiments, the computer system comprises one or more processors and memory storing one or more programs configured to be executed by the one or more processors. In some embodiments, the one or more programs includes instructions for: receiving an indication that a set of one or more operations is performed based on a subject entering an environment; and in response to receiving the indication that the set of one or more operations is performed based on the subject entering the environment: in accordance with a determination that a first set of one or more criteria is satisfied, outputting, via the one or more output devices, an indication that includes a first explanation regarding performance of the set of one or more operations; and in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

In some embodiments, a computer system configured to communicate with one or more output devices is described. In some embodiments, the computer system comprises means for performing each of the following steps: receiving an indication that a set of one or more operations is performed based on a subject entering an environment; and in response to receiving the indication that the set of one or more operations is performed based on the subject entering the environment: in accordance with a determination that a first set of one or more criteria is satisfied, outputting, via the one or more output devices, an indication that includes a first explanation regarding performance of the set of one or more operations; and in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

In some embodiments, a computer program product is described. In some embodiments, the computer program product comprises one or more programs configured to be executed by one or more processors of a computer system that is in communication with one or more output devices. In some embodiments, the one or more programs include instructions for: receiving an indication that a set of one or more operations is performed based on a subject entering an environment; and in response to receiving the indication that the set of one or more operations is performed based on the subject entering the environment: in accordance with a determination that a first set of one or more criteria is satisfied, outputting, via the one or more output devices, an indication that includes a first explanation regarding performance of the set of one or more operations; and in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

In some embodiments, a method that is performed at a computer system is described. In some embodiments, the method comprises: receiving an indication that an identified subject with a respective authentication level is detected in an environment; and in response to receiving the indication that the identified subject with the respective authentication level is detected in the environment: in accordance with a determination that the respective authentication level satisfies a first set of one or more criteria, wherein the first set of one or more criteria includes a criterion that is satisfied when the respective authentication level is a first authentication level, initiating an automation; and in accordance with a determination that the respective authentication level satisfies a second set of one or more criteria, wherein the second set of one or more criteria includes a criterion that is satisfied when the respective authentication level is a second authentication level, forgoing initiation of the automation, wherein the second authentication level is different from the first authentication level.

In some embodiments, a non-transitory computer-readable storage medium storing one or more programs configured to be executed by one or more processors of a computer system is described. In some embodiments, the one or more programs includes instructions for: receiving an indication that an identified subject with a respective authentication level is detected in an environment; and in response to receiving the indication that the identified subject with the respective authentication level is detected in the environment: in accordance with a determination that the respective authentication level satisfies a first set of one or more criteria, wherein the first set of one or more criteria includes a criterion that is satisfied when the respective authentication level is a first authentication level, initiating an automation; and in accordance with a determination that the respective authentication level satisfies a second set of one or more criteria, wherein the second set of one or more criteria includes a criterion that is satisfied when the respective authentication level is a second authentication level, forgoing initiation of the automation, wherein the second authentication level is different from the first authentication level.

In some embodiments, a transitory computer-readable storage medium storing one or more programs configured to be executed by one or more processors of a computer system is described. In some embodiments, the one or more programs includes instructions for: receiving an indication that an identified subject with a respective authentication level is detected in an environment; and in response to receiving the indication that the identified subject with the respective authentication level is detected in the environment: in accordance with a determination that the respective authentication level satisfies a first set of one or more criteria, wherein the first set of one or more criteria includes a criterion that is satisfied when the respective authentication level is a first authentication level, initiating an automation; and in accordance with a determination that the respective authentication level satisfies a second set of one or more criteria, wherein the second set of one or more criteria includes a criterion that is satisfied when the respective authentication level is a second authentication level, forgoing initiation of the automation, wherein the second authentication level is different from the first authentication level.

In some embodiments, a computer system is described. In some embodiments, the computer system comprises one or more processors and memory storing one or more programs configured to be executed by the one or more processors. In some embodiments, the one or more programs includes instructions for: receiving an indication that an identified subject with a respective authentication level is detected in an environment; and in response to receiving the indication that the identified subject with the respective authentication level is detected in the environment: in accordance with a determination that the respective authentication level satisfies a first set of one or more criteria, wherein the first set of one or more criteria includes a criterion that is satisfied when the respective authentication level is a first authentication level, initiating an automation; and in accordance with a determination that the respective authentication level satisfies a second set of one or more criteria, wherein the second set of one or more criteria includes a criterion that is satisfied when the respective authentication level is a second authentication level, forgoing initiation of the automation, wherein the second authentication level is different from the first authentication level.

In some embodiments, a computer system is described. In some embodiments, the computer system comprises means for performing each of the following steps: receiving an indication that an identified subject with a respective authentication level is detected in an environment; and in response to receiving the indication that the identified subject with the respective authentication level is detected in the environment: in accordance with a determination that the respective authentication level satisfies a first set of one or more criteria, wherein the first set of one or more criteria includes a criterion that is satisfied when the respective authentication level is a first authentication level, initiating an automation; and in accordance with a determination that the respective authentication level satisfies a second set of one or more criteria, wherein the second set of one or more criteria includes a criterion that is satisfied when the respective authentication level is a second authentication level, forgoing initiation of the automation, wherein the second authentication level is different from the first authentication level.

In some embodiments, a computer program product is described. In some embodiments, the computer program product comprises one or more programs configured to be executed by one or more processors of a computer system. In some embodiments, the one or more programs include instructions for: receiving an indication that an identified subject with a respective authentication level is detected in an environment; and in response to receiving the indication that the identified subject with the respective authentication level is detected in the environment: in accordance with a determination that the respective authentication level satisfies a first set of one or more criteria, wherein the first set of one or more criteria includes a criterion that is satisfied when the respective authentication level is a first authentication level, initiating an automation; and in accordance with a determination that the respective authentication level satisfies a second set of one or more criteria, wherein the second set of one or more criteria includes a criterion that is satisfied when the respective authentication level is a second authentication level, forgoing initiation of the automation, wherein the second authentication level is different from the first authentication level.

In some embodiments, a method that is performed at a computer system is described. In some embodiments, the method comprises: detecting a subject in an environment; in response to detecting the subject in the environment: in accordance with a determination that a first set of one or more criteria is satisfied, wherein the first set of one or more criteria includes a criterion that is satisfied when the subject has been authenticated with respect to a user account using a first set of one or more authentication techniques, initiating an automation; and in accordance with a determination that a second set of one or more criteria is satisfied, wherein the second set of one or more criteria includes a criterion that is satisfied when the subject has been authenticated with respect to the user account using a second set of authentication techniques, forgoing initiation of the automation, wherein the first set of one or more authentication techniques is different from the second set of one or more authentication techniques.

In some embodiments, a non-transitory computer-readable storage medium storing one or more programs configured to be executed by one or more processors of a computer system is described. In some embodiments, the one or more programs includes instructions for: detecting a subject in an environment; in response to detecting the subject in the environment: in accordance with a determination that a first set of one or more criteria is satisfied, wherein the first set of one or more criteria includes a criterion that is satisfied when the subject has been authenticated with respect to a user account using a first set of one or more authentication techniques, initiating an automation; and in accordance with a determination that a second set of one or more criteria is satisfied, wherein the second set of one or more criteria includes a criterion that is satisfied when the subject has been authenticated with respect to the user account using a second set of authentication techniques, forgoing initiation of the automation, wherein the first set of one or more authentication techniques is different from the second set of one or more authentication techniques.

In some embodiments, a transitory computer-readable storage medium storing one or more programs configured to be executed by one or more processors of a computer system is described. In some embodiments, the one or more programs includes instructions for: detecting a subject in an environment; in response to detecting the subject in the environment: in accordance with a determination that a first set of one or more criteria is satisfied, wherein the first set of one or more criteria includes a criterion that is satisfied when the subject has been authenticated with respect to a user account using a first set of one or more authentication techniques, initiating an automation; and in accordance with a determination that a second set of one or more criteria is satisfied, wherein the second set of one or more criteria includes a criterion that is satisfied when the subject has been authenticated with respect to the user account using a second set of authentication techniques, forgoing initiation of the automation, wherein the first set of one or more authentication techniques is different from the second set of one or more authentication techniques.

In some embodiments, a computer system is described. In some embodiments, the computer system comprises one or more processors and memory storing one or more programs configured to be executed by the one or more processors. In some embodiments, the one or more programs includes instructions for: detecting a subject in an environment; in response to detecting the subject in the environment: in accordance with a determination that a first set of one or more criteria is satisfied, wherein the first set of one or more criteria includes a criterion that is satisfied when the subject has been authenticated with respect to a user account using a first set of one or more authentication techniques, initiating an automation; and in accordance with a determination that a second set of one or more criteria is satisfied, wherein the second set of one or more criteria includes a criterion that is satisfied when the subject has been authenticated with respect to the user account using a second set of authentication techniques, forgoing initiation of the automation, wherein the first set of one or more authentication techniques is different from the second set of one or more authentication techniques.

In some embodiments, a computer system is described. In some embodiments, the computer system comprises means for performing each of the following steps: detecting a subject in an environment; in response to detecting the subject in the environment: in accordance with a determination that a first set of one or more criteria is satisfied, wherein the first set of one or more criteria includes a criterion that is satisfied when the subject has been authenticated with respect to a user account using a first set of one or more authentication techniques, initiating an automation; and in accordance with a determination that a second set of one or more criteria is satisfied, wherein the second set of one or more criteria includes a criterion that is satisfied when the subject has been authenticated with respect to the user account using a second set of authentication techniques, forgoing initiation of the automation, wherein the first set of one or more authentication techniques is different from the second set of one or more authentication techniques.

In some embodiments, a computer program product is described. In some embodiments, the computer program product comprises one or more programs configured to be executed by one or more processors of a computer system. In some embodiments, the one or more programs include instructions for: detecting a subject in an environment; in response to detecting the subject in the environment: in accordance with a determination that a first set of one or more criteria is satisfied, wherein the first set of one or more criteria includes a criterion that is satisfied when the subject has been authenticated with respect to a user account using a first set of one or more authentication techniques, initiating an automation; and in accordance with a determination that a second set of one or more criteria is satisfied, wherein the second set of one or more criteria includes a criterion that is satisfied when the subject has been authenticated with respect to the user account using a second set of authentication techniques, forgoing initiation of the automation, wherein the first set of one or more authentication techniques is different from the second set of one or more authentication techniques.

A computer-readable storage medium or other computer program product that is set up to run on one or more processors can optionally include executable instructions for carrying out steps described above.

### DESCRIPTION OF THE FIGURES

To gain a clearer understanding of techniques described herein, references to various embodiments are described below in the Detailed Description. In conjunction with the Detailed Description, drawings are provided in which reference numerals refer to related parts across the drawings.

FIG. 1 is a block diagram illustrating a computer system in accordance with some embodiments.

FIG. 2A is a block diagram illustrating a device and a system in accordance with some embodiments.

FIG. 2B illustrates a computer system with a touch screen in accordance with some embodiments.

FIG. 3 is a block diagram illustrating an ecosystem including a computer system with other accessory devices in accordance with some embodiments.

FIGS. 4A-4H illustrate exemplary user interfaces for providing guest access to an environment while on a call in accordance with some embodiments.

FIG. 5 is a flow diagram illustrating a process for providing guest access to an environment while on a call in accordance with some embodiments.

FIGS. 6A-6C illustrate exemplary user interfaces for displaying status of an environment in accordance with some embodiments.

FIG. 7 is a flow diagram illustrating a process for displaying status of an environment in accordance with some embodiments.

FIGS. 8A-8G illustrate exemplary user interfaces for providing access to accessories in an environment in accordance with some embodiments.

FIG. 9 is a flow diagram illustrating a process for providing access to accessories in an environment in accordance with some embodiments.

FIGS. 10A-10V illustrate exemplary user interfaces for detecting a presence of a subject in accordance with some embodiments.

FIG. 11 is a flow diagram illustrating a process for displaying a live feed of various cameras in accordance with some embodiments.

FIG. 12 is a flow diagram illustrating a process for assisting a subject with an authentication process in accordance with some embodiments.

FIGS. 13A-13G illustrate an exemplary environment for performing automations in accordance with some embodiments.

FIG. 14 is a flow diagram illustrating a process for initiating an automation in accordance with some embodiments.

### DETAILED DESCRIPTION

The description that follows covers exemplary embodiments and examples. However, it should be acknowledged that this description is given as an explanation and is not meant to restrict the scope of the current disclosure. For example, terms used to describe different embodiments and different examples are not meant to be restrictive unless explicitly stated.

In some embodiments, one or more steps of a process can be contingent upon fulfillment of one or more conditions. To fulfill the one or more conditions, a process can be repeated multiple times. In such embodiments, different conditions can be satisfied in different repetitions. For example, steps can be repeated until all conditions have been satisfied. In some embodiments, electronic devices, computer systems, and/or computer readable mediums include instructions for performing one or more steps that are contingent upon one or more conditions being satisfied. Such instructions can include logic that determines whether the one or more conditions have been fulfilled without repetition of a step.

Although terms such as “first”, “second”, and so forth are used with different elements in the following description, these elements should not be constrained by the terms unless explicitly stated otherwise. In some embodiments, the terms are used to differentiate one element from another. For example, a “first” input can be different from a “second” input, though the terms “first” and “second” can be switched without changing the meaning of either input. In some embodiments, the “first” input and the “second” input are two different references to the same input unless explicitly stated otherwise.

Unless context makes it apparent otherwise, singular forms of “a”, “an”, and “the” are meant to cover plural forms. Additionally, the term “and/or” is meant to be interpreted to apply to and include any and all potential combinations of one or more of the related mentioned things. The terms “has”, “having”, “includes”, “including”, “comprises”, and/or “comprising” are meant to cover the presence of different elements; however, they do not preclude the presence or addition of one or more additional elements. The term “if” is meant to be interpreted to indicate “when”, “upon”, “in response to determining”, or “in response to detecting”. Accordingly, depending on the context, the expressions “if it is determined” or “if [a stated condition] is detected” can be interpreted as meaning “upon determining”, “in response to determining”, “upon detecting [the stated condition]”, or “in response to detecting [the stated condition]”.

Some processes described below enhance the operability of devices and make interfaces better, such as by helping a user provide proper inputs and/or reduce mistakes when using devices, through various techniques. For example, some processes perform an operation when a set of conditions has been met without requiring further input, such as input by a user. For another example, some processes provide additional control options without cluttering user interfaces with additional displayed controls. For another example, some processes reduce the number of inputs needed to perform an operation. For another example, some processes provide improved feedback (e.g., visual, haptic, acoustic, and/or tactile feedback) to a user. Additional techniques include increasing the security and/or privacy of the device and/or reducing burn-in. These techniques also reduce power usage and/or improve battery life of devices, such as by enabling a user to use devices better, more quickly, and/or efficiently.

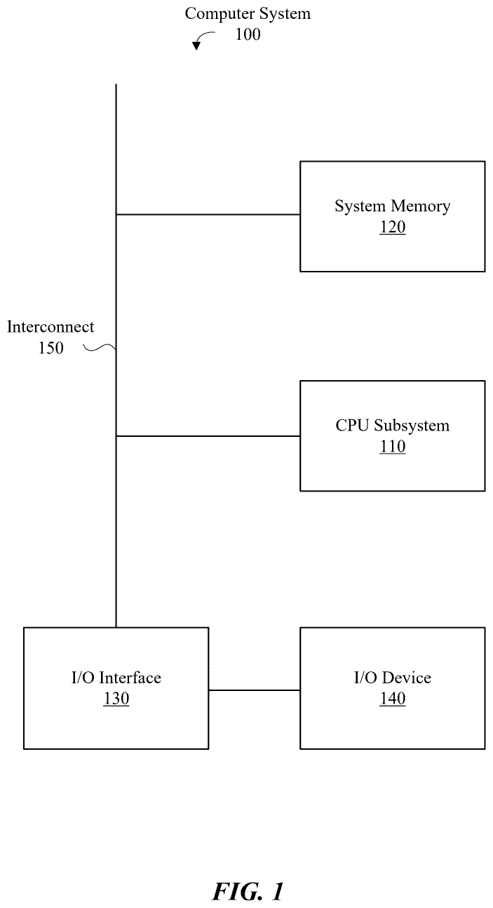

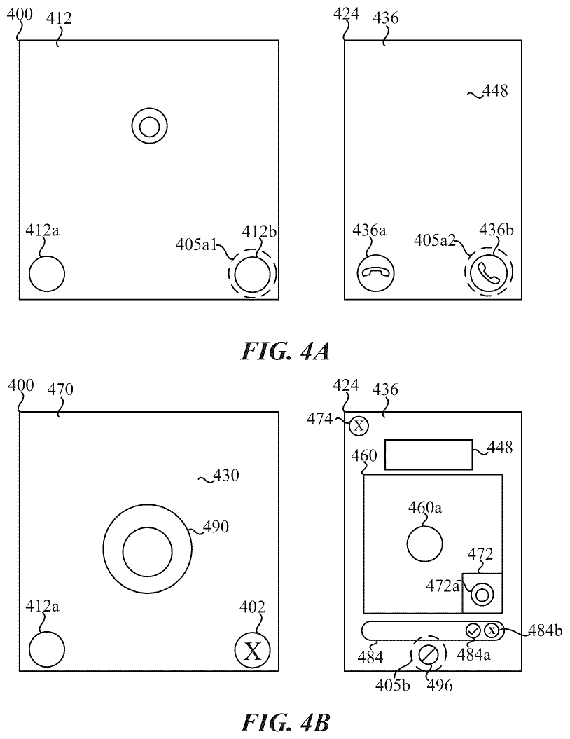

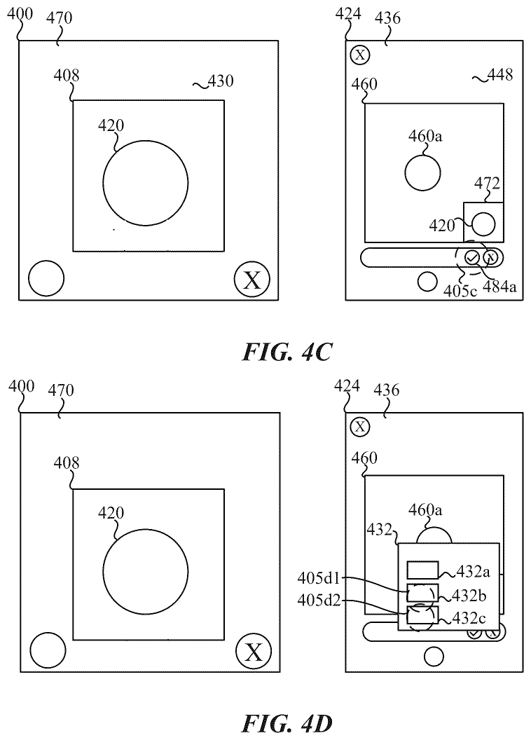

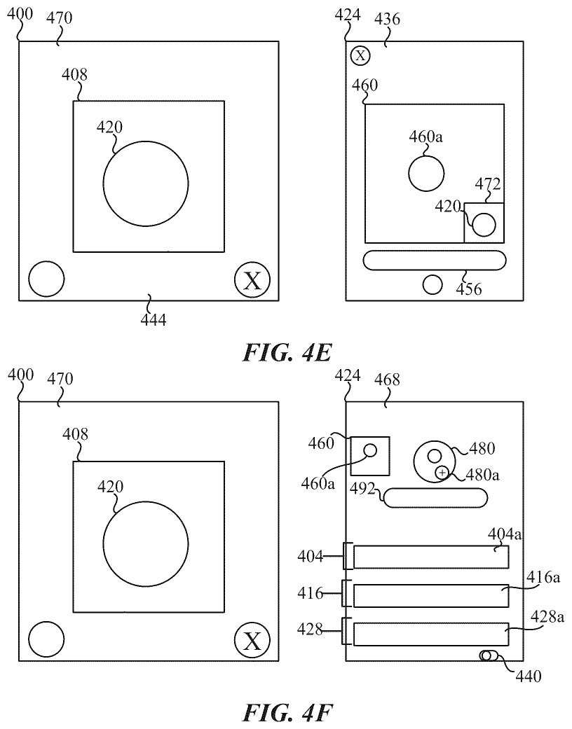

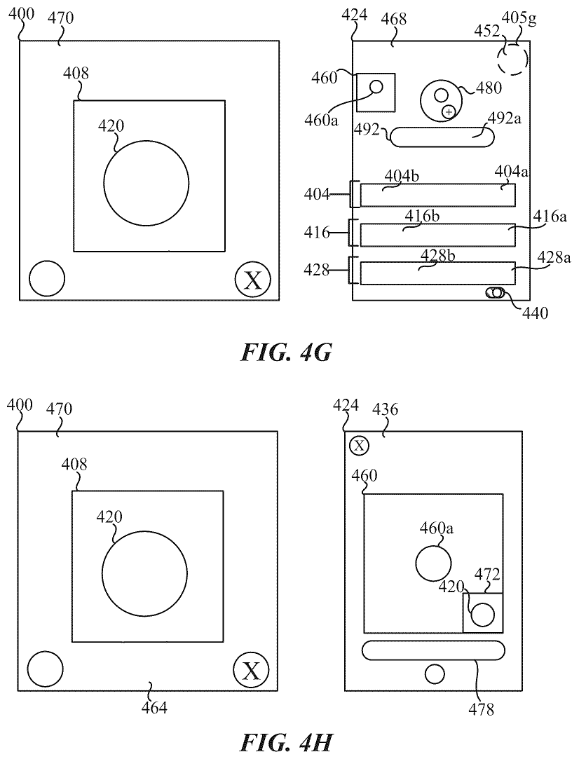

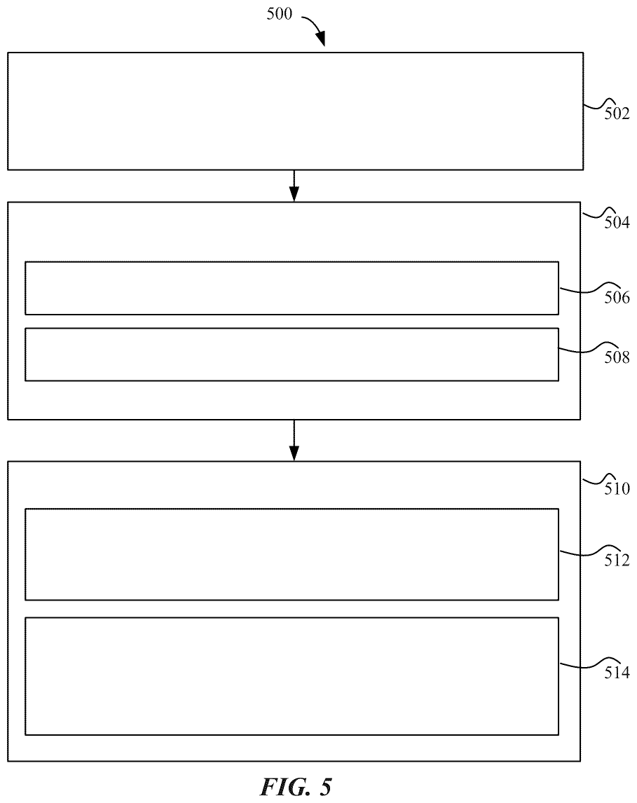

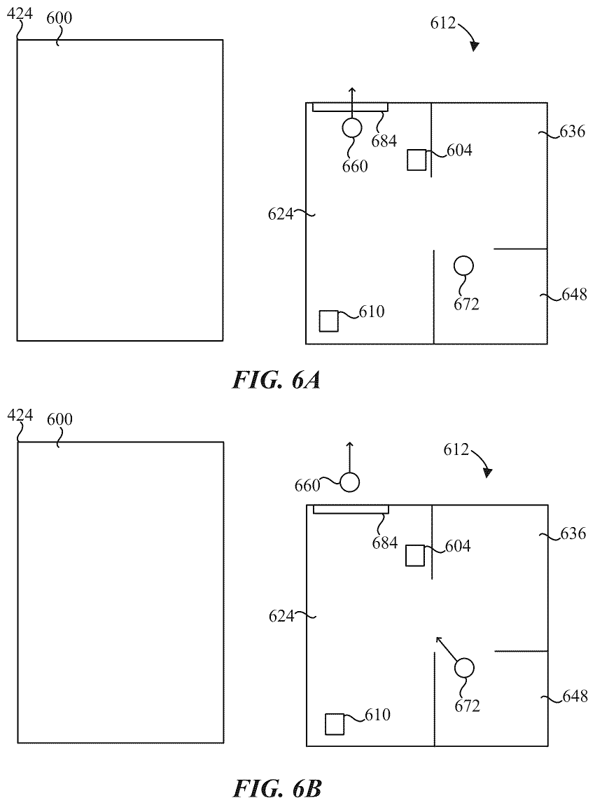

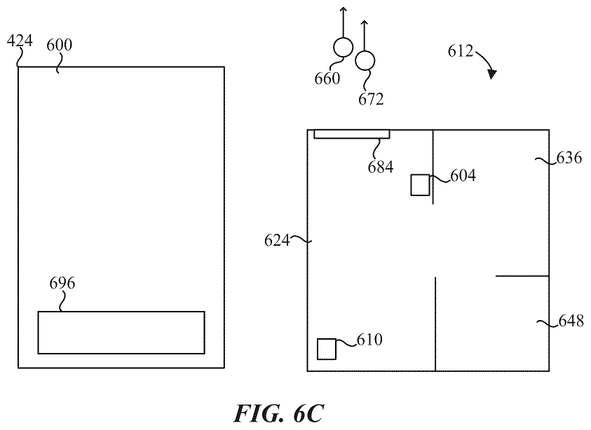

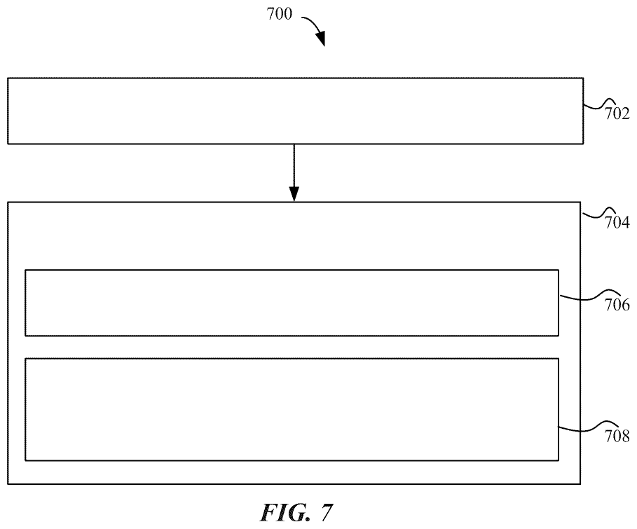

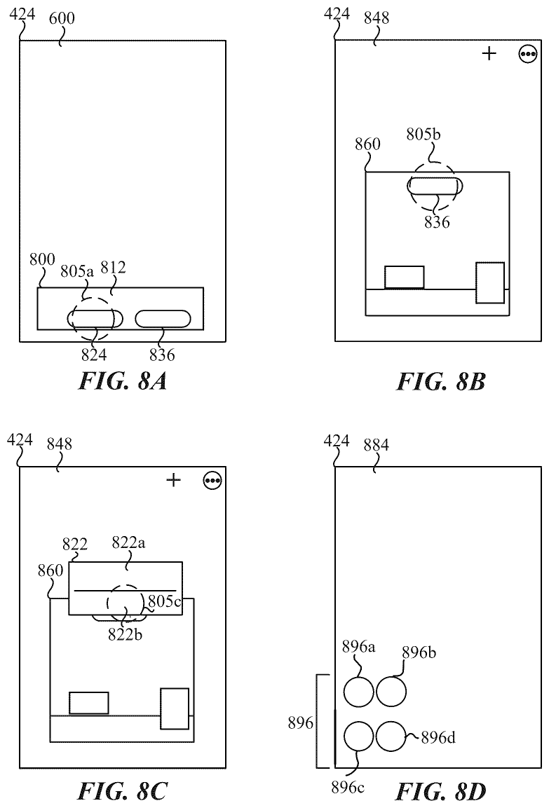

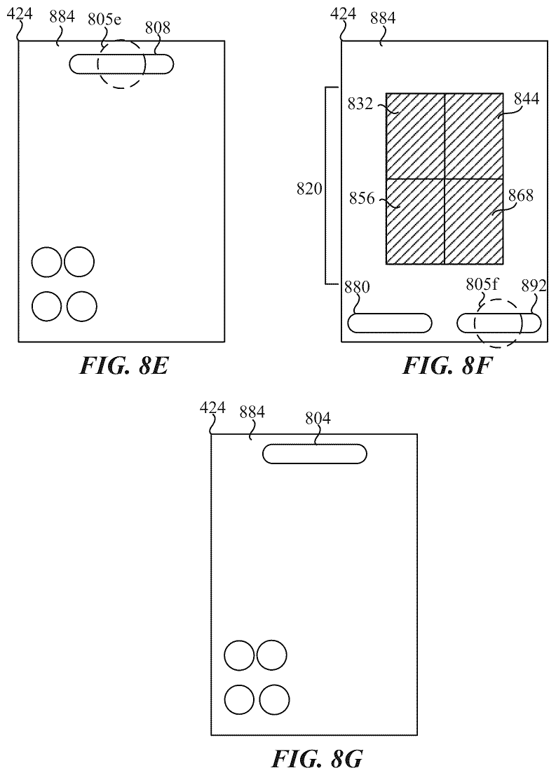

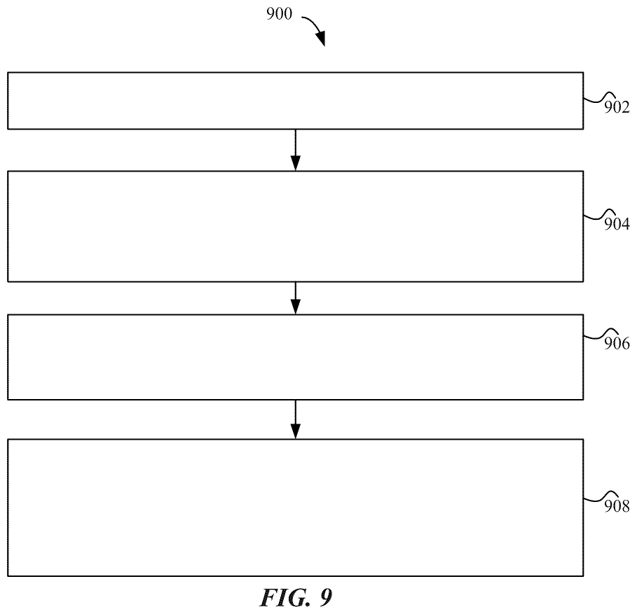

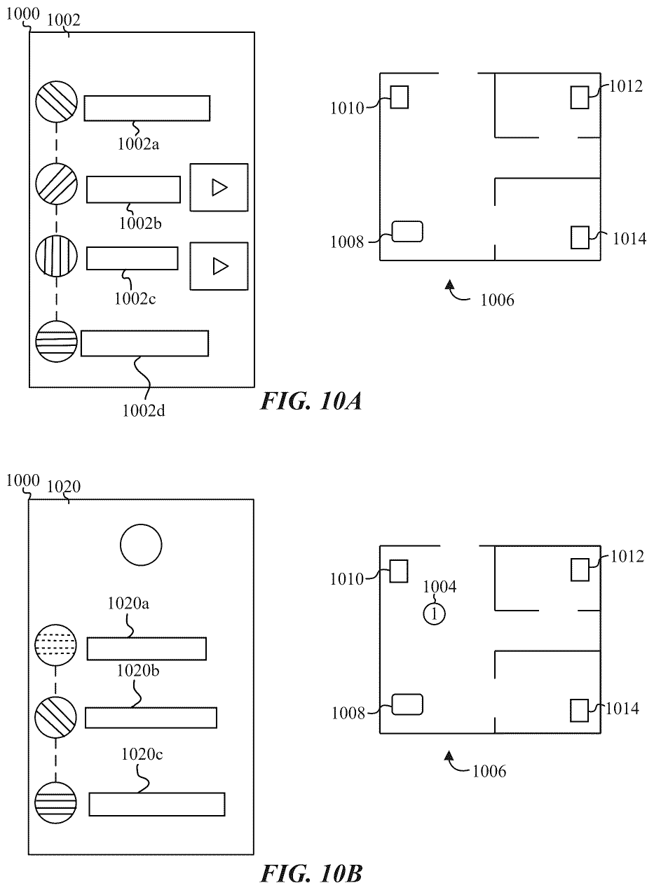

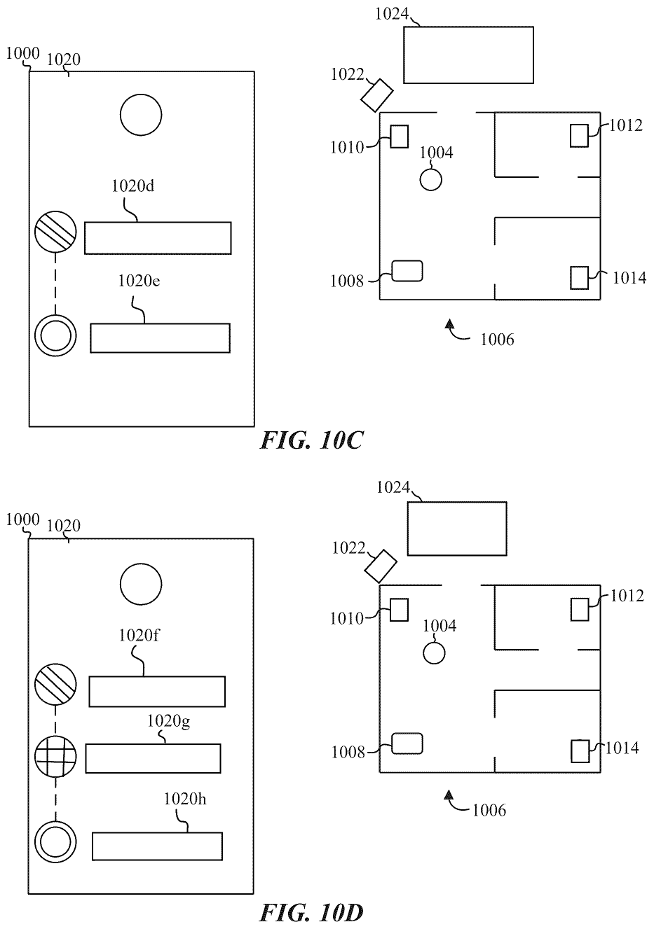

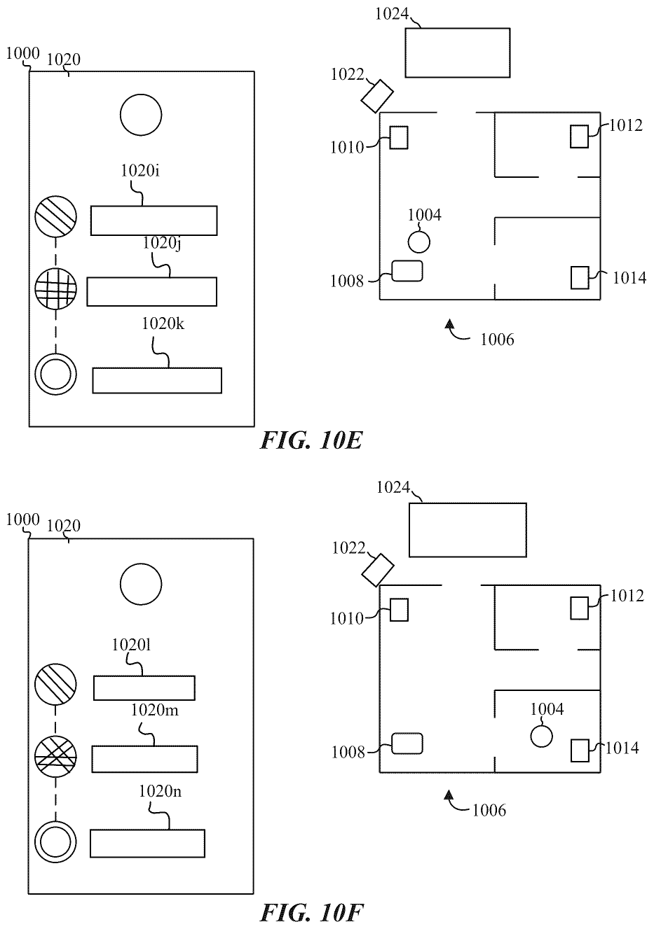

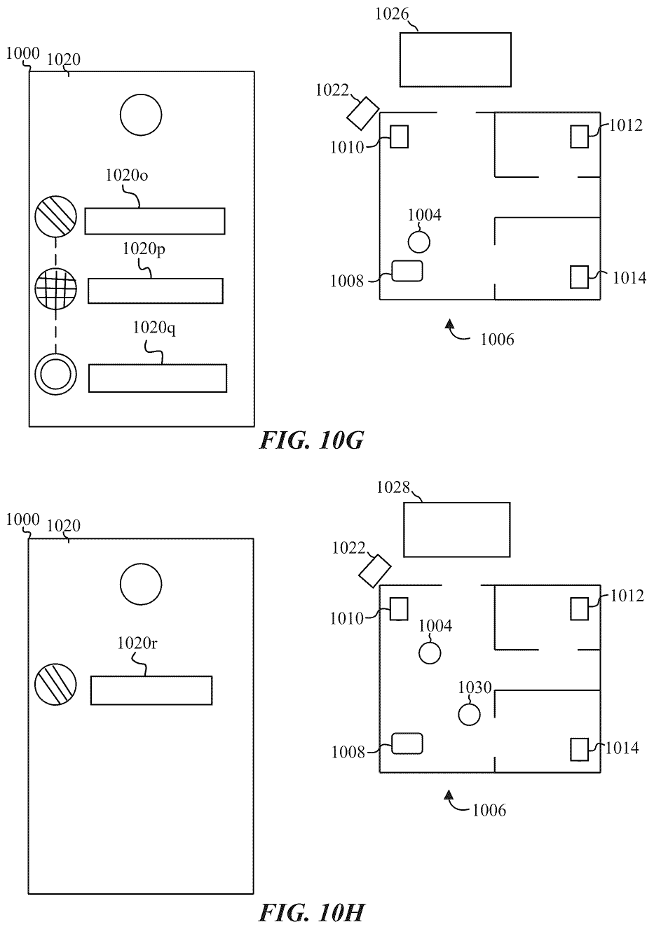

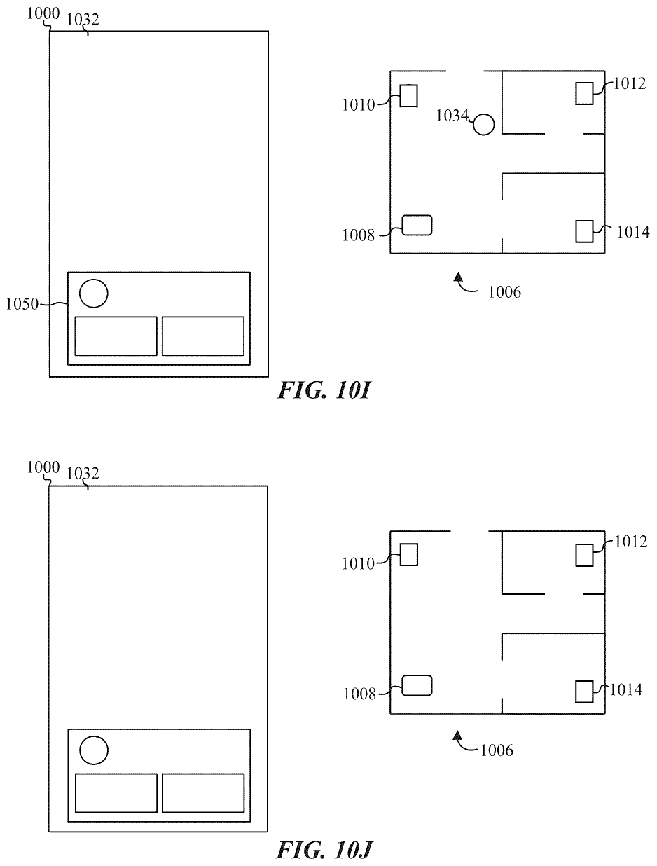

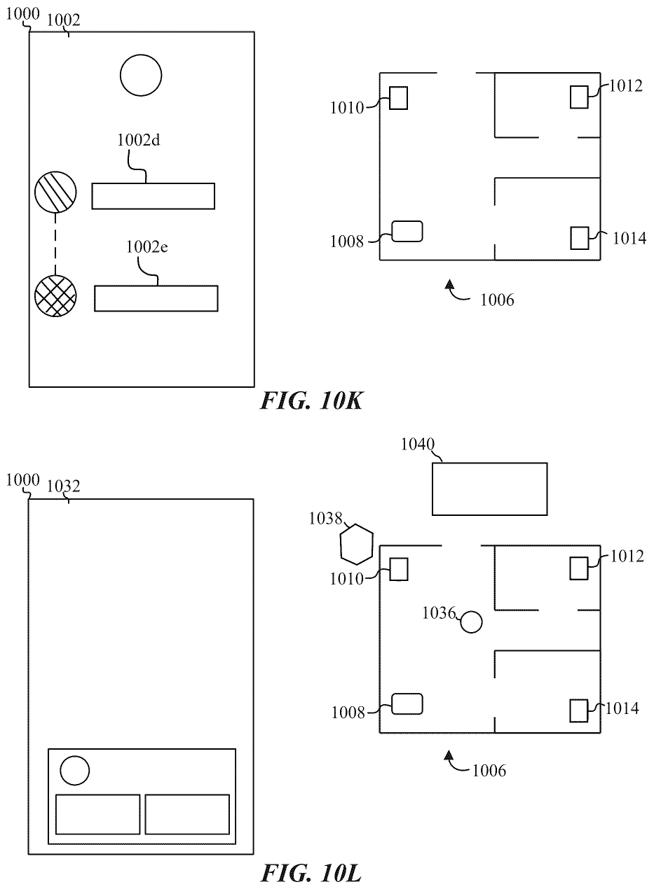

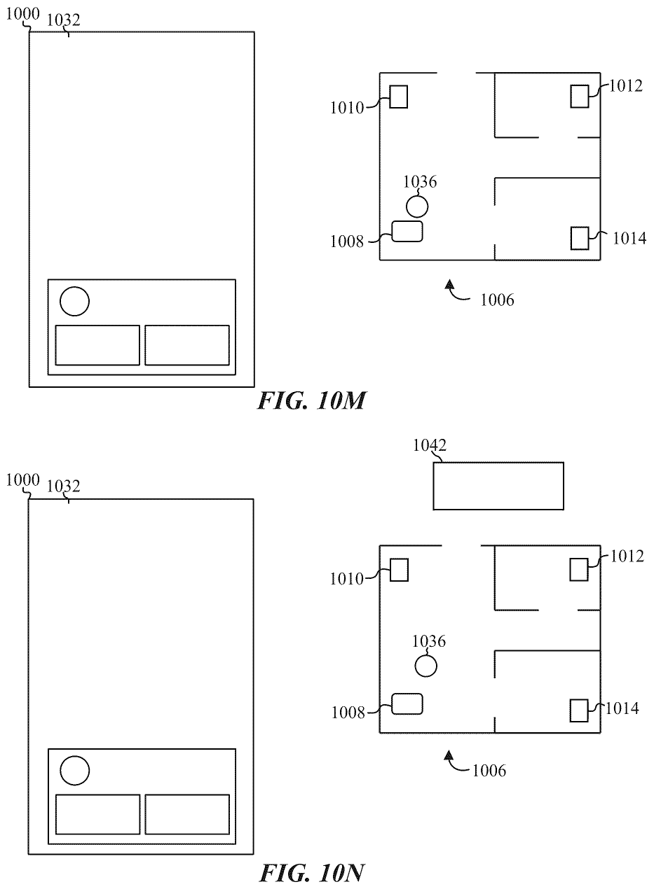

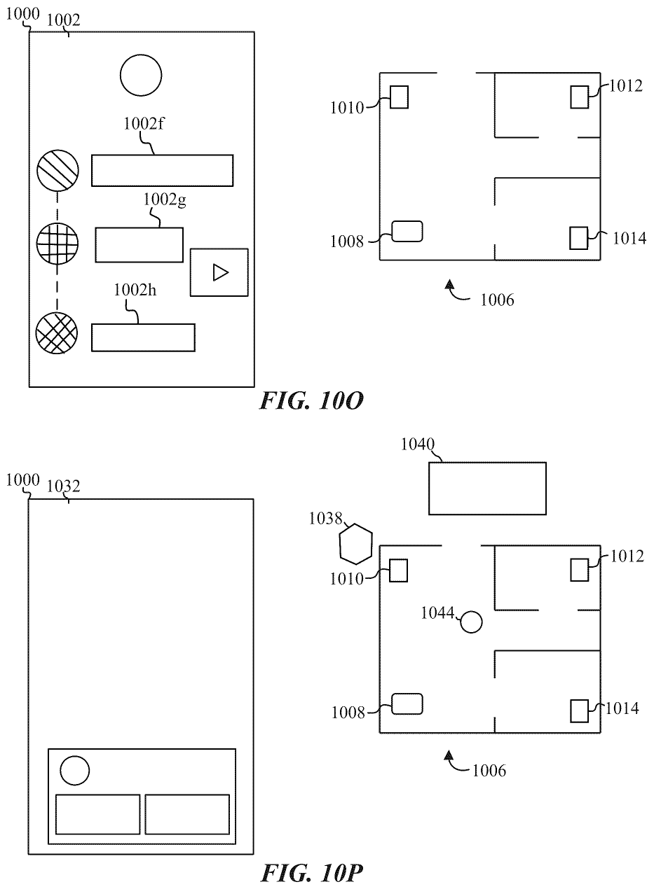

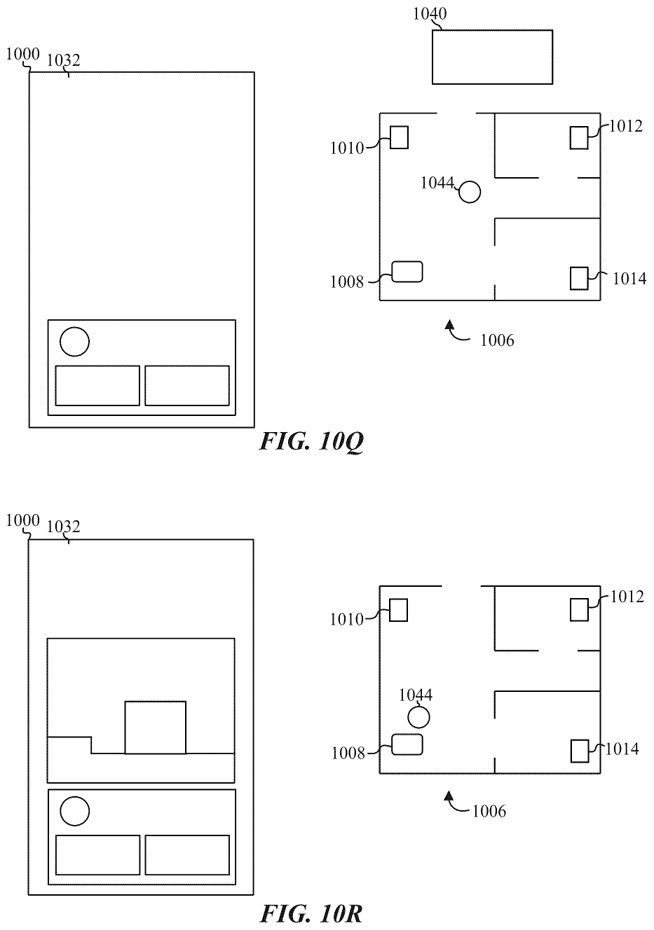

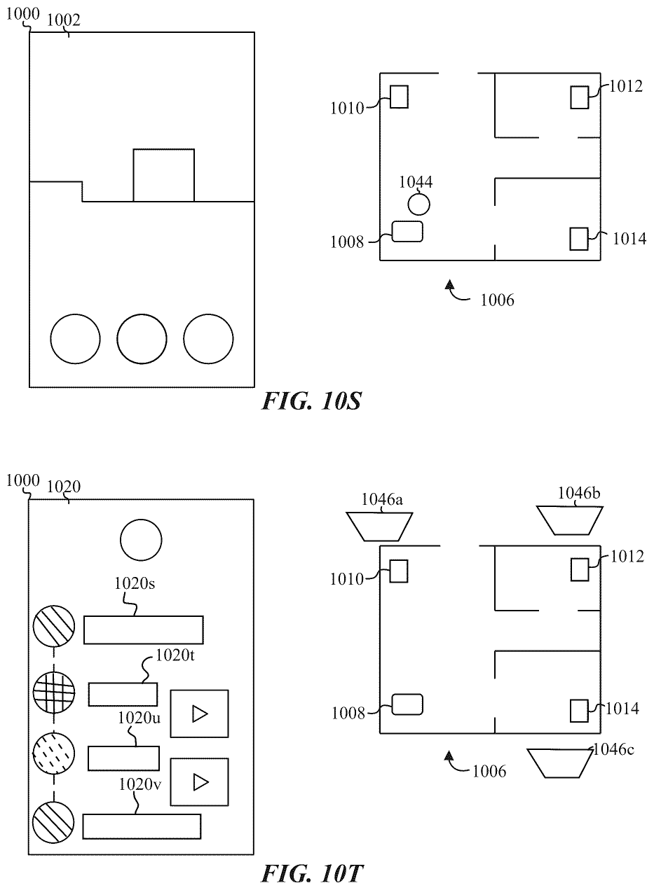

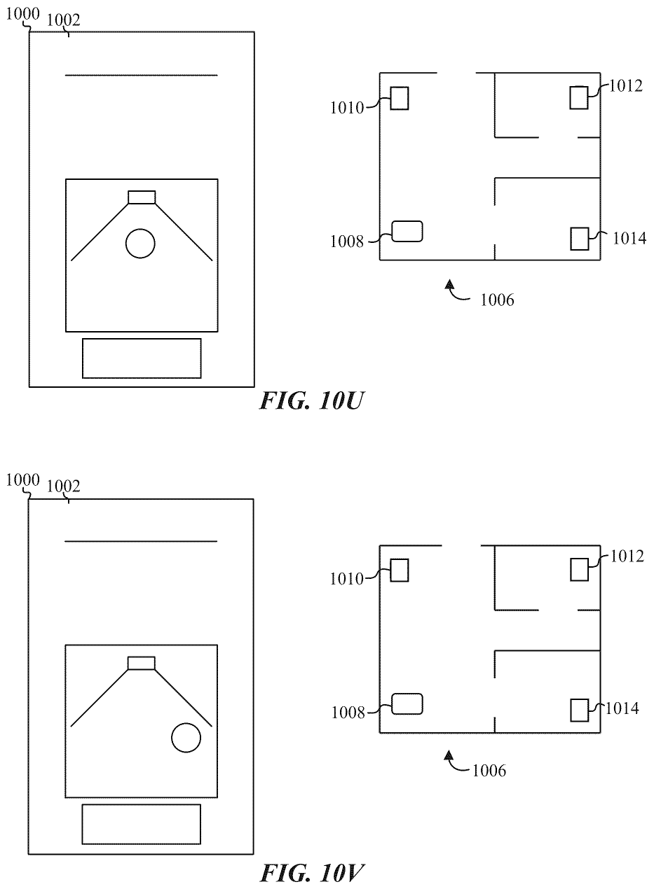

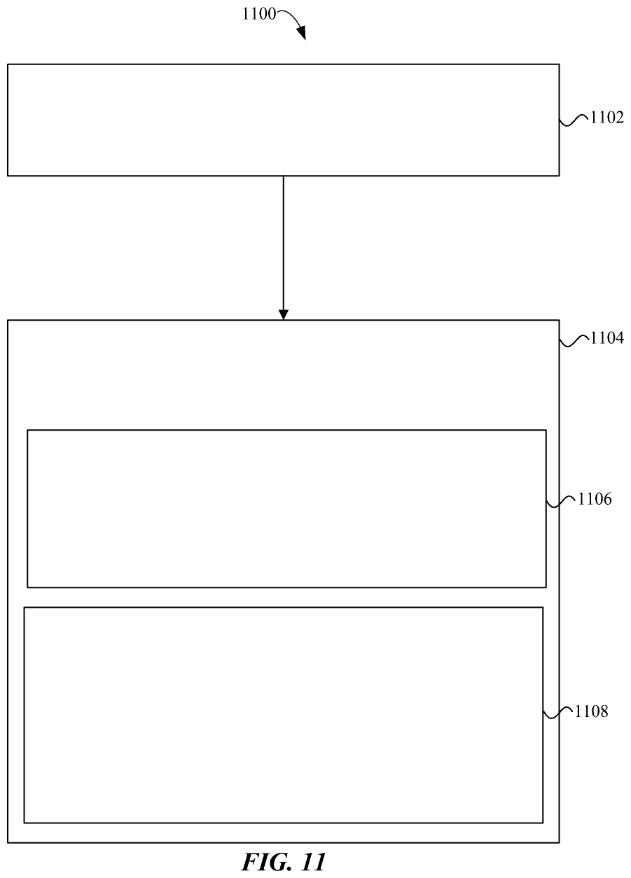

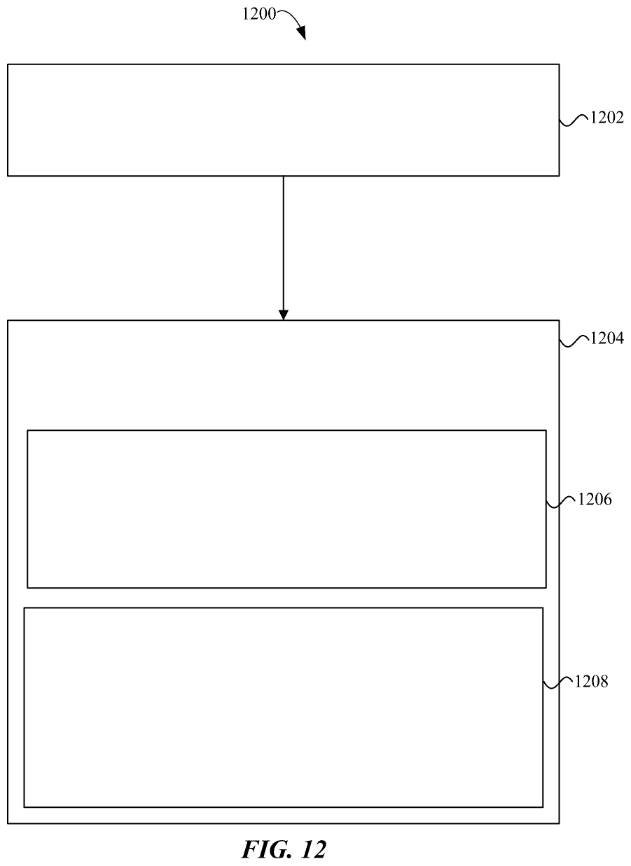

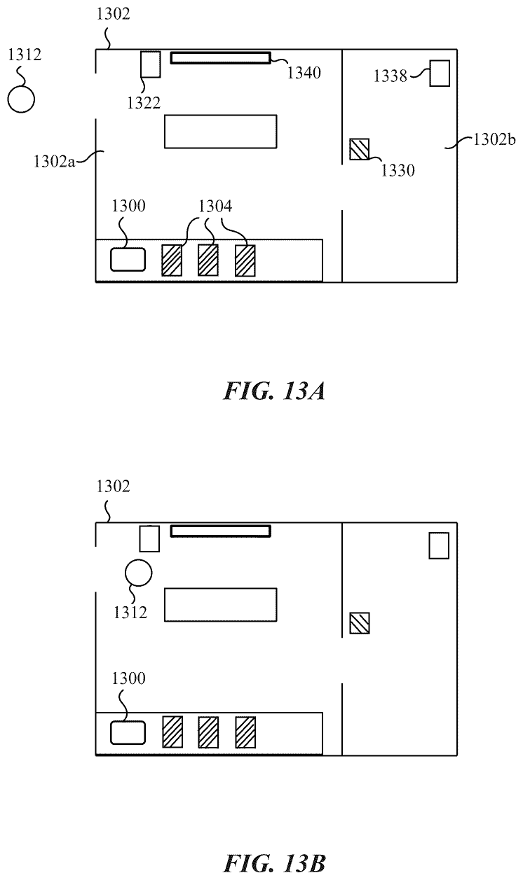

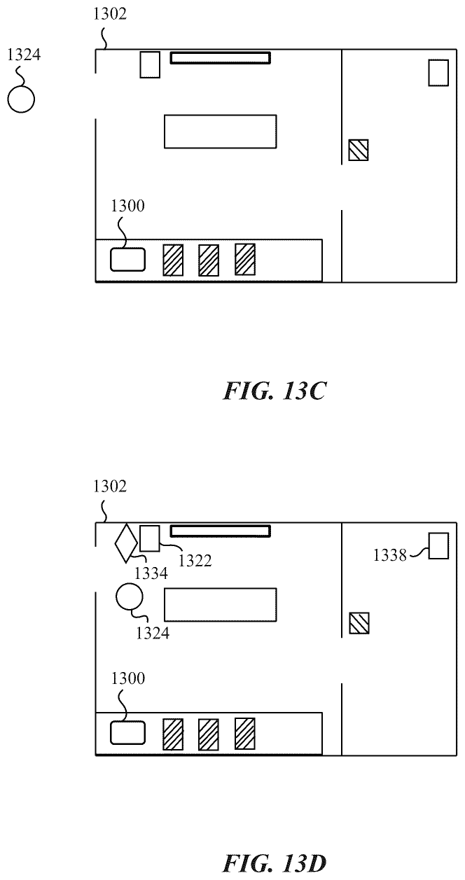

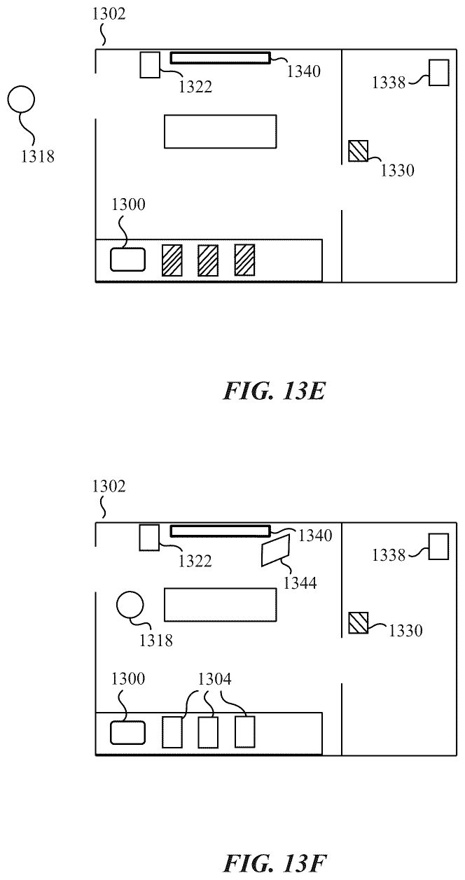

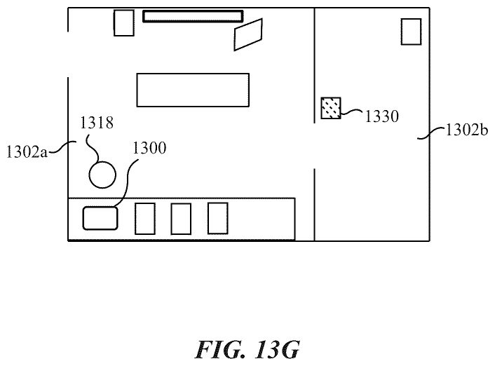

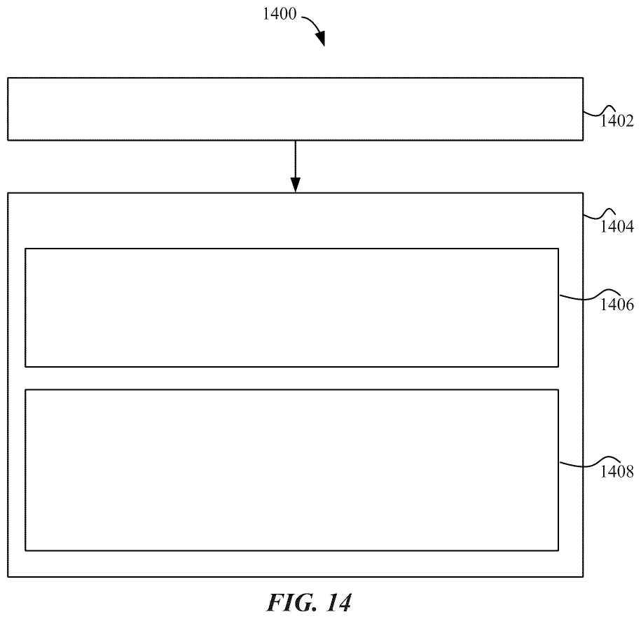

Below, FIGS. 1, 2A-2B, and 3 provide description of exemplary devices for implementing techniques described below. FIGS. 4A-4H illustrate exemplary user interfaces for providing guest access to an environment while on a call in accordance with some embodiments. FIG. 5 is a flow diagram illustrating a process for providing guest access to an environment while on a call in accordance with some embodiments. The user interfaces in FIGS. 4A-4H are used to illustrate the processes described below, including the processes in FIG. 5. FIGS. 6A-6C illustrate exemplary user interfaces for displaying status of an environment in accordance with some embodiments. FIG. 7 is a flow diagram illustrating a process for displaying status of an environment in accordance with some embodiments. The user interfaces in FIGS. 6A-6C are used to illustrate the processes described below, including the processes in FIG. 7. FIGS. 8A-8G illustrate exemplary user interfaces for providing access to accessories in an environment in accordance with some embodiments. FIG. 9 is a flow diagram illustrating a process for providing access to accessories in an environment in accordance with some embodiments. The user interfaces in FIGS. 8A-8G are used to illustrate the processes described below, including the processes in FIG. 9. FIGS. 10A-10V illustrate exemplary user interfaces for detecting a presence of a subject in accordance with some embodiments. FIG. 11 is a flow diagram illustrating a process for displaying a live feed of various cameras in accordance with some embodiments. FIG. 12 is a flow diagram illustrating a process for assisting a subject with an authentication process in accordance with some embodiments. The user interfaces in FIGS. 10A-10V are used to illustrate the processes described below, including the processes in FIGS. 11-12. FIGS. 13A-13G illustrate an exemplary environment for performing automations in accordance with some embodiments. FIG. 14 is a flow diagram illustrating a process for initiating an automation in accordance with some embodiments. The environments in FIGS. 13A-13G are used to illustrate the processes described below, including the processes in FIG. 14.

FIG. 1 is a block diagram illustrating a computer system in accordance with some embodiments. While FIG. 1 illustrates one computer system, two or more computer systems working together can implement techniques described herein. It should be acknowledged that the computer system (e.g., computer system 100) is sometimes referred to as a device, an electronic device, an electronic system, a compute system, and/or a system. In some embodiments, computer system 100 is a personal computer system, a server system, a smart phone, a system on a chip, a smart watch, a wearable device, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor.

As illustrated in FIG. 1, computer system 100 includes CPU subsystem 110, system memory 120, and I/O interface 130. Such components are able to communicate with one another through interconnect 150. In some embodiments, interconnect 150 is an electrical means of communication such as a system bus, one or more memory locations, and/or additional electrical channels for connecting multiple components of computer system 100.

It should be acknowledged that computer system 100 is only one example of a computer system to carry out techniques described below and that one or more other computer systems can carry out such techniques. Furthermore, while FIG. 1 illustrates a particular computer architecture of computer system 100, techniques described herein can be carried out by other computer architectures, such as by incorporating more, less, similar, and/or different components than the components illustrated.

In some embodiments, CPU subsystem 110 includes one or more processing units that can carry out techniques described herein. For example, CPU subsystem 110 can execute system-level and/or application-level instructions to perform an operation. In some embodiments, computer system 100 has several processing subsystems (e.g., multiple instances of CPU subsystem 110).

In some embodiments, CPU subsystem 110 is capable of carrying out instructions stored on a storage medium, such as a non-transitory or transitory computer-readable medium. A computer-readable storage medium (or many physical computer-readable storage media of one or more types) including one or more computer-readable instructions can be used to realize implementations falling partially or fully under the purview of the current disclosure. It should be acknowledged that computer-readable instructions can be arranged in any way, such as components, software, processes, widgets, and/or applications.

It should be acknowledged that the storage medium can be any medium that can physically include or store computer-executable instructions. For example, the storage medium can be temporary or non-temporary. Examples of storage medium include magnetic (e.g., hard drives and/or magnetic disks), optical (e.g., optical drives and/or optical discs based on CD, DVD, and Blu-ray technologies), solid state (e.g., solid state drives and/or flash drives), and/or semiconductor (e.g., random access memory) storages. In some embodiments, the storage medium is system memory 120. In such embodiments, each instruction stored by system memory 120 and executed by CPU subsystem 110 corresponds to an operation for completing functionality described herein. For example, instructions for processes 500, 700, 900, 1100, 1200, and 1400 can be stored in system memory 120.

In some embodiments, system memory 120 implements a range of distinct physical, non-transitory memory media. Examples of system memory 120 include a storage array, a storage area network (SAN), a removable flash drive, flash memory, hard disk storage, optical drive storage, floppy disk storage, removable disk storage, random access memory (such as SDRAM, DDR SDRAM, RAM-SRAM, EDO RAM, and/or RAMBUS RAM), and/or read-only memory (such as PROM and/or EEPROM). In some embodiments, computer system 100 has several memory components coupled, either directly or via interconnect 150, to CPU subsystem 110.

In some embodiments, computer system 100 communicates with external devices through I/O interface 130, which can be one or more types of interfaces. For example, I/O interface 130 can include a bridge chip that connects a front-side bus to one or more back-side buses. In some embodiments, I/O interface 130 allows communication through one or more appropriate buses or other interfaces with one or more I/O devices, such as I/O device 140. For example, I/O device 140 can include one or more: physical user-interface devices (e.g., a physical keyboard, a mouse, a button, a touch-sensitive surface, a rotatable component, and/or a joystick), storage devices (e.g., as described above with respect to system memory 120), network interface devices (e.g., to a local and/or wide-area network), sensor devices (e.g., a camera, a microphone, a motion detector, and/or a temperature sensor), audio output devices (e.g., speaker, audio jacks, and/or hearing loops), and/or visual output devices (e.g., screen, light, and/or projector). In some embodiments, I/O device 140 includes a network interface device that enables computer system 100 to establish a wired or wireless connection to a network or other computer systems. Examples of network interface devices include Ethernet, USB, Bluetooth, NFC, Wi-Fi, and/or Thunderbolt communication devices. In some embodiments, I/O device 140 is wired or wirelessly connected to I/O interface 130.

In some embodiments, a component of computer system 100 incorporates I/O device 140 with other components. For example, a single component can include I/O interface 130 and I/O device 140. In some embodiments, I/O device 140 is a discrete component, meaning it is not incorporated into another part of computer system 100. In some embodiments, functionality of different components is integrated into a component of computer system 100 that is composed of I/O interface 130 and I/O device 140. Additionally, it should be acknowledged that computer system 100 can include one or more I/O interfaces that connect to one or more I/O devices.

In some embodiments, I/O device 140 can be used to detect a subject (e.g., a user, a person, an animal, another computer system different from computer system 100, and/or an object) and/or an input (e.g., a verbal input, a tap input, a swipe input, a hold-and-drag input, a gaze input, an air-gesture input, a physical input and/or a passive input) from a detected subject. In some embodiments, a user has an account enabled by and/or linked to computer system 100, and computer system 100 can determine if a detected subject is a user with an account (e.g., a known user). Determining if a detected subject has an account includes identifying and/or authenticating the detected subject. In some embodiments, identifying and/or authenticating the detected subject includes comparing detected information to stored information about known users. For example, comparing detected information can include comparing biometric data (e.g., facial scans, iris scans, fingerprint scans, and/or voice recognition data) of detected subjects to stored biometric data of known users. For another example, comparing detected information can include comparing detected identification (e.g., MAC address and/or IP address) of a computer system of a detected subject to known identifications of computer systems of known users. For yet another example, comparing detected information can include comparing detected passcodes (e.g., usernames, passwords, passphrases, and/or PINs). In another example, computer system 100 can detect a known user (e.g., a user that corresponds to an account) and allow access to an environment when the user is identified. In some embodiments, computer system 100 detects unknown subjects and enables guest accounts for the unknown subjects to utilize computer system 100.

In some embodiments, computer system 100 collects information without the need for physical inputs via a sensor of I/O device 140. For example, computer system 100 can recognize subject inputs, including air-gesture inputs and/or passive inputs via a camera. In some embodiments, an air-gesture input is that is a detected intentional motion of a portion of the subject's body without the subject touching an input element in communication with or of the device. In some embodiments, a passive input is a detected input that is not purposefully directed at computer system 100 and/or a component in communication with computer system 100. Examples of passive inputs that can be detected by a camera include, but are not limited to, the subject entering an environment, the motion of the subject through an environment, the location of the subject in the environment, the direction the subject is looking and/or facing, and/or light levels of the environment. In some embodiments, computer system 100 can send visual and/or video data to an application from one or more cameras. For example, computer system 100 can send video data to an application for the purpose of making a video phone call. For another example, computer system 100 can detect the sound of a subject talking, glass breakings, and/or music playing via a microphone of I/O device 140. In some embodiments, computer system 100 recognizes speech as verbal a input from a subject that are detected via a microphone.

In some embodiments, computer system 100 detects information about the environment via other types of sensors of I/O device 140. Examples of such sensors include a flow sensor, a gas sensor, a humidity sensor, a chemical sensor, a contact sensor, a precipitation sensor, a pressure sensor, a proximity sensor, a motion sensor, an occupancy sensor, an electricity sensor, and/or a flood sensor.

In some embodiments, computer system 100 detects a physical input via a physical user-interface device of I/O device 140 that allow a subject to communicate with computer system 100 directly. In some embodiments, computer system 100 includes one or more input devices as described above, and data from one input device is combined with data from one or more other input devices (e.g., that are a part of computer system 100 and/or other computer systems) to gather information about the physical environment.

In some embodiments, computer system 100 outputs visual information via a component of I/O device 140, such as a display screen, a projector, a touch-sensitive display, and/or a light. For example, I/O device 140 can include a light to indicate a status of computer system 100, such as an on/off status. For another example, I/O device 140 can include a display screen for displaying user interface elements. In some embodiments, “outputting” visual information includes sending data (e.g., image and/or video data) to an external display component via a wired or wireless connection, causing the external display component can display the visual information.

In some embodiments, computer system 100 emits sound via an audio output device of I/O device 140, such as a speaker, a headphone, an earbud, an audio jack, an optical audio output, a Bluetooth audio output, an HDMI audio output, and/or a hearing loop. For example, computer system 100 can provide a subject with information and/or audio-based content via speakers of I/O device 140.

In some embodiments, I/O device 140 includes a tactile output device. For example, I/O device 140 can include a haptic element that allows computer system 100 to communicate with a subject who is in close proximity to or in physical contact with computer system 100.

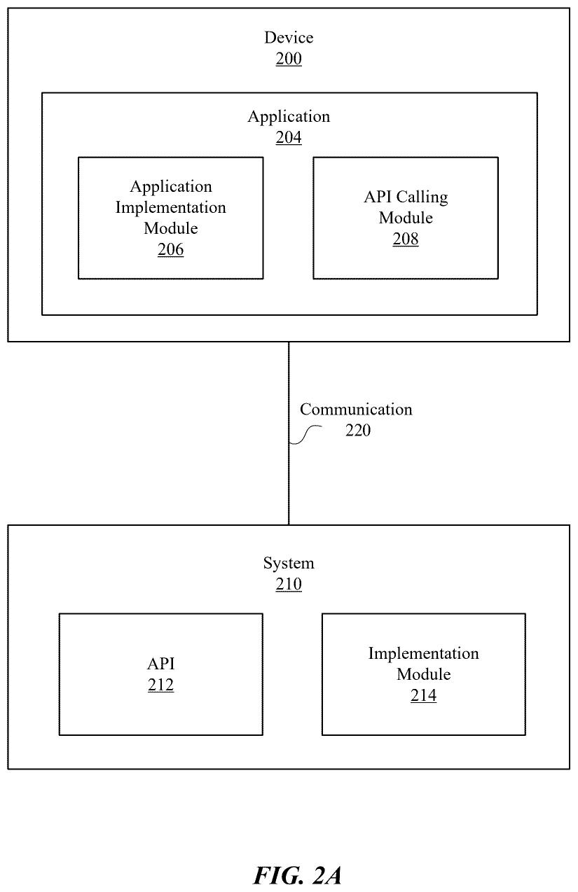

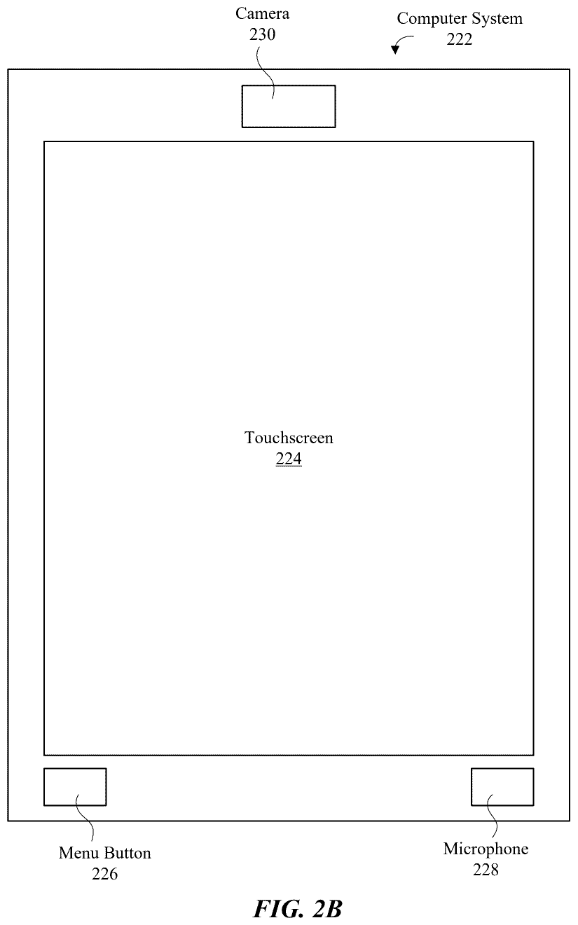

FIG. 2A is a block diagram illustrating a device and a system in accordance with some embodiments. In some embodiments, device 200 is a personal computing device, a server system, a smart phone, a smart watch, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor. In some embodiments, system 210 is an operating system hosted on device 200. In some embodiments, system 210 is an operating system hosted on an external device (e.g., a server, a peripheral device, an accessory, and/or a personal computing device). It should be acknowledged that device 200 and/or system 210 can include more, fewer, and/or different components than illustrated in FIG. 2A.

As illustrated in FIG. 2A, device 200 includes an application (e.g., application 204) that, when executed by one or more processing units, causes device 200 to perform one or more processes and/or methods described herein. In some embodiments, application 204 is an application that is pre-installed on device 200 by a manufacture of device 200 (e.g., a first-party application). In some embodiments, application 204 is an application that is provided to device 200 via an operating system update file (e.g., a first-party application or a second-party application). In some embodiments, application 204 is an application that is installed by a user of device 200, such as through an application store installed on device 200. It should be acknowledged that application 204 can be any suitable type of application such a browser application, a fitness application, a health application, a digital payments application, a media application, a social network application, a messaging application, a maps application, and/or an application that functions as an execution environment for plug-ins, widgets and/or other applications. In some embodiments, application 204 causes device 200 to perform processes 500, 700, 900, 1100, 1200, and 1400.

In some embodiments, a software platform has a set of frameworks that provide objects and/or behaviors that a software developer uses to build applications on the software platform. Software developers use the set of frameworks to display and/or interact with content, and/or manage interactions with the software platform. In some embodiments, an application relies on the set of frameworks for their behavior. In such embodiments, the set frameworks can provide different ways for the software developer to customize behavior of the application to match specific needs of the application.

In some embodiments, interaction with a device includes transfer and/or receipt of one or more API calls between multiple different software processes (e.g., different portions of an operating system, an application and an operating system, or different applications) via one or more APIs. For example, when an input is detected, raw sensor data can be processed into one or more input events that are provided (e.g., via an API) to a receiving software process that makes some determination based on the one or more input events, and then sends (e.g., via an API) information to a software process to perform an operation (e.g., change a device state and/or user interface).

In some embodiments, an object and/or a behavior is accessed via an API, specifying a format for communication between processes, including specifying and grouping available protocols, variables, and/or functions. For example, an API call, sometimes referred to as an API request, can be sent from a first software process to a second software process as a way to accomplish different things. The first software process can request information from the second software process. The first software process can provide information to the second software process. The first software process can request action by the second software process. The first software process can provide information to the second software process about action taken by the first software process.

In some embodiments, while a determination and an operation performed in response can be made by the same software process, alternatively, a determination can be made in a first software process and relayed (e.g., via an API) to a second software process different from the first software process. Relaying the determination can cause an operation to be performed by the second software process. Alternatively, the second software process can relay one or more instructions (e.g., via an API) to a third software process different from the first software process and/or the second software process. The one nor more instructions can be to perform an operation.

It should be acknowledged that some or all subject interactions with a computer system can involve one or more API calls within a step of interacting with the computer system, such as between different software components of the computer system or between a software component of the computer system and a software component of one or more remote computer systems.

As illustrated in FIG. 2A, application 204 includes application implementation module 206 and API calling module 208. In some embodiments, application implementation module 206 includes a set of one or more instructions corresponding to one or more operations performed by application 204. For example, when application 204 is a messaging application, application implementation module 206 can include operations to receive and send messages.

In some embodiments, API calling module 208 is a module that can receive application programming interface (API) calls, respond to API calls, and/or send API calls. In some embodiments, application implementation module 206 communicates with API calling module 208 to communicate with a system, such as system 210. In some embodiments, communication 220 represents one or more API calls and/or one or more other forms of communication between device 200 (e.g., one or more components of device 200) and system 210 (e.g., one or more components of system 210).

As illustrated in FIG. 2A, system 210 includes API 212 and implementation module 214. In some embodiments, API 212 is a software and/or hardware module that can receive API calls, respond to API calls, and/or send API calls. In some embodiments, API 212 is a software module (e.g., a collection of computer-readable instructions) that provides an interface that allows a different module (e.g., API calling module 208) to access and/or use one or more functions, methods, procedures, data structures, classes, and/or other services provided by implementation module 214. For example, API calling module 208 can make an API call to API 212 to access and use a feature of implementation module 214 that is specified by API 212. In some embodiments, API 212 is implemented in part by firmware, microcode, or other low-level logic that executes in part on the hardware component.

In some embodiments, API calling module 208 passes data and/or controls information within implementation module 214 through the one or more API calls via API 212. In some embodiments, API 212 includes one or more features for translating API calls and returns between implementation module 214 and API calling module 208, which allows multiple API-calling modules written in different programming languages to communicate with implementation module 214. For example, API calling module 208 can call using APIs from different providers such as a set of APIs from an OS provider, another set of APIs from a plug-in provider, and/or another set of APIs from another provider (e.g., the provider of a software library) or creator of the other set of APIs.

In some embodiments, implementation module 214 is a system (e.g., operating system, and/or server system) software module that is constructed to perform an operation in response to receiving an API call via API 212. In some embodiments, implementation module 214 is constructed to provide an API response (via API 212) as a result of processing an API call. In some embodiments, implementation module 214 is embodied at least in part in firmware, microcode, or hardware logic. In some embodiments, implementation module 214 calls one or more other components via an underlying API and thus is both an implementation module and an API calling module similar to API calling module 208. For example, implementation module 214 and API calling module 208 can each be any one of an operating system, a library, a device driver, an API, an application program, or other module. It should be acknowledged that implementation module 214 and API calling module 208 can be the same or different type of module from each other.

In some embodiments, various API calls are transferred between API calling module 208 and implementation module 214. It should be acknowledged that transferring API calls can include issuing, initiating, invoking, calling, receiving, returning, and/or responding to a function of calls or messages. In other words, transferring API calls can describe actions by either API calling module 208 or implementation module 214. In some embodiments, in response to an API call from API calling module 208, implementation module 214 returns (via API 212) a value to report to application 204 the capabilities or state of a hardware component of device 200, such as input capabilities and state, output capabilities and state, processing capability, power state, storage capacity and state, and/or communications capability.

In some embodiments, implementation module 214 provides more than one API, with different APIs supplying different aspects of functionality performed by implementation module 214 while protecting some aspects of functionality from view. For example, one API of implementation module 214 can provide a first set of functions and can be exposed to third-party developers while another API of implementation module 214 can be hidden (e.g., not exposed) and provide a subset of the first set of functions and/or provide a different set of functions, such as testing or debugging functions which are not in the first set of functions. It should be acknowledged that implementation module 214 can include additional functions, methods, classes, data structures, and/or other features that are not specified through API 212 and are not available to API calling module 208. In some embodiments, implementation module 214, API 212, and/or API calling module 208 are stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, in response to and/or after receiving information from one or more hardware components of device 200, one or more software modules of device 200, and/or one or more hardware components external to device 200 (e.g., a peripheral device, an accessory device, and/or a server), application 204 executes a task with the information. In some embodiments, the tasks executed include: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling API 212 of system 210 based on the information. In some embodiments, after receiving the information, application 204 executes the task in response to a trigger, such as a detection of an event, a notification received from system 210, an input, and/or a response to a call to an API provided by system 210.

In some embodiments, application 204 calling API 212 (e.g., as part of a task executed by application 204 in response to and/or after receiving information) includes using one or more parameters defined by API 212. In some embodiments, the one or more parameters include a constant, a key, a data structure, an object, an object class, a variable, a data type, a pointer, an array, a list or a pointer to a function or method, and/or another way to reference a data or other item to be passed via API 212.

In some embodiments, in response to and/or after receiving the information, application 204 transfers the information to system 210 via communication 220. In some embodiments, after receiving the information, application 204 transfers the information to system 210 in response to a trigger.

FIG. 2B illustrates a computer system with a touch screen in accordance with some embodiments. In some embodiments, computer system 222 is a portable multifunction device that is a personal device of a user. It should be acknowledged that computer system 222 can be computer system 100 and/or device 200 as described above.

As illustrated in FIG. 2B, computer system 222 includes touch screen 224, touch screen 230, menu button 226, and microphone 228. In some embodiments, computer system 222 displays, via touch screen 224, a user interface (UI) including one or more user interface elements, such as controls, graphics, and/or content. Computer system 222 can then detect an input, such as a tap input using a finger of a user or a stylus, on a user interface element to select the user interface element. In some embodiments, the user interface element is selected when touch screen 223 no longer detects the input.

In some embodiments, microphone 228 is an input device for detecting sounds near computer system 222, including verbal inputs from a user. For example, computer system 222 can detect a subject making a verbal request and/or command to computer system 222 via microphone 228. In some embodiments, computer system 222 collects data and/or information about a subject via microphone 228. For example, computer system 222 can confirm an identity of a subject by matching a verbal input of the subject to a voice profile of a user. At FIG. 2B, microphone 228 is part of computer system 222. In some embodiments, microphone 228 is not part of but is in communication (e.g., via a wired and/or wireless communication) with computer system 222.

In some embodiments, camera 230 is an input device that includes an image or video sensor (such as one or more optical sensors and/or one or more depth sensors) that allows computer system 222 to detect objects and/or inputs (e.g., hand and/or air-gesture inputs) near computer system 222. In some embodiments, computer system 222 collects data and/or information about a subject via camera 230. For example, computer system 222 can confirm an identity a subject by matching a facial scan of a subject to a biometric profile of a user. At FIG. 2B, camera 230 is part of computer system 222. In some embodiments, camera 230 is not part of computer system 222 but is in communication (e.g., via a wired and/or wireless connection) with computer system 222. In some embodiments, camera 230 is always on and continuously capturing images (e.g., periodically and/or without interruption). In some embodiments, camera 230 begins to capture an image when an input and/or interaction is detected.

In some embodiments, menu button 226 is a physical button that, when depressed, provides a physical input for computer system 222. In some embodiments, touch screen 224 and/or menu button 226 are used for turning computer system 222 on and off and/or locking it. For example, menu button 226 can be used to lock computer system 222 by pressing and releasing menu button 226 before a predetermined amount of time (e.g., 2-10 seconds) has passed. For another example, menu button 226 can be used to unlock computer system 222 or start an unlocking process, or to turn computer system 222 on or off by pressing and holding menu button 226 in the depressed state for longer than the predetermined amount of time. In some embodiments, microphone 228 allows computer system 222 to detect a verbal input for turning on or off certain features. Additionally, computer system 222 can optionally have one or more tactile output devices to provide tactile outputs (e.g., haptic outputs) to the user and/or one or more contact intensity sensors to detect the intensity of contacts on touch screen 224

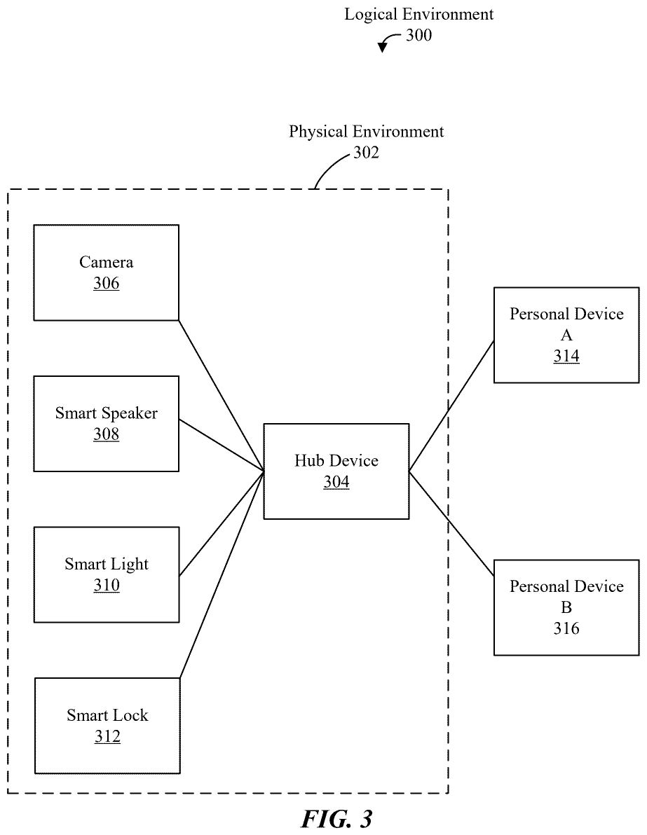

FIG. 3 is a block diagram illustrating a logical environment in accordance with some embodiments. As illustrated in FIG. 3, logical environment 300 includes multiple devices that are in communication (e.g., wired and/or wirelessly) with each other. In some embodiments, logical environment 300 is a software-defined construct that represents state, capabilities, and/or permissible interactions of devices within logical environment 300. For example, logical environment 300 can maintain a data model including (1) unique identifiers for different devices and/or assigned roles for each device, (2) a capability map describing supported functions and/or data formats, (3) a relationship graph indicating pairing status, hierarchy, and/or authorized communication paths, (4) contextual state parameters such as operating modes, user profiles, and/or session data, and/or (5) policy constraints that govern security, power management, and/or permissible commands. In some embodiments, logical environment 300 enables controller devices (e.g., hub device 304, personal device A 314, personal device 316, and/or server 318) to discover, address, control, and/or configure accessory devices (e.g., camera 306, smart speaker 308, smart light 310, smart lock 310, and/or hub device 304). In such embodiments, logical environment 300 can be independent of underlying physical transports and/or physical location.

As illustrated in FIG. 3, logical environment 300 includes (e.g., involves) devices within physical environment 302 (e.g., camera 306, smart speaker 308, smart light 310, smart lock 312, and hub device 304). In some embodiments, physical environment 302 is a physical location, such a home, an office building, a warehouse, and/or an apartment building. It should be acknowledged that techniques described herein can be used with any type of physical location.

In some embodiments, the devices within logical environment 300 work together using one or more of the techniques described herein for detecting an activity in, interacting with, capturing sensor data related to, and/or communicating data about physical environment 302. Such control and/or communication can be via a homeowner and/or administrator of physical environment 302 and/or logical environment 300. In some embodiments, detecting an activity includes detecting and/or identifying a subject within physical environment 302. In some embodiments, in response to detecting the activity, a device (e.g., camera 306, smart speaker 308, smart light 310, smart lock 312, and/or hub device 304) within physical environment 302 captures sensor data in physical environment 302 and/or performs an operation. In such embodiments, the operation can includes allowing or denying a subject access to all or part of physical environment 302, turning on a light, and/or playing music.

At FIG. 3, devices illustrated within the dashed box of physical environment 302 are located within physical environment 302. Such devices include hub device 304, camera 306, smart speaker 308, smart light 310, and smart lock 312. In some embodiments, such devices and are in communication via one or more local area networks (e.g., WiFi and/or ethernet), one or more personal area network (e.g., Bluetooth, Zigbee, and/or Thread), one or more wide area networks (e.g., Internet and/or cellular), and/or one or more peer-to-peer connections.

At FIG. 3, devices illustrated outside the dashed box of physical environment 302 are located outside of physical environment 302 or are mobile with the ability to be inside or outside of physical environment 302. Such devices include personal device A 314, personal device B 316, and server 318. It should be acknowledged that logical environment 300 and physical environment 302 are described for explanatory purposes and that techniques described below can be carried out with more, less, similar, and/or different devices than the devices and/or the configurations discussed above.

In some embodiments, hub device 304 is a stationary or semi-stationary computer system that communicates with accessory devices located within physical environment 302 including, but not limited to, camera 306, smart speaker 308, smart light 310 and/or smart lock 312. In some embodiments, hub device 304 communicates with one or more accessory devices on behalf of (e.g., communicates information to and/or from) one or more controller devices, such as personal device A 314 and/or personal device B 316. In some embodiments, hub device 304 provides centralized coordination, routing, and/or persistent data storage for physical environment 302. In some embodiments, hub device 304 includes a component for detecting other devices, such as a camera, a microphone, and/or Bluetooth and/or Ultra-Wideband (UWB) component. While hub device 304 is depicted in FIG. 3 as a single device, the functionality described below can be implemented with two or more resident devices operating together. Examples of hub device 304 include a smart speaker, a set-top box, a router, a home-automation bridge, a television, and/or a desktop computer.

In some embodiments, hub device 304 communicates with devices outside of physical environment 302. For example, hub device 304 can communicate with other hub devices that belong to different environments. For another example, hub device 304 can communicate with other accessory devices and/or other controller devices. In such embodiments, hub device 304 communicates with other devices through one or more communication channels described above (e.g., a local area network, a personal area network, a peer-to-peer connection, and/or a wide area network).

In some embodiments, hub device 304 includes and/or is in communication with one or more cameras with which hub device 304 can capture an image and/or a video of a subject and/or activity within physical environment 302. In some embodiments, hub device 304 includes and/or is in communication with one or more microphones with which hub device 304 can detect noise (e.g., glass breaking, an alarm going off, and/or a subject talking) within physical environment 302. In some embodiments, a microphone enables hub device 304 to detect verbal inputs from a subject, enabling the subject to interact with hub device 304 without making physical contact with hub device 304 or another computer system within physical environment 302.

In some embodiments, hub device 304 includes and/or is in communication with one or more sensors. In some embodiments, a sensor includes a hardware component capable of detecting (e.g., sensing and/or processing) information about physical environment 302 in proximity to the hardware component. For example, a sensor can be configured to detect information surrounding the sensor, detect information in one or more directions away from the sensor, and/or detect information based on contact of the sensor with an element of physical environment 302. In some embodiments, a hardware component of a sensor includes a sensing component (e.g., a temperature and/or image sensor), a transmitting component (e.g., a radio transmitter and/or laser transmitter), and/or a receiving component (e.g., a radio receiver and/or laser receiver). It should be acknowledged that a sensor can be multiple types of sensors. For example, a sensor can be an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a motion sensor, a range or depth sensor (e.g., RADAR and/or LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. In some embodiments, hub device 304 combines data from multiple sensors to generate information about physical environment 302.

In some embodiments, hub device 304 includes and/or is in communication with one or more speakers that can output audio content into physical environment 302. In some embodiments, hub device 304 includes and/or is in communication with one or more display component, such as a display, a projector, a touch-sensitive display, a head-mounted display (HMD), and/or another device component that presents visual content to a subject. In some embodiments, hub device 304 includes and/or is in communication with a touch-sensitive surface (such as a touchpad or a touch screen display) from which hub device 304 detects inputs.

In some embodiments, camera 306 is a computer system for capturing and/or recording images in the form of digital photos and/or videos. In some embodiments, camera 306 includes and/or is in communication with one or more sensors, such as those mentioned above with respect to hub device 304. In some embodiments, camera 306 captures an image and/or a video continuously and/or in response to detecting an activity via a sensor. In some embodiments, camera 306 combines data from multiple sensors (e.g., that are part of camera 306 and/or one or more additional devices in communication with camera 306) to generate information about physical environment 302. While camera 306 is presented as an individual device, it should be acknowledged that camera 306 can represent multiple devices capable of capturing images and/or videos. For example, camera 306 can include cameras positioned to observe important areas of physical environment 302, such as an entrance, a hallway, and/or a living room area.

In some embodiments, smart speaker 308 is a computer system that converts electrical signals into sound and includes one or more components for outputting audio, such as speakers, audio distributors, soundbars, headphones, earphones, earbuds, television speakers, HMD speakers, audio jacks, optical audio outputs, Bluetooth audio outputs, and/or HDMI audio outputs. For example, smart speaker 308 can output audio content to provide information to a subject. In some embodiments, smart speaker 308 includes one or more microphones that can be used by smart speaker 308 to obtain data and/or information from a subject and/or about physical environment 302. For example, smart speaker 308 can detect if a subject is in the room by detecting a subject talking via a microphone. In some embodiments, the information that smart speaker 308 obtains via the microphone includes verbal inputs from a subject. For example, a subject can request smart speaker 308 to perform an action and/or obtain information for the subject. While smart speaker 308 is presented as an individual device, it should be acknowledged that smart speaker 308 can represent multiple devices capable of outputting audio.

In some embodiments, smart light 310 is a computer system for outputting light and includes one more components for outputting light, such as an incandescent, LED, fiber optic, fluorescent, halogen, and/or neon light. In some embodiments, smart light 310 includes and/or is in communication with one or more sensors, such as those mentioned above with respect to hub device 304. In some embodiments, smart light 310 outputs light or ceases outputting light in response to detecting an activity via a sensor. For example, smart light 310 can turn on in response to detecting a sound via a microphone. For another example, smart light 310 can turn off in response to detecting light from another light source via a light sensor. While smart light 310 is presented as an individual device, it should be acknowledged that smart light 310 can represent multiple devices capable of outputting light.

In some embodiments, smart lock 312 is a computer system for locking and unlocking an area and includes one or more components for such locking, such as a deadbolt, mortise, electromagnet, and/or latch lock. In some embodiments, smart lock 312 includes and/or is in communication with one or more sensors, such as those mentioned above with respect to hub device 304, and locks or unlocks in response to detecting an activity via a sensor. For example, smart lock 312 can lock in response to detecting a contact sensor close, indicating that a door has closed. In some embodiments, smart lock 312 includes and/or is in communication with an input component capable of detecting physical inputs, such as a physical input mechanism (e.g., one or more buttons) and/or a touch sensitive surface and/or screen, and locks or unlocks in response to detecting inputs via the input component. For example, smart lock 312 can unlock in response to detecting a correct PIN code being entered via the input component. In some embodiments, smart lock 312 includes a component for detecting other devices, such as Bluetooth, UWB, and/or Near Field Communication (NFC) component, and locks or unlocks in response to detecting another device. For example, smart lock 312 can unlock in response to detecting, via UWB, a personal device of a user approach smart lock 312. While smart lock 312 is presented as an individual device, it should be acknowledged that smart lock 312 can represent multiple devices capable of locking and unlocking areas.

Personal device A 314 and personal device B 316 are computer systems belonging to users and/or groups of users. For example, personal device A 314 and/or personal device B 316 can be a smart phone, a tablet, a smart watch, a laptop, a communal device, a personal gaming system, a desktop computer, a fitness tracking device, and/or an HMD. In some embodiments, personal device A 314 and personal device B 316 are the same type of device. For example, both personal device A 314 and personal device B 316 can both be smart phones. In other embodiments, personal device A 314 and personal device B 316 are different types of devices. For example, personal device A 314 can be a smartwatch while personal device B 316 can be a smart phone.

In some embodiments server 318 is a remotely accessible digital storage system, that is hosted by a service provider and accessible by registered devices of logical environment 300 (e.g., hub device 304 and/or other device with appropriate user credentials). In some embodiments, hub device 304 communicates with server 318 via a wired or wireless connection, such as Wi-Fi, ethernet, and/or cellular network.

In some embodiments, one or more devices within logical environment 300 communicate with hub device 304 about an activity detected within physical environment 302. For example, in response to unlocking, smart lock 312 can communicate the unlocking to hub device 304. In some embodiments, in response to a device communicating a detected activity, hub device 304 captures a photo and/or a video of physical environment 302 (e.g., via camera 306 and/or a camera of hub device 304). For example, in response to smart speaker 308 communicating about detecting a noise, hub device 304 can send a command to camera 306 to capture video of physical environment 302 near smart speaker 308. In some embodiments, one or more devices within logical environment 300 send information (e.g., images, video, audio, inputs and/or status updates from sensors) regarding an activity to hub device 304 and, in response, hub device 304 analyzes the information. For example, when camera 306 captures a video in response to detecting motion (e.g., as discussed above), camera 306 can send the video to hub device 304 to analyze. For example, hub device 304 can analyze a captured image of physical environment 302 that includes smoke and determine a fire is in physical environment 302.

In some embodiments, devices outside of hub device 304 analyze data to make determination. For example, camera 306 can determine an identity of a subject within an image and send the identity to hub device 304 rather than sending the image. For another example, in response to smart lock 312 detecting the presence of a personal device of a user (e.g., personal device A 314), hub device 304 can request camera 306 to capture an image. After capturing the image, camera 306 can identify a subject in the image to determine whether the image includes the user.

In some embodiments, after a subject is identified (e.g., such as using camera 306 as described above), hub device 304 initiates an authentication process to authenticate the subject. The authentication process can verify and/or confirm the identity of the subject in physical environment 302. For example, if the subject is registered with hub device 304, in conjunction with identifying the subject (e.g., via camera 306 as described above), hub device 304 communicates with a personal device (e.g., personal device A 314 or personal device B 316) registered to the subject through wireless signal (e.g., UWB signal, Bluetooth signal, and/or Wi-Fi signal) to authenticate the subject. In some embodiments, hub device 304 captures and/or receives multiple types of information at once and is able to identify and authenticate the subject simultaneously. For example, in a scenario where the subject in physical environment 302 is speaking while being within the field-of-view of camera 306, hub device 304 can identify the subject using an image captured via camera 306 using facial recognition and authenticate the subject using audio captured via smart speaker 308 to match voice biometrics. In some embodiments, hub device 304 receives an authentication key (e.g., PIN code and/or key fob authenticator) for a user (such as when the user enters the authentication key at smart lock 312) and uses the fact that the authentication key corresponds to same user as detected in physical environment 302 via another device, such as camera 306, to authenticate the user.

In some embodiments, when a subject is identified and not authenticated, hub device 304 sends an authentication request to a personal device (e.g., personal device A 314 or personal device B 316) of the subject. For example, hub device 304 can send a request for a facial scan and/or a PIN to personal device A 314, and consider the subject authenticated upon receiving a notification from personal device 412 that correct information has been entered and/or received. In some embodiments, hub device 304 sends an authentication request to a personal device detected within physical environment 302.

In some embodiments, personal device B 316 is a personal device (e.g., phone, watch and/or tablet) belonging to an administrator (e.g., a resident, owner, and/or caretaker) of logical environment 300. Personal device B 316 can be in communication with hub device 304, and allow the administrator to view and/or remotely control aspects of logical environment 300, such as managing camera views and/or visitor access. In some embodiments, in response to detecting an inquiry (e.g., “Who is at the door?” and/or “Is anyone home?”), personal device B 316 sends a request to hub device 304 to capture an image (e.g., via camera 306) and send the image to personal device B 316. It should be acknowledged that communication between devices within physical environment 302 and personal device B 316 can occur even when personal device B 316 is outside physical environment 302, such as through a secure outside internet or cellular connection.

In some embodiments, hub device 304 sends a notification to personal device B 316 in response to detecting (e.g., directly and/or via another device of ecosystem 400) an activity. For example, hub device 304 can send a notification to personal device B 316 in response to not being able to identify a subject detected in physical environment 302. In some embodiments, the notification sent by hub device 304 to personal device B 316 includes information corresponding to a time and/or a location that the activity and/or subject was detected. In some embodiments, the notification includes an image and/or a video of the activity. For example, the notification can include a video of smoke filling a room where smoke was detected. In some embodiments, the notification includes identifying information (e.g., name, photo, and/or video) of the subject in physical environment 302. In some embodiments, hub device 304 sends a notification without sending images to personal device B 316. For example, an administrator might want to be notified if someone they recognize is at the front door without showing a video feed of a camera at the front door. For another example, the notification might not require an image, such as a notification that a thermostat has detected a temperature outside of a predetermined range. In other embodiments, hub device 304 does not send a notification if certain identified subjects are detected, thus avoiding unnecessary notifications (e.g., an administrator might not care to be notified if their spouse or roommate is detected at the front door).

In some embodiments, the notification sent by hub device 304 to personal device B 316 includes an option to authenticate a detected subject via the notification (e.g., a control within the notification and/or an application corresponding the notification). In some embodiments, if the detected subject is identified, the notification includes a control to initiate communication (e.g., text and/or call) with the detected subject. In some embodiments, the notification includes a control to initiate communication with a subject detected in physical environment 302 via smart speaker 308. In some embodiments, the notification includes escalation options such as a control contacting emergency services. In some embodiments, the administrator corresponding to personal device B 316 creates a profile for a subject in physical environment 302 that automatically authenticates the subject.

In some embodiments, devices within physical environment 302 output content to communicate information to a subject within physical environment 302. For example, in response to a subject being identified but not authenticated, hub device 304 can output via smart speaker 308 a request for the subject to authenticate themselves. For another example, in response to detecting a door being opened, hub device 304 can indicate the door is opened by outputting light via smart light 310 near the door. In some embodiments, devices within physical environment 302 output content to communicate an event escalation. For example, in response to personal device B 316 detecting an input on the control to contact emergency services (e.g., as described above), smart light 310 can flash its lights and smart speaker 308 can output alarm noises.

In some embodiments, hub device 304 allows communication with administrators of logical environment 300. For example, a person in physical environment 302 can request to call an administrator of logical environment 300 (e.g., initiate a call to personal device B 316) to request access to physical environment 302 and/or devices within physical environment 302. In some embodiments, hub device 304 detect such a request directly or via an input on a personal device (e.g., personal device A 314). In such embodiments, the administrator can give allowance to subject in physical environment 302 and personal device B 316 communicates to hub device 304 that the subject in physical environment 302 has been authenticated.

In some embodiments, after the subject in physical environment 302 is identified and authenticated, hub device 304 enables the subject access to physical environment 302 and/or one or more devices with physical environment 302. In some embodiments, hub device 304 enables the subject access to physical environment 302s for a predefined amount of time (e.g., 1 hour to 10 days). In such embodiments, the predefined amount of time can vary depending on the type of authorization provided to the subject. For example, a guest of physical environment 302 can have access for less time than a temporary resident of physical environment 302.

In some embodiments, data about activities detected within physical environment 302 is recorded and stored. Some or all of such activity data can be stored locally and/or on server 318. Storing activity data can allow an administrator of physical environment 302 to review a history of activity in physical environment 302.

Reference is made herein to environmental context (also referred to herein as a “context of an environment” and/or “a context corresponding to an environment”). In some embodiments, an environmental context is a context based on one or more characteristics of physical environment 302 (e.g., subjects, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) by detecting input (e.g., via one or more input devices) and/or receiving data (e.g., from one or more other devices and/or components in communication with the device).

Reference is made herein to user context (also referred to herein as a “context of a user” and/or “a context corresponding to a user”). In some embodiments, a user context is a context based on one or more characteristics of a user. For example, a user context can include a subject's appearance and/or clothing, personality, actions, behavior, movement, location, and/or pose. In some embodiments, a device (e.g., using an agent) determines a user context (e.g., to be currently true, occurring, and/or applicable) by detecting input (e.g., via one or more input devices) and/or receiving data (e.g., from one or more other devices and/or components in communication with the device). In some embodiments, a device determines user context based on historical context and/or learned characteristics of the subject, where one or more characteristics of the subject are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include an internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) by detecting input (e.g., via one or more input devices) and/or receiving data (e.g., from one or more other devices and/or components in communication with the device). In some embodiments, a device (e.g., using an agent) determines an operational context (e.g., to be currently true, occurring, and/or applicable) by assessing one or more internal states (e.g., accessed, retrieved, and/or queried by a process of the device).

Reference is made herein to “performing output,” “causing output,” “outputting,” and/or similar phrases. Such phrases can be interchangeable and/or include computer system itself performing such output or causing another computer system perform such output. Reference is made herein to “displaying,” “causing display of,” “outputting visual content,” and/or similar phrases. Such phrases can be interchangeable and/or include computer system itself displaying or causing another computer system perform such display. Reference is made herein to “outputting audio,” “causing output of audio,” “providing audio output,” and/or similar phrases. Such phrases can be interchangeable and/or include computer system itself outputting audio or causing another computer system perform such output.

Attention is now directed towards embodiments of user interfaces (“UI”) and associated processes that are implemented on an electronic device, such as computer system 100, device 200, computer system 222, hub device 304, camera 306, smart speaker 308, smart light 310, smart lock 312, personal device A 314, personal device B 316, or server 318.

FIGS. 4A-4H illustrate exemplary user interfaces for managing guest access in an environment while on a call in accordance with some embodiments. The user interfaces in these figures are used to illustrate the processes described below, including the processes in FIG. 5.

In some embodiments, managing guest access is a process where an administrator of an environment is able to grant access to a guest within the environment and/or create a guest profile for the guest within an ecosystem (e.g., a set of one or more interconnected computer systems and/or accessories that interact with subjects within the environment) corresponding to the environment. In some embodiments, the environment is a location (e.g., a house, an apartment, a building, a living room and/or a locality configured by a user and/or defined by a computer system) that includes multiple accessories (e.g., a camera, a speaker, and/or other type of accessory) in communication with each other and/or a resident device (e.g., resident device 400). In such embodiments, the multiple accessories can be in communication with one or more controllers (e.g., personal device 424) directly or via the resident device. In some embodiments, an accessory can detect the guest and communicate with the resident device within the environment to determine how to respond to detection of the guest as described further below. For example, in response to receiving a communication that the guest is at the environment, the resident device can communicate with a personal device of an administrator (e.g., personal device 424). In some embodiments, in response to receiving the communication, the administrator is able to review the guest at the environment. In such embodiments, reviewing the guest can include the ability to grant permission to the guest in the environment and/or create a guest profile for the guest.

In some embodiments, an administer is a resident of the environment with control of access to the environment and/or to the one or more accessories in the environment for others. In some embodiments, a resident is a person and/or a device with access to the environment and/or to the one or more accessories in the environment but does not have control of access for others. In some embodiments, similar to a resident, a guest is a person and/or a device without control of access for others. In such embodiments, the guest might have different access to the environment on and/or to the one or more accessories in the environment than a resident.

FIGS. 4A-4H illustrate resident device 400 on the left and personal device 424 on the right. At FIG. 4A, resident device 400 is mounted on a wall at an entryway of a home and is in communication with personal device 424 and/or one or more accessory devices. It should be recognized that a home and aspects of resident device 400 are used as an example and that other locations (e.g., and/or environment such as, an office building, a warehouse, a parking lot, a public park, and/or an apartment building) and/or other aspects of resident device 400 can be used with techniques described herein.

In some embodiments, resident device 400 is a device that is installed within the home (e.g., a fixture) and/or is part of a local area network within the home. In some embodiments, resident device 400 is a device that is actively connected to a network within the home and/or consistently part of a network within the home. In some embodiments, resident device 400 is an always-on device within the home. In some embodiments, resident device 400 is a semi-permanent device and/or fixture (e.g., once installed in an environment, is confined to that environment), a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, and/or a fixed-location device. In some embodiments, resident device 400 includes and/or is in communication with one or more cameras. In some embodiments, resident device 400 includes one or more components and/or features described above in relation to computer system 100.

FIGS. 4A-4H illustrate personal device 424 as a smart phone belonging to the administrator. It should be recognized that personal device 424 can be other types of computer systems such as a tablet, a smart watch, a laptop, a communal device, an accessory, a personal gaming system, a desktop computer, a fitness tracking device, and/or a head-mounted display (HMD) device. In some embodiments, personal device 424 includes and/or is in communication with one or more input devices (e.g., a sensor, a camera, a lidar detector, a motion sensor, an infrared sensor, a touch-sensitive surface, a physical input mechanism, and/or a microphone). In some embodiments, personal device 424 includes and/or is in communication with one or more output devices (e.g., a display screen, a projector, a touch-sensitive display, and/or a speaker). In some embodiments, personal device 424 includes one or more components and/or features described above in relation to computer system 100.

While the examples in FIGS. 4A-4H include resident device 400 and/or personal device 424 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, another computer system within the environment detects one or more inputs.

As illustrated in FIG. 4A, resident device 400 displays identification user interface 412. In some embodiments, resident device 400 displays identification user interface 412 in response to receiving a communication from an accessory within the environment that is unable to identify the guest. In such embodiments, identification can be defined as the accessory detecting a guest within the environment and, in response to detecting the guest, attempting to identify an identity of the guest. In some embodiments, attempting to identify the identity of the guest includes attempting recognition through media captured by a camera, biometrics (e.g., face and/or voice), and/or communication (e.g., via UWB, Bluetooth, WiFi, NFC, and/or the like) with a personal device of the guest to verify the identity of the guest. In some embodiments, resident device 400 detects an approaching guest and, in response, communicates with the accessory to attempt to identify the approaching guest. For example, in response to receiving a communication of the approaching guest, the accessory can attempt to identify the approaching guest by capturing an image of the approaching guest.

As illustrated in FIG. 4A, identification user interface 412 includes an indication that the guest is unable to be identified (e.g., “Welcome” and “Home does not recognize you. Please identify yourself to home members.”), control 412a, and contact control 412b. It should also be recognized that more, fewer, and/or different elements can be included in identification user interface 412.

In some embodiments, authentication is defined as a recognition and/or authorization of a guest. In some embodiments, authentication requires two factors in order to be successful. In such embodiments, the two factor authentication can include multiple different forms of authentication, each having different requirements. For example, a first form of authentication can include identifying the guest in media captured via a camera. In such an example, a second form of authentication can include detecting a personal device of the guest in an environment and/or receiving an indication that a PIN code corresponding to the guest has been recently entered. As will be discussed further below with reference to FIGS. 4F-4G, a PIN code can be assigned to a guest by the administrator in a guest profile.

In some embodiments, in response to detecting an input directed to PIN control 468b, resident device 400 ceases display of identification user interface 412 and displays a PIN code user interface to allow a guest to authenticate themselves. In some embodiments, in response to detecting an input directed to contact control 412b, resident device 400 ceases display of identification user interface 412 and sends an invitation to personal device 424 (e.g., the personal device of the administrator) to join a telecommunications connection. In some embodiments, the telecommunications connection is a video call (e.g., receiving and/or transmitting audio data and video data). In other embodiments, the telecommunications connection call is an audio call (e.g., receiving and/or transmitting audio data). In some embodiments, in response to detecting an input directed to contact control 412b, resident device 400 ceases display of identification user interface 412 and sends an invitation to another computer system belonging to a resident of the environment. In some embodiments, in response to detecting an input directed to contact control 412b, resident device 400 displays a messaging user interface to allow the guest to send a message to the administrator.

At FIG. 4A, resident device 400 detects input 405a1 directed to contact control 412b. It should be recognized that input 405a1 is an example of a selection input as a tap input but can be other inputs, such as a mouse click, a verbal input (e.g., “Call the homeowner.”), and/or a button press. At FIG. 4A, in response to detecting input 405a1, resident device 400 sends an invitation to personal device 424 to join a telecommunications connection. In some embodiments, in response to detecting input 405a1, resident device 400 initiates a telecommunications connection between itself and personal device 424. It should also be recognized that input 405a1 is an example of a first type of selection input and other intermediate steps may be needed before resident device 400 sends the invitation to personal device 424. For example, resident device 400 can display a list of administrators that a guest can pick from before sending the invitation to initiate the telecommunications connection with a personal device of a selected administrator.

As illustrated in FIG. 4A, in response to receiving an invitation to join a telecommunications connection from resident device 400, personal device 424 displays call user interface 436. In some embodiments, rather than display call user interface 436, personal device 424 displays a notification on a home screen that resident device 400 is calling.

As illustrated in FIG. 4A, call user interface 436 includes call indication 448 (e.g., “Front door calling”) which indicates a location of the origin of the call. In some embodiments, personal device 424 displays call indication 448 differently if the location of the origin of the call is different. For example, if the environment has another resident device at the back door and personal device 424 receives an invitation to join a telecommunications connection from the other resident device at the back door, personal device 424 displays call indication 448 as, “Back door calling.”

As illustrated in FIG. 4A, call user interface 436 includes decline control 436a and answer control 436b. In some embodiments, in response to detecting an input directed to decline control 436a, personal device 424 rejects the invitation to join a telecommunications connection with resident device 400 and ceases display of call user interface 436. In some embodiments, in response to detecting an input directed to answer control 436b, personal device 424 accepts the invitation to join a telecommunications connection with resident device 400 and establishes the telecommunications connection. It should also be recognized that more, fewer, and/or different elements can be included in call user interface 436.

At FIG. 4A, resident device 400 detects input 405a2 directed to answer control 436b. It should be recognized that input 405a2 is an example of a selection input as a tap input but can be other inputs, such as a mouse click, a verbal input (e.g., “Answer the call.”), and/or a button press.

In between FIGS. 4A and 4B, in response to detecting input 405a2, personal device 424 establishes the telecommunications connection with resident device 400 and begins the call between the administrator and the guest at the entrance of the environment. As illustrated in FIG. 4B, in response to a successful telecommunications connection, resident device 400 ceases display of identification user interface 412 and displays contact user interface 470. Contact user interface 470 includes administrator indication 430, icon 490, PIN control 412a, and exit control 402. In some embodiments, administrator indication 430 indicates to the guest that they are on an active call with the administrator. In some embodiments, administrator indication 430 includes the name of the administrator to indicate which administrator, if multiple, they are on the active call with. As illustrated in FIG. 4B, icon 490 is an image of a person with no features. In some embodiments, icon 490 includes an image of an administrator such as their contact card or user profile picture. At FIG. 4B, resident device 400 displays icon 490 in response to a determination that the setting for a call between the administrator and the guest includes a setting that the camera of the administrator should be off when starting the telecommunications connection. In some embodiments, the setting for the call between the administrator and the guest includes starting the call with the camera of the administrator being on. For example, when the guest is identified but not authenticated, a security setting can determine the guest is a known subject and begin the telecommunications connection with the camera of the administrator being on.

In some embodiments, in response to detecting an input directed to exit control 402, resident device 400 ends the call. In such embodiments, personal device 424 communicates with resident device 400 and/or a camera accessory to not grant access to the guest.

As illustrated in FIG. 4B, in response to a successful telecommunications connection, personal device 424 ceases display of decline control 436a and answer control 436b and displays live feed 460, allow control 484 (e.g., “Allow this person?”), and camera control 496. Additionally, in response to a successful telecommunications connection, personal device 424 updates call indication 448 to indicate that the ongoing call is originating from the front door. It should also be recognized that more, fewer, and/or different elements can be included, removed, and/or changed in call user interface 436. For example, in some embodiments, a microphone control that turns off and/or on a microphone of personal device 424 may also be included in call user interface 436.

As illustrated in FIG. 4B, live feed 460 is a live feed captured by a camera connected to and/or in communication with resident device 400 and/or the accessory and transmitted to personal device 424. As illustrated in FIG. 4A, live feed 460 includes guest representation 460a (e.g., a representation of the guest at the environment), and live feed 472. Live feed 472 is a live feed captured by a camera connected to and/or in communication with personal device 424. As illustrated in FIG. 4B, live feed 472 includes icon 472a when the camera of personal device 424 is turned off. As illustrated in FIG. 4B, icon 472a is an image of a person with no features. In some embodiments, icon 427a includes an image of the administrator such as their contact card or user profile picture. In some embodiments, rather than a live feed, personal device 424 outputs audio of the guest in the environment captured by the camera accessory and/or resident device 400 (e.g., similar to a phone call) instead of live feed 460. In some embodiments, rather than a live feed, resident device 400 displays a profile picture of the guest (e.g., in the scenario that the guest has a guest profile)

As illustrated in FIG. 4B, allow control 484 is a suggested action for the administrator that allows them to reject (e.g., reject control 484b) or allow (e.g., allow control 484) access to the guest in the environment. An input directed to allow control 484 allows the guest within the environment and/or creates a guest profile for the guest with the environment's ecosystem. An input directed to reject control 484 indicates that the administrator does not want the guest to have access in the environment. In some embodiments, in response to detecting an input on reject control 484b, personal device 424 ends the telecommunications connection. In some embodiments, after detecting an input directed to reject control 484b, personal device 424 sends information to resident device 400 and/or one or more accessory devices corresponding to the environment. In such embodiments, after receiving information from personal device 424, resident device 400 and/or the one or more accessory devices can output an indication (e.g., display an indication, output an audio output, and/or output a light output) to the guest in the environment. For example, resident device 400 can display a message that the administrator rejected access to the guest. For another example, a speaker in the environment can output a statement that the administrator rejected access to the guest. As illustrated in FIG. 4B, personal device 424 displays exit control 474. In some embodiments, in response to detecting an input corresponding to exit control 474, personal device 424 ends the call and does not provide access to the guest in the environment.

As illustrated in FIG. 4B, camera control 496 includes a line over camera control 496 to show that the camera of personal device 424 is off. Camera control 496 allows the administrator to control whether the camera of personal device 424 is on or off. In this example, the camera of personal device 424 being off is based on a determination that the camera should remain off while starting the telecommunications connection. In some embodiments, the determination is based on a previous setting of personal device 424, resident device 400, and/or an application corresponding to the telecommunications connection. For example, when the guest in the environment is not identified, personal device 424 can determine that the guest in the environment may not be a person that the administrator would recognize and start the telecommunications connection with the camera off. In some embodiments, based on a determination that different set of conditions are met, personal device 424 starts the telecommunications connection with the camera on. For example, when the guest in the environment is identified but not authenticated, personal device 424 can determine that the guest in the environment is a known subject that the administrator would recognize and start the telecommunications connection with the camera on. In this example, live feed 472 would not include icon 472a and instead include a live feed captured by a camera included in and/or in communication with personal device 424.

At FIG. 4B, personal device 424 detects input 405b, from the homeowner, directed to camera control 496. It should be recognized that input 405b is an example of a selection input as a tap input but can be other inputs, such as a mouse click, a verbal input (e.g., “Turn on the camera.”), and/or a button press.

As illustrated in FIG. 4C, in response to detecting input 405b, personal device 424 turns the administrator's camera on. After or in response to turning on the administrator's camera on, personal device 424 removes icon 472a and displays a live feed captured by a camera included in and/or in communication with personal device 424. The live feed includes administrator representation 420 (e.g., a representation of the administrator corresponding to personal device 424). While the administrator's camera is turned on, personal device 424 sends video data to resident device 400. As illustrated in FIG. 4C, in response to detecting input 405b and personal device 424 turning on the administrator's camera, resident device 400 removes icon 490 and displays live feed 408.

At FIG. 4C, personal device 424 detects input 405c directed to allow control 484. It should be recognized that input 405c is an example of a selection input as a tap input but can be other inputs, such as a mouse click, a verbal input (e.g., “They are allowed.”), and/or a button press.

As illustrated in FIG. 4D, in response to detecting input 405c and while maintaining live feed 472, personal device 424 displays guest access menu 432 that includes controls for different levels of guest access. Guest access menu 432 is a user interface element that allows the administrator to select how long the guest has access to the environment. As illustrated in FIG. 4B, guest access menu 432 includes one hour control 432a, day control 432b, and schedule control 432c. In some embodiments, in response to detecting an input directed to one hour control 432a, personal device 424 communicates with resident device 400 to grant access to the environment for one hour. In some embodiments, in response to detecting an input directed to day control 432b, personal device 424 communicates with resident device 400 to grant access to the environment for the rest of the day. In some embodiments, in response to detecting an input directed to schedule control 432c, personal device 424 ceases display of call user interface 436 and displays a schedule user interface that gives the administrator the ability to create an exact schedule for when the guest is allowed to enter the environment and/or how long they can remain in the environment. In some embodiments, different levels of access give the guest access to the same one or more accessories within the environment. In other embodiments, different levels of guest access include access to different types of one or more accessories within the environment.

In some embodiments, at FIG. 4D, personal device 424 detects input 405d1 directed to day control 432b, causing personal device 424 to react as discussed below with respect to FIG. 4E. It should be recognized that input 405d1 is an example of a selection input as a tap input but can be other inputs, such as a mouse click, a verbal input (e.g., “Give access for today.”), and/or a button press. In some embodiments, at FIG. 4D, personal device 424 detects input 405d2 as a tap directed to schedule control 432c, causing personal device 424 to react as discussed below with respect to FIG. 4F. It should be recognized that input 405d2 is an example of a selection input as a tap input but can be other inputs, such as a mouse click, a verbal input (e.g., “Let make them a profile.”), and/or a button press.

As illustrated in FIG. 4E, in response to detecting input 405d1 at day control 432b, personal device 424 ceases display of allow control 484 and guest access menu 432 and displays confirmation indication 456 (e.g., Allowed until end of day.”). Confirmation indication 456 indicates to the administrator that the guest in the environment has been granted permission for the day. In some embodiments, personal device 424 outputs a request for the administrator to further specify what accessories the guest will have access to before displaying confirmation indication 456.

At FIG. 4E, in response to detecting input 405d1 on day control 432b, personal device 424 communicates with resident device 400 to allow the guest access for the rest of the day. In some embodiments, the end of the day is when the administrator changes a mode (e.g., sleep mode or lock mode) of personal device 424, resident device 400, and/or one or more accessories in the environment. In some embodiments, the end of the day is at midnight on the day when the administrator gave the guest access. At FIG. 4E, in response to receiving a communication from personal device 424 to allow the guest access for the rest of the day, resident device 400 authenticates the guest at the entryway of the environment and grants the guest access to the environment. As illustrated in FIG. 6E, in response to personal device 424 communicating with the resident device 400, resident device 400 displays confirmation indication 444 (“Access granted, Welcome!). Confirmation indication 444 indicates to the guest in the environment that they have been granted access.

In FIGS. 4F-4H, personal device 424 displays different user interfaces initiated by personal device 424 in response to detecting input 405d2 on schedule control 432c. As illustrated in FIG. 4F, in response to detecting input 405d2, personal device 424 ceases display of call user interface 436 and displays review user interface 468. As illustrated in FIG. 4F, review user interface 468 includes a series of user interface elements that allow a user to view, create, and/or edit a guest profile (e.g., including data and permissions) corresponding to the guest, including image 480, create name control 92, PIN control 404, schedule control 416, accessories control 428, and remote access control 440.

As illustrated in FIG. 4F, image 480 is the same image as guest representation 460a. In some embodiments, image 480 is an image of when the guest was detected and/or identified, it should be recognized that personal device 424 uses image 480 as the profile image for the guest. In some embodiments, a default profile image (e.g., of a blank head icon) is displayed within image 480 instead of the same image as guest representation 460a. Additionally, as illustrated within FIG. 4F, personal device 424 displays add control 480a within image 480. In some embodiments, in response to detecting an input directed to add control 480a, personal device 424 ceases display of review user interface 468 and displays a photo user interface that allows the administrator to select a different image for the guest.

As illustrated in FIG. 4F, create name control 492 has the words, “Create name” within create name control 492, indicating that no name has been created for the guest. In some embodiments, in response to detecting an input directed to create name control 492, personal device 424 displays a digital keyboard that allows the administrator to create a name for the guest.

As illustrated in FIG. 4F, PIN control 404 does not include any text or numbers within PIN control 404, indicating that no PIN has been created for the guest. In some embodiments, in response to detecting an input directed to PIN control 404, personal device 424 displays a digital keyboard to allow the administrator to create a PIN for the guest. Additionally, as illustrated in FIG. 4E, personal device 424 displays edit control 404a within PIN control 404. In some embodiments, in response to detecting an input to edit control 404a when no PIN has been created, personal device 424 displays a digital keyboard to allow the administrator to create a PIN for the guest. In some embodiments, in response to detecting an input to edit control 404a when a PIN has been created, personal device 424 displays a digital keyboard to allow the administrator to edit an existing PIN for the guest. It should be recognized that once a PIN is created for the guest, the guest can use it as a means of authentication and/or entry.

As illustrated in FIG. 4F, schedule control 416 does not include any dates and/or times within schedule control 416, indicating that no schedule has been created for the guest. In some embodiments, in response to detecting an input directed to schedule control 416, personal device 424 ceases display of review user interface 468 and displays a scheduling user interface to allow the administrator to create a custom schedule for the guest. For example, the administrator can create a schedule that only allows the guest access on Monday, Wednesday, and Friday, from the times of 8:00 AM to 11:00 AM. For another example, the administrator can create a schedule that allows the guest access to the environment every Sunday, all day. Additionally, as illustrated in FIG. 4F, personal device 424 displays edit control 416a within schedule control 416. In some embodiments, in response to detecting an input to edit control 416a when no schedule has been created, personal device 424 ceases display of review user interface 468 and displays a scheduling user interface to allow the administrator to create a schedule for the guest. In some embodiments, in response to detecting an input to edit control 416a when a schedule has been created, personal device 424 ceases display of review user interface 468 and displays a scheduling user interface to allow the administrator to edit an existing schedule for the guest. It should be recognized that once a schedule is created for the guest, the guest is only granted access to the environment including particular accessories defined in accessories control 428 during the selected times and/or dates of the schedule. In some embodiments, if the guest tries to access the environment during a time not selected within the schedule, resident device 400 communicates with personal device 424 to notify the administrator.

As illustrated in FIG. 4F, accessories control 428 does not include any selected accessory indicators within accessories control 428, indicating that no accessories have been selected to be accessed by the guest. In some embodiments, in response to detecting an input directed to accessories control 428, personal device 424 ceases display of review user interface 468 and displays an accessory user interface including a list of accessories in the environment. In such embodiments, in response to an input to select an accessory, personal device 424 enables the accessory to be controlled by the guest. For example, the administrator can grant the guest access to use the television, the lights in the living room, and access into the laundry room. For another example, the administrator can grant the guest access to every accessory in the environment. For another example, the administrator can grant the guest access to only the living room and the backyard. Additionally, as illustrated in FIG. 4F, personal device 424 displays edit control 428a within accessories control 428. In some embodiments, in response to detecting an input to edit control 428a when no accessories have been selected, personal device 424 ceases display of review user interface 468 and displays an accessory user interface to allow the administrator to select which accessories within the environment can be accessed by the guest. In some embodiments, in response to detecting an input to edit control 428a when accessories have been selected, personal device 424 ceases display of review user interface 468 and displays an accessory user interface to allow the administrator to edit which accessories within the environment can be accessed by the guest. In some embodiments, if the guest tries to access and/or use non-selected accessories, resident device 400 can communicate with personal device 424 to notify the administrator.

In some embodiments, in response to detecting an input directed to remote access control 440, personal device 424 grants the guest the ability to remotely control accessories that the guest has been granted access from their personal device while their personal device is away from the environment. For example, the guest can turn on the lights remotely if given remote access. For another example, the guest can unlock the front door remotely if given remote access.

As illustrated in FIG. 4E, in response to detecting input 405d2, personal device 424 displays live feed 460 that includes guest representation 460a (e.g., a representation of the guest) within review user interface 468. Live feed 460 is displayed in a different area and size as compared to live feed 460 display in call user interface 436. It should be recognized that the size and location of live feed 460 in review user interface 468 is an exemplary location and size to show that the call with resident device 400 is ongoing. In some embodiments, live feed 460 in review user interface 468 is displayed at a different size (e.g., smaller and/or larger) and/or a different location. In some embodiments, live feed 460 is not displayed in review user interface 468 while the call is ongoing. In some embodiments, personal device 424 ends the call with resident device 400 while displaying review user interface 468. In such embodiments, personal device 424 communicates with resident device 400 to grant the guest access to the environment, where the type of access (e.g., schedule and/or accessories) is updated after the administrator creates the guest profile.

In between FIG. 4F and FIG. 4G, the administrator enters information for the guest profile. For example, the administrator provides instructions on when and what access the guest can have. As illustrated in FIG. 4G, the administrator is granting the guest a PIN code of “0714”, (e.g., PIN code indication 404b) for access to the guest every Tuesday and Thursday (e.g., schedule indication 416b) for the living room and entryway of the environment (e.g., accessories indication 428b).

At FIG. 4G, personal device 424 detects input 405g directed to done control 452. It should be recognized that input 405c is an example of a selection input as a tap input but can be other inputs, such as a mouse click, a verbal input (e.g., “Create this profile for Dave.”), and/or a button press.

As illustrated in FIG. 4H, in response to detecting input 405g, personal device 424 ceases display of review user interface 468 and redisplays call user interface 436. As illustrated in FIG. 4H, call user interface 436 includes live feed 460, live feed 472, and indication 478. At FIG. 4H, in response to detecting input 405g, personal device 424 creates and saves the guest profile and displays indication 478. Indication 478 is used to indicate to the administrator that the guest profile has been created.

At FIG. 4H, in response to detecting input 405g, personal device 424 communicates with resident device 400 and to grant the guest access to the environment using Dave's profile. As illustrated in FIG. 4H, after personal device 424 communicates with resident device 400 to grant the guest access, resident device 400 displays indication 464 (e.g., “Access granted.” And “Welcome Dave!”) while maintaining the call with the administrator. As illustrated in FIG. 4H, indication 464 includes the name given to the guest by the administrator. In some embodiments, resident device 400 displays indication 464 after the call with the administrator has ended. In some embodiments, indication 464 includes other identifying indications such as the profile picture corresponding to the profile of the guest.

FIG. 5 is a flow diagram illustrating a process (e.g., process 500) for providing guest access to an environment while on a call in accordance with some embodiments. Some operations in process 500 are, optionally, combined, the orders of some operations are, optionally, changed, and some operations are, optionally, omitted.

As described below, process 500 provides an intuitive way for providing guest access to an environment while on a call. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a first computer system (e.g., 424) that is in communication (e.g., wired communication and/or wireless communication) with (and/or includes) one or more output devices (e.g., a display component, an audio generation component, and/or a haptic generation component) and one or more input devices (e.g., a camera, a depth sensor, a microphone, a hardware input mechanism, a rotatable input mechanism, a physical input mechanism, and/or a touch-sensitive surface). In some embodiments, the first computer system is a watch, a phone, a tablet, a fitness tracking device, a processor, a head-mounted display (HMD) device, and/or a personal computing device. In some embodiments, the display component includes a display screen, a projector, and/or a touch-sensitive display. In some embodiments, the audio generation component includes a speaker, a smart speaker, a soundbar, a headphone, an earphone, an earbud, an audio jack, an optical audio output, and/or Bluetooth audio output.

The first computer system displays (502), via the one or more output devices, a call user interface (e.g., 436) corresponding to a connection (e.g., a call, a wired and/or wireless connection, an audio call, and/or a video call) with a second computer system (e.g., 400) external to the first computer system, wherein the call user interface includes a user interface element (e.g., 484 and/or 432) for providing guest access to an environment (e.g., a home, a business, an area, a predefined area, a defined area, a group of one or more devices, and/or a group of one or more accessory devices) (e.g., as describe above with respect to FIG. 4B). In some embodiments, the call user interface includes a plurality of user interface elements, such as the user interface element for providing guest access to the environment and a user interface element for controlling an output device of the one or more output devices.

The first computer system detects (504), via the one or more input devices, a set of one or more inputs (e.g., 405c, 405d1, 405d2, and/or 405g) that includes: (506) a first input (e.g., 405c) that corresponds to a request to provide a respective level of guest access to the environment (e.g., as describe above with respect to FIG. 4C); and a (508) second input (e.g., 405d1, 405d2, and/or 405g) that is directed to the user interface element for providing guest access to the environment (e.g., as describe above with respect to FIG. 4D and/or FIG. 4G). In some embodiments, the respective level of guest access to the environment includes a period of time, one time access, and/or a schedule. In some embodiments, the set of one or more inputs is a single input. In some embodiments, the second input is the first input. In some embodiments, the second input is different and/or separate from the first input.

In response to (510) detecting the set of one or more inputs, in accordance with a determination that the respective level of guest access to the environment is a first level of guest access (e.g., 432c) to the environment, the first computer system provides (512) (e.g., to a subject corresponding to and/or detected by the second computer system) the first level of guest access to the environment (e.g., as describe above with respect to FIGS. 4F-4H).

In response to (510) detecting the set of one or more inputs, in accordance with a determination that the respective level of guest access to the environment is a second level of guest access (e.g., 432a and/or 432b) to the environment, the first computer system provides (514) (e.g., to a subject corresponding to and/or detected by the second computer system) the second level of guest access to the environment, wherein the second level of guest access to the environment is different from the first level of guest access to the environment (e.g., as describe above with respect to FIG. 4E). Providing different levels of guest access to an environment via a call user interface corresponding to a connection between different computer systems allows the first computer system to enable guest access to the environment for others directly from a call, thereby reducing the number of inputs needed to perform an operation and/or performing an operation when a set of conditions has been met without requiring further user input.

In some embodiments, the first level of guest access (e.g., 432c) includes a frequency (e.g., a schedule, such as a day, month, year, and/or time) of access (e.g., 416) (e.g., as described above with respect to FIGS. 4F-4G). In some embodiments, the second level of guest access includes another frequency (e.g., a schedule, such as a day, month, year, and/or time) of access different from the frequency of access. Providing guest access for a particular frequency to an environment via a call user interface corresponding to a connection between different computer systems allows the first computer system to configure different guest access levels to the environment for others directly from a call, thereby reducing the number of inputs needed to perform an operation and/or performing an operation when a set of conditions has been met without requiring further user input.

In some embodiments, the first level of guest access (e.g., 432c) includes access (e.g., 428) to (e.g., control, access to a current status, ability to modify a state of) one or more computer systems (e.g., an accessory device, a communal device, a personal device, a television, and/or a speaker) in the environment (e.g., locations included in 428b). In some embodiments, the one or more computer systems are external to the first computer system (e.g., 424) and the second computer system (e.g., 400) (e.g., as described above with respect to FIGS. 4F-4G). In some embodiments, the second level of guest access includes access to (e.g., control, access to a current status, ability to modify a state of) one or more other computer systems (e.g., an accessory device, a communal device, a personal device, a television, and/or a speaker) in the environment different from the other or more computer systems. In some embodiments, the one or more other computer systems are external to the first computer system and the second computer system. In some embodiments, the second level of guest access does not include access to (e.g., control, access to a current status, ability to modify a state of) another computer system (e.g., an accessory device, a communal device, a personal device, a television, and/or a speaker) in the environment. In some embodiments, the other computer system is external to the first computer system and the second computer system. Providing guest access to one or more computer systems in an environment via a call user interface corresponding to a connection between different computer systems allows the first computer system to enable guest access to particular computer systems for others directly from a call, thereby reducing the number of inputs needed to perform an operation and/or performing an operation when a set of conditions has been met without requiring further user input.

In some embodiments, the first level of guest access (e.g., 432c) is provided to a subject (e.g., represented by 460a) (e.g., a personal device, a person, and/or a wearable device) detected (e.g., via receiving a communication from the subject, via detection of the subject on a wireless network of and/or associated with the environment, via a camera, and/or via a microphone) in the environment. In some embodiments, the first level of guest access (e.g., 432c) includes remote access (e.g., 440) to one or more computer systems in the environment (e.g., locations included in 428b). In some embodiments, the one or more computer systems are external to the first computer system and the second computer system (e.g., as described above with respect to FIGS. 4A-4G). In some embodiments, the second level of guest access is provided to the subject. In some embodiments, the second level of guest access does not include remote access (e.g., and only local access, such as while the subject is connected to a wireless network of and/or associated with the environment) to the one or more computer systems in the environment. In some embodiments, remote access is while the subject is not connected to a wireless network of and/or associated with the environment. In some embodiments, remote access is via cellular. Providing remote guest access to a subject in an environment via a call user interface corresponding to a connection between different computer systems allows the first computer system to enable remote control for others directly from a call, thereby reducing the number of inputs needed to perform an operation and/or performing an operation when a set of conditions has been met without requiring further user input.

In some embodiments, the first level of guest access (e.g., 432c) is provided via an authentication code (e.g., 404b) (e.g., a password, a PIN, and/or a set of one or more characters) (e.g., as described above with respect to FIGS. 4F-4G). In some embodiments, the authentication code is defined via the second computer system. In some embodiments, the authentication code is defined via the first computer system and sent and/or provided to the second computer system. In some embodiments, the authentication code is defined for the second computer system. In some embodiments, the second level of guest access is provided via another authentication code (e.g., a password, a PIN, and/or a set of one or more characters) different from the authentication code. In some embodiments, the other authentication code is defined for the second computer system. In some embodiments, the second level of guest access is not provided via an authentication code defined for the second computer system. In some embodiments, entering the authentication code enables access to the environment, such as entering the authentication code on the second computer system and/or another computer system separate from the first computer system and the second computer system. Providing guest access via an authentication code to an environment via a call user interface corresponding to a connection between different computer systems allows the first computer system to enable guest access with the authentication code for others directly from a call, thereby reducing the number of inputs needed to perform an operation and/or performing an operation when a set of conditions has been met without requiring further user input.

In some embodiments, in accordance with the determination that the respective level of guest access to the environment is the first level of guest access to the environment, the first input (e.g., 405d2) corresponds to a first user interface element for the first level of guest access (e.g., 432c) to the environment (e.g., when the respective level of guest access to the environment is the first level of guest access to the environment). In some embodiments, in accordance with the determination that the respective level of guest access to the environment is the second level of guest access (e.g., 432a and/or 432b) to the environment, the first input (e.g., 405d1) corresponds to a second user interface element for the second level of guest access (e.g., 432b) to the environment (e.g., when the respective level of guest access to the environment is the second level of guest access to the environment). In some embodiments, the second user interface element is separate from the first user interface element (e.g., as described above with respect to FIG. 4D). In some embodiments, the first user interface element is concurrently displayed with the second user interface element. Providing different levels of guest access to an environment using different user interface elements via a call user interface corresponding to a connection between different computer systems allows the first computer system to configure different levels of guest access to the environment for others directly from a call, thereby reducing the number of inputs needed to perform an operation and/or performing an operation when a set of conditions has been met without requiring further user input.

In some embodiments, the second input is the first input. Providing guest access to an environment using a single input via a call user interface corresponding to a connection between different computer systems allows the first computer system to quickly grant access directly from a call, thereby reducing the number of inputs needed to perform an operation and/or performing an operation when a set of conditions has been met without requiring further user input.

In some embodiments, the second input (e.g., 405d1, 405d2, and/or 405g) is separate (and/or different) from the first input (e.g., 405c) (e.g., as described above with respect to FIGS. 4C-4G). Providing guest access to an environment using at least one input detected via a call user interface corresponding to a connection between different computer systems and another input to define a level of the guest access allows the first computer system to configure different levels of guest access with a starting point from the call user interface, thereby performing an operation when a set of conditions has been met without requiring further user input.

In some embodiments, the second computer system (e.g., 400) is a resident device (e.g., a communication hub, a controller, a home hub, and/or a hub device) that is in communication with (and/or manages communication with) one or more accessories (e.g., a light, a lock, a speaker, a television, a fan, an air conditioner, and/or a heater) within the environment. In some embodiments, the first level of guest access (e.g., 432c) is with respect to the one or more accessories. In some embodiments, the second level of guest access (e.g., 432a and/or 432b) is with respect to the one or more accessories (e.g., as described above with respect to FIGS. 4D-4G). In some embodiments, the resident device and the one or more accessories are on the same wireless network, such as a local area network or a mesh network. Providing different levels of guest access to one or more accessories via a call user interface corresponding to a connection between the first computer system and a resident device associated with the one or more accessories allows the first computer system to communicate with the resident device while providing guest access through the resident device, thereby reducing the number of inputs needed to perform an operation and/or performing an operation when a set of conditions has been met without requiring further user input.

In some embodiments, the one or more accessories include a plurality of accessories (e.g., as described above with respect to FIGS. 4D-4H). In some embodiments, the plurality of accessories includes an accessory of a first type and an accessory of a second type different from the first type. In some embodiments, the accessory of the first type is separate from the accessory of the second type.

In some embodiments, the first computer system (e.g., 424) is a personal device of an administrator (e.g., represented by 420 and/or 472) (e.g., a resident and/or an owner) of the environment (e.g., as described above with respect to FIGS. 4A-4H). Providing different levels of guest access to an environment via a call user interface corresponding to a connection between a personal device of an administrator of the environment and another computer system allows the personal device to control access to the environment, thereby performing an operation when a set of conditions has been met without requiring further user input.

In some embodiments, the first computer system (e.g., 424) is a personal device of an administrator (e.g., represented by 420 and/or 472) (e.g., a resident and/or an owner) of the second computer system (e.g., 400) (e.g., as described above with respect to FIGS. 4A-4H). Providing different levels of guest access to an environment via a call user interface corresponding to a connection between (1) a personal device of an administrator of a second computer system and (2) the second computer system allows the personal device to control access to the environment, thereby performing an operation when a set of conditions has been met without requiring further user input.

In some embodiments, the call user interface (e.g., 436) is displayed while detecting the first input (e.g., 405c, 405d1, 405d2, and/or 405g) and while providing the first level of guest access (e.g., 432c) to the environment (e.g., as described above with respect to FIGS. 4C-4H). In some embodiments, the call user interface is displayed while detecting the second input and/or while providing the second level of guest access to the environment. Maintaining a call user interface through inputs to provide guest access and providing guest access allows a user of the first computer system to continue to communicate with a user of another computer system while providing guest access, thereby performing an operation when a set of conditions has been met without requiring further user input.

In some embodiments, the call user interface (e.g., 436) includes content (e.g., video, audio, and/or an image) (e.g., 460) received from the second computer system (e.g., 400) (e.g., as described above with respect to FIGS. 4B-4H).

In some embodiments, the connection is an audio call (e.g., as described above with respect to FIG. 4B).

In some embodiments, the connection is a video call (e.g., as described above with respect to FIGS. 4B-4H).

In some embodiments, the connection includes the first computer system (e.g., 424) receiving video (e.g., 460) and audio from the second computer system (e.g., 400). In some embodiments, the connection includes, at a first time, the first computer system sending audio without sending video to the second computer system (e.g., as described above with respect to FIG. 4B). Providing different levels of guest access to an environment via a call user interface corresponding to a connection between different computer systems that is receiving audio and video while only sending audio allows the first computer system to enable guest access to the environment for others directly from a call without requiring video to go both ways, thereby performing an operation when a set of conditions has been met without requiring further user input.

In some embodiments, the connection includes, at a second time different from the first time, the first computer system (e.g., 424) sending audio and video (e.g., 408) to the second computer system (e.g., 400) (e.g., as described above with respect to FIG. 4C). In some embodiments, after sending audio without sending video to the second computer system, the first computer system detects, via the one or more input devices, an input (e.g., a tap input and/or a voice request) corresponding to a request to send video to the second computer system. In some embodiments, in response to detecting the input corresponding to the request to send video to the second computer system, the first computer system sends video and audio to the second computer system. Providing different levels of guest access to an environment via a call user interface corresponding to a connection between different computer systems that is switches from only sending audio to sending both audio and video allows the first computer system to enable guest access to the environment while choosing how to communicate with another computer system, thereby performing an operation when a set of conditions has been met without requiring further user input.

In some embodiments, the call user interface (e.g., 436) includes an identification (e.g., 448) of (e.g., a name and/or identifier assigned to) the environment (e.g., as described above with respect to FIGS. 4A-4E). In some embodiments, the identification of the environment corresponds to a location where a guest was detected via the second computer system or a location where the second computer system is located. Providing different levels of guest access to an environment via a call user interface that includes an identification of the environment allows the first computer system to identify where guest access is to be given when providing the guest access, thereby performing an operation when a set of conditions has been met without requiring further user input.

In some embodiments, the call user interface (e.g., 436) includes an identification (e.g., a name, a username, an account, and/or a unique identifier) of a subject (e.g., represented by 460a) in the environment. (e.g., as described above with respect to FIGS. 4A-4B) In some embodiments, the subject is a person within the environment. Providing different levels of guest access to an environment via a call user interface that includes an identification of a person in the environment allows the first computer system to identify who is to be given guest access when providing the guest access, thereby performing an operation when a set of conditions has been met without requiring further user input.

In some embodiments, the call user interface (e.g., 436) includes an indication that an unknown guest (e.g., represented by 460a) is in the environment (e.g., as described above with respect to FIGS. 4A-4B). In some embodiments, the unknown guest is a person within the environment. In some embodiments, the unknown guest is a subject that is not able to be recognized and/or identified by the first computer system, the second computer system, and/or another computer system separate from the first computer system and the second computer system. Providing different levels of guest access to an environment via a call user interface that includes an indication that an unknown guest is in the environment allows the first computer system to identify the presence of an unknown guest when providing guest access, thereby performing an operation when a set of conditions has been met without requiring further user input.

In some embodiments, in response to detecting the set of one or more inputs, in accordance with the determination that the respective level of guest access to the environment is the first level of guest access (e.g., 432c) to the environment, the first computer system outputs (and/or displays), via the one or more output devices, a confirmation (e.g., 478 and/or 464) (e.g., a visual and/or auditory confirmation, such as text that indicates access has been provided) that the first level of guest access has been provided (e.g., as described above with respect to FIG. 4H). In some embodiments, in response to detecting the set of one or more inputs, in accordance with the determination that the respective level of guest access to the environment is the second level of guest access (e.g., 432a and/or 432b) to the environment, the first computer system outputs (and/or displays), via the one or more output devices, a confirmation (e.g., 444 and/or 456) (e.g., a visual and/or auditory confirmation, such as text that indicates access has been provided) that the second level of guest access has been provided (e.g., as describe above with respect to FIG. 4E). Outputting a confirming when guest access is provided via a call user interface allows the first computer system to indicate a status of the guest access, thereby performing an operation when a set of conditions has been met without requiring further user input.

In some embodiments, before displaying the call user interface (e.g., 436), the first computer system receives (e.g., from the second computer system or another computer system separate from the first computer system and the second computer system) a notification that an unrecognized subject (e.g., an unrecognized person and/or an unrecognized guest) is detected in the environment (e.g., as described above with respect to FIG. 4A). In some embodiments, in response to receiving the notification that an unrecognized subject is detected in the environment, the first computer system displays an indication of the notification. Receiving a notification that an unrecognized subject is detected in an environment before providing different levels of guest access to the environment via a call user interface allows the first computer system to first be notified of a situation before connecting to a call via the call user interface, thereby performing an operation when a set of conditions has been met without requiring further user input.

In some embodiments, before displaying the call user interface (e.g., 436 as illustrated in FIGS. 4B-4E and/or 4H), the first computer system receives (e.g., from the second computer system or another computer system separate from the first computer system and the second computer system) a notification (e.g., call user interface 436 as illustrated in FIG. 4A) that the second computer system (e.g., 400) is calling the first computer system (e.g., 424), wherein the call user interface is displayed in response to detecting an input (e.g., 405a2)(e.g., an input corresponding to a acceptance of a call from the second computer system) corresponding to the notification that the second computer system is calling the first computer system (e.g., as described above with respect to FIGS. 4A-4B). In some embodiments, in response to receiving the notification that the second computer system is calling the first computer system, the first computer system displays the notification that the second computer system is calling the first computer system. Receiving a notification that another computer system is calling the first computer system before providing different levels of guest access to the environment via a call user interface allows the first computer system to have a choice for whether to accept a call via the call user interface, thereby performing an operation when a set of conditions has been met without requiring further user input.

In some embodiments, before displaying the call user interface (e.g., 436), the first computer system receives a call from a respective location within the environment, wherein the call user interface includes: in accordance with a determination that the respective location is a first location, an indication (e.g., 448) of the first location (e.g., as describe above with respect to FIG. 4A); and in accordance with a determination that the respective location is a second location, an indication of the second location (e.g., without including the indication of the first location), wherein the second location is different from the first location (e.g., as describe above with respect to FIG. 4A). Including different indication of different locations depending on where a call is received from to provide different levels of guest access allows the first computer system to identify where a person is located before providing guest access to the person, thereby performing an operation when a set of conditions has been met without requiring further user input.

In some embodiments, while displaying the call user interface (e.g., 436) and before providing access to the environment, the first computer system detects, via the one or more input devices, an input (e.g., a tap input and/or a voice request) (e.g., an input at exit control 474) corresponding to a request to end the connection (e.g., as described above with respect to FIG. 4B). In some embodiments, in response to detecting the input corresponding to the request to end the connection, the first computer system ends the connection without providing guest access to the environment (e.g., as described above with respect to FIG. 4B). Enabling the first computer system to end a connection with another computer system without providing guest access to an environment allows the first computer system to choose whether to provide the guest access while on a call with the other computer system, thereby performing an operation when a set of conditions has been met without requiring further user input.

Note that details of the processes described above with respect to process 500 (e.g., FIG. 5) are also applicable in an analogous manner to other processes described herein. For example, process 900 optionally includes one or more of the characteristics of the various processes described above with reference to process 500. For example, the guest access provided in process 500 can include access to the one or more accessory devices in process 900. For brevity, these details are not repeated herein.

FIGS. 6A-6C illustrate exemplary user interfaces for managing notifications of an environment in accordance with some embodiments. The user interfaces in these figures are used to illustrate the processes described below, including the processes in FIG. 7.

In some embodiments, managing notifications of an environment includes multiple computer systems in an ecosystem (e.g., an interconnected system of computer systems and/or accessories that interact with people within the environment) detecting and identifying subjects leaving the environment and/or a state of the environment (e.g., door locked and/or garaged closed). In some embodiments, the environment is a location (e.g., a house, an apartment, a building, a living room and/or a locality configured by a user and/or defined by a computer system) that include multiple accessories (e.g., a camera, a speaker, and/or other type of accessory) in communication with each other and/or a resident device as described above. In some embodiments, an accessory can detect the guest and communicate with the resident device within the environment to determine how to respond to detection of the guest as described further below. For example, in response to receiving a communication that the guest is at the environment, the resident device can communicate with a personal device of an administrator (e.g., personal device 424). In some embodiments, in response to receiving the communication, the administrator is able to review the guest at the environment. In such embodiments, reviewing the guest can include the ability to grant permission to the guest in the environment and/or create a guest profile for the guest.

FIGS. 6A-6C illustrate personal device 424 on the left and schematic 612 on the right. Personal device 424 is illustrated as a smart phone. It should be recognized that personal device 424 can be other types of computer systems such as a tablet, a smart watch, a laptop, a communal device, an accessory, a personal gaming system, a desktop computer, a fitness tracking device, and/or a head-mounted display (HMD) device. In some embodiments, personal device 424 includes and/or is in communication with one or more input devices (e.g., a sensor, a camera, a lidar detector, a motion sensor, an infrared sensor, a touch-sensitive surface, a physical input mechanism, and/or a microphone). In some embodiments, personal device 424 includes and/or is in communication with one or more output devices (e.g., a display screen, a projector, a touch-sensitive display, and/or a speaker). In some embodiments, personal device 424 includes one or more components and/or features described above in relation to computer system 100, resident device 310 and/or computer system 360. As illustrated in FIG. 6A, personal device 424 displays lock screen user interface 600. Lock screen user interface 600 includes an indication of the date and time (e.g., “Friday, October 11” and “9:41”). It should be recognized that personal device 424 is the personal computer system of an administrator of the environment, Alex.

FIGS. 6A-6C illustrate schematic 612 on the right, a representation of the environment of an interior of a home, which includes entryway 624 with front door 684, living room 648 and bedroom 636. In some embodiments, the environment is an apartment, a building, and/or a locality configured by a user (e.g., administrator and/or homeowner) and/or defined by a computer system such as a resident computer system. Schematic 612 also includes resident device representation 604 (e.g., a representation of resident device 400 as described above with respect to FIG. 4A-4H), camera accessory representation 610 (e.g., a representation of the camera accessory within the home), administrator representation 660 (e.g., a representation of the administrator, Alex) near front door 684 and guest representation 672 (e.g., a representation of a guest, Brittany). It should be recognized that resident device representation 604 represents a resident device, such as a central computer system within the environment that connects to and/or communicates with multiple the systems and/or accessories within the environment. In some embodiments, resident device representation 604 represents a communal device and/or a television. In some embodiments, the resident device includes and/or is in communication with one or more sensors (e.g., a camera, a LiDAR detector, a motion sensor, an infrared sensor, ultra-wideband (UWB) and/or a microphone). Such sensors can be used to detect presence, attention, statements, requests, and/or instructions from a subject in an environment. It should also be recognized that a camera accessory (e.g., exemplified by camera accessory representation 610) is in the same environment and in communication with a resident device (e.g., exemplified by resident device representation 604). In some embodiments, the camera accessory is included in (e.g., a part of and/or connected to) the resident device.

FIGS. 6A-6B illustrate a scenario where a subject, identified as the administrator, is detected leaving the environment. As illustrated in FIG. 6A, the administrator (e.g., represented by administrator representation 660) is leaving the environment through front door 684 as illustrated by the arrow originating from administrator representation 660. At FIG. 6A, the administrator, Alex, is detected leaving the environment. In some embodiments, the resident device detects and identifies that the administrator is leaving the environment. For example, the resident device can detect the movement of personal device 424 in the environment through UWB sensors. In some embodiments, the resident device uses one or more sensors to detect motion in the environment and determine that the administrator is leaving the environment using the one or more sensors. For example, the camera accessory can detect motion of a subject and transmit such information to the resident device that then identifies the subject as the administrator. In such an example, the camera accessory (e.g., exemplified by camera accessory representation 610) can detect a subject near the front door and send data to the resident device to determine that the administrator is the subject leaving the environment. In some embodiments, an accessory device such as a smart lock and/or garage security system is in communication with the resident device and detecting a subject has left the environment includes the resident device receiving an indication that the accessory device has changed status. For example, the resident device can detect that a smart lock at the front door is being opened and/or locked to determine someone has left through the front door. In some embodiments, the resident device and/or one or more accessory can detect an input that that a subject has left, such as a verbal statement (e.g., “I am leaving the house now!”) and determine that voice input of the subject matches a voice profile corresponding to the administrator.

As illustrated in FIG. 6B, the administrator is out the environment as illustrated by administrator representation 660 being on the other side of front door 684. At FIG. 6B, the administrator is determined to have left the environment. In some embodiments, the determination that the administrator has left the environment is determined by detecting that a personal device of the administrator is no longer in the environment. In some embodiments, the determination that the administrator has left the environment is determined by receiving (e.g., from a server, a personal device of the administrator, and/or an accessory device) one or more indications that the administrator has left the environment.

At FIG. 6B, in response to detecting the administrator has left, the resident device determines if there is anyone else left in the environment. At FIG. 6B, the guest is determined to still be in the environment. In some embodiments, the resident device detects and identifies that the guest is still in the environment. For example, the resident device can detect the movement of, such as through UWB sensors, a personal device of the guest in the environment. In some embodiments, the resident device uses one or more sensors to determine if there is motion in the environment and detects motion of the guest using the one or more sensors. For example, the camera accessory can detect motion of a subject and transmit such information to the resident device that then identifies the subject as a guest. For another example, one or more accessories can detect a subject in the living room and send data of motion of the subject to the resident device to identify the guest. In some embodiments, the resident device and/or one or more accessories can detect an input that that a subject has left, such as a verbal statement (e.g., “I am still home!”) and determine that the verbal statement corresponds to a guest.

At FIG. 6B, the resident device determines that a guest is still in the environment. As illustrated in FIG. 6B, in response to detecting the administrator has left and a determination that the guest is still in the environment, personal device 424 does not display a notification of a status of the environment. In some embodiments, personal device 424 displays a notification after the determination the guest is still in the environment. In some embodiments, personal device 424 displays a notification for security purposes. For example, in a scenario where the guest is an unknown subject, the resident device can send an indication that someone the administrator does not know is still in the environment. For another example, in a scenario where the guest is a subject who is unable to leave (e.g., a bedridden grandmother) the environment, the resident device can ignore the guest and communicate with personal device 424 to display a notification (e.g., Everyone but Grandma has left the home). As illustrated in FIG. 6B, the guest, represented by guest representation 672, is heading to front door 684 as illustrated by the arrow originating from guest representation 672.

As illustrated in FIG. 6C, the guest is out of the environment as illustrated by guest representation 672 being on the other side of front door 684. At FIG. 6C, the guest is determined to have left the environment. In some embodiments, the determination that the guest has left the environment is determined by detecting that a personal device of the guest is no longer in the environment. In some embodiments, the determination that the guest has left the environment is determined by receiving (e.g., from a server, a personal device of the guest, and/or an accessory device) one or more indications that the guest has left the environment.

At FIG. 6C, the resident device determines that no subject is the environment. At FIG. 6C, in response to detecting the guest has left and a determination that no one is in the environment, the resident device determines a status of the environment. In some embodiments, in response to detecting the guest has left, the resident device communicates with multiple accessories in the environment and/or ecosystem to send live (e.g., current and/or present) data of each accessory. In some embodiments, communicating to send the live data includes commanding one or more accessories devices to capture media content, such as an image and/or a video. In some embodiments, communicating to send the live data includes commanding one or more accessories devices to provide status (e.g., device is locked, device is unlocked, a computer system is still in the environment and/or a malfunction of the device) of the accessories. In some embodiments, after determining that the guest has left and in response to receiving and analyzing the live data of the accessories, the resident device communicates with personal device 424 to display a notification. As illustrated in FIG. 6C, in response to detecting the guest has left and a determination that no one is in the environment, resident device sends an indication of the status of the environment to personal device 424 and personal device 424 displays the status of the environment as notification 696. In some embodiments, while displaying the status of the environment as notification 696, personal device 424 outputs audio corresponding to notification 696, such as an alert sound or a dictation of content included in notification 696.

As illustrated in FIG. 6C, notification 696 includes content about a state and/or a summary of the environment (e.g., Everyone is away and front door is locked”). In some embodiments, notification 696 includes states of multiple accessories in the environment. In some embodiments, content included in notification 696 is based on a setting of personal device 424, such as which accessories (e.g., front lock, back door, and or garage) to include in notifications. In some embodiments, notification 696 includes an indication of time (e.g., today at 9:43). In some embodiments, notification 696 includes an identification of the environment (e.g., “Miller home”). In some embodiments, notification 696 includes an indication of a location within the environment where a subject is detected to have left the environment (e.g., “front door” or “back door”). In some embodiments, notification 696 includes a representation of the set of one or more subjects (e.g., profile image from contacts and/or photo from external device when the respective subject was detected in the environment). In some embodiments, personal device 424 displays notification 696 after a predefined amount of time has passed since receiving the indication from the resident device.

FIG. 7 is a flow diagram illustrating a process (e.g., process 700) for displaying status of an environment in accordance with some embodiments. Some operations in process 700 are, optionally, combined, the orders of some operations are, optionally, changed, and some operations are, optionally, omitted.

As described below, process 700 provides an intuitive way for displaying status of an environment. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 424). In some embodiments, the computer system is a resident device, a phone, a watch, a tablet, a fitness tracking device, a processor, a head-mounted display (HMD) device, and/or a personal computing device. In some embodiments, the display component includes a display screen, a projector, and/or a touch-sensitive display. In some embodiments, the audio generation component includes a speaker, a smart speaker, a soundbar, an audio jack, an optical audio output, and/or Bluetooth audio output.

The computer system detects (702) that a set of one or more subjects (e.g., a user, a person, a guest, a resident, an individual, and/or a primary and/or nearest user, person, and/or individual) (e.g., represented by 660 and/or 627) has left (e.g., exited and/or no longer detected) an environment (e.g., a location, a home, a room, a yard, a business, an area, a predefined area, a defined area, and/or a building) (e.g., 612) (e.g., as described above with respect to FIGS. 6A-6C). In some embodiments, detecting that the set of one or more subjects has left the environment includes detecting, via one or more input devices (e.g., a camera, a depth sensor, a microphone, a hardware input mechanism, a rotatable input mechanism, a physical input mechanism, and/or a touch-sensitive surface) that are in communication with and/or included with the computer system, that the set of one or more subjects has left the environment. In some embodiments, detecting that the set of one or more subjects has left the environment includes detecting that a personal device of a subject of the set of one or more subjects is no longer in the environment. In some embodiments, detecting that the set of one or more subjects has left the environment includes receiving (e.g., from a server, a personal device of a subject of the set of one or more subjects, and/or another computer system separate from the computer system) an indication that the one or more subjects has left the environment.

In response to (704) detecting that the set of one or more subjects has left the environment, in accordance with a determination that a subject (e.g., any subject or a particular subject such as a resident of the environment) is not detected in (and/or does not remain within) the environment, the computer system outputs (706) a notification (e.g., 696) (e.g., a summary of a state of the first computer and/or one or more external devices, such as an accessory device, a communal device, and/or a personal device, in communication with and separate from the computer system) corresponding to the environment (e.g., as described above with respect to FIG. 6C). In some embodiments, outputting the notification includes outputting, via one or more output devices (e.g., a display component, an audio generation component, and/or a haptic generation component) that are in communication with and/or included with the computer system, the notification. In some embodiments, outputting the notification includes sending, to another computer system (e.g., a phone, a tablet, a fitness tracking device, a processor, and/or a personal computing device) external to the first computer system, the notification.

In response to (704) detecting that the set of one or more subjects has left the environment, in accordance with a determination that a subject (e.g., any subject or a particular subject such as a resident of the environment) is detected in (and/or remains within) the environment, the computer system forgoes (708) output of the notification corresponding to the environment (e.g., as described above with respect to FIG. 6B). Selectively outputting a notification depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, the notification (e.g., 696) corresponding to the environment (e.g., 612) includes: in accordance with a determination that an administrator (e.g., an owner and/or a logged-in user) of the computer system customized notifications corresponding to the environment in a first manner (e.g., established that such notification would include a status of certain accessories and/or include certain information corresponding to the environment), first content (e.g., a state and/or status of an accessory, an indication of a state and/or context corresponding to the environment, and/or an identification of presence of a person in the environment) (e.g., as describe above with respect to FIG. 6C); and in accordance with a determination that the administrator of the computer system customized notifications corresponding to the environment in a second manner (e.g., established that such notification would include a status of certain accessories and/or include certain information corresponding to the environment), second content (e.g., a state and/or status of an accessory, an indication of a state and/or context corresponding to the environment, and/or an identification of presence of a person in the environment) (e.g., without including the first content) different from the first content. In some embodiments, the second manner is different from the first manner (e.g., as describe above with respect to FIG. 6C). Customizing a notification that is output depending on whether a subject is detected in an environment in response to detecting that a set of one or more subjects has left the environment allows the computer system to provide particular information about the environment when no one remains in the environment, thereby performing an operation when a set of conditions has been met without requiring further user input.

In some embodiments, the notification (e.g., 696) includes an indication of time (e.g., when the set of one or more subjects left the environment and/or when the notification was output) (e.g., as described above with respect to FIG. 6C). Selectively outputting a notification with an indication of time depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, the notification (e.g., 696) includes a summary (e.g., no one is home, all of the doors are locked, one door is unlocked, all of the windows are closed, the garage door is open, the garage door is closed, all of the lights are off, lights remain on in one room, and/or the like) of a current state of the environment (e.g., as described above with respect to FIG. 6C). Selectively outputting a notification with a summary of an environment depending on whether a subject is detected in the environment in response to detecting that a set of one or more subjects has left the environment allows the computer system to provide information about the environment when no one remains in the environment, thereby performing an operation when a set of conditions has been met without requiring further user input.

In some embodiments, the notification (e.g., 696) includes an indication of a current state (e.g., on, off, active, power-saving mode, turned up to high, and/or the like) of an accessory device (e.g., a communal device, a lock, a light, a television, a speaker, a fan, an air conditioner, and/or a heater) within the environment (e.g., 612) (e.g., as described above with respect to FIG. 6C). Selectively outputting a notification with indication of a current state of an accessory device depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, the computer system (e.g., 424) is a resident device (e.g., a communication hub, a controller, a home hub, and/or a hub device) that is in communication with (and/or manages communication with) one or more accessories (e.g., a light, a lock, a speaker, a television, a fan, an air conditioner, and/or a heater) within the environment (e.g., 612). In some embodiments, the one or more accessories includes the accessory device (e.g., represented by 610) (e.g., as described above with respect to FIG. 6C). In some embodiments, the resident device and the one or more accessories are on the same wireless network, such as a local area network or a mesh network.

In some embodiments, in response to detecting that the set of one or more subjects (e.g., represented by 660 and/or 627) has left the environment (e.g., 612), the computer system obtains, via the accessory device, the current state of the accessory device (e.g., represented by 610) (e.g., as described above with respect to FIG. 6C). In some embodiments, obtaining, via the accessory device, the current state of the accessory device includes sending, to the accessory device, a request for the current state of the accessory device.

In some embodiments, the notification (e.g., 696) includes: an indication of a current state (e.g., on, off, active, power-saving mode, turned up to high, and/or the like) of a first accessory device (e.g., represented by 610) (e.g., a communal device, a lock, a light, a television, a speaker, a fan, an air conditioner, and/or a heater) within the environment (e.g., 612) (e.g., as described above with respect to FIG. 6C); and an indication of a current state (e.g., on, off, active, power-saving mode, turned up to high, and/or the like) of a second accessory device (e.g., a communal device, a lock, a light, a television, a speaker, a fan, an air conditioner, and/or a heater) within the environment. In some embodiments, the second accessory device is different from the first accessory device (e.g., as described above with respect to FIG. 6C). In some embodiments, the indication of the current state of the second accessory device is separate from the indication of the current state of the first accessory device. Selectively outputting a notification with indications of a current state of different accessory devices depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, the notification (e.g., 696) includes an identification (e.g., “your home” and/or “New York home”) of the environment (e.g., 612) (e.g., as described above with respect to FIG. 6C). In some embodiments, the identification of the environment is defined by a user of the computer system. In some embodiments, the identification of the environment is automatically assigned by the computer system, such as being an address of the environment or a default name. Selectively outputting a notification with an identification of an environment depending on whether a subject is detected in the environment in response to detecting that a set of one or more subjects has left the environment allows the computer system to provide information about the environment when no one remains in the environment, thereby performing an operation when a set of conditions has been met without requiring further user input.

In some embodiments, the notification (e.g., 696) includes: in accordance with a determination that the set of one or more subjects left the environment via a first portion (e.g., a front door, a back door, or a garage) of the environment, an identification of the first portion of the environment (e.g., as described above with respect to FIG. 6C); and in accordance with a determination that the set of one or more subjects left the environment via a second portion (e.g., a front door, a back door, or a garage) of the environment, an identification of the second portion of the environment. In some embodiments, the second portion is different from the first portion (e.g., as described above with respect to FIG. 6C). In some embodiments, the identification of the second portion of the environment is different from the identification of the first portion of the environment. Selectively outputting a notification with an identification of a portion of an environment when a set of one or more subjects left the environment depending on whether a subject is detected in the environment in response to detecting that the set of one or more subjects has left the environment allows the computer system to provide information about the environment when no one remains in the environment, thereby performing an operation when a set of conditions has been met without requiring further user input.

In some embodiments, the notification (e.g., 696) includes a representation (e.g., a profile image from contacts, an image from another computer system external to the computer system, and/or a video) of the set of one or more subjects (e.g., represented by 660 and/or 627) (e.g., as described above with respect to FIG. 6C). Selectively outputting a notification with a representation of a set of one or more subjects depending on whether a subject is detected in an environment in response to detecting that the set of one or more subjects has left the environment allows the computer system to provide information about who recently left the environment when no one remains in the environment, thereby performing an operation when a set of conditions has been met without requiring further user input.

In some embodiments, the notification (e.g., 696) includes an identification (and/or an indication) of when the set of one or more subjects (e.g., represented by 660 and/or 627) left the environment (e.g., as described above with respect to FIG. 6C). Selectively outputting a notification with an identification of when a set of one or more subjects left an environment depending on whether a subject is detected in an environment in response to detecting that the set of one or more subjects has left the environment allows the computer system to provide information about when the set of one or more subjects left the environment when no one remains in the environment, thereby performing an operation when a set of conditions has been met without requiring further user input.

In some embodiments, the notification (e.g., 696) corresponding to the environment is a first notification corresponding to the environment. In some embodiments, in response to detecting that the set of one or more subjects (e.g., represented by 660 and/or 627) has left the environment, in accordance with a determination that a first subject (e.g., a particular subject such as a guest of the environment, and/or a particular type of subject) is detected in (and/or remains within) the environment, the computer system outputs a second notification (e.g., a summary of a state of the first computer and/or one or more external devices, such as an accessory device, a communal device, and/or a personal device, in communication with and separate from the computer system) corresponding to the environment; wherein the second notification is different from the first notification (e.g., as described above with respect to FIG. 6B). In some embodiments, outputting the notification includes outputting, via one or more output devices (e.g., a display component, an audio generation component, and/or a haptic generation component) that are in communication with and/or included with the computer system, the notification. In some embodiments, outputting the notification includes sending, to another computer system (e.g., a phone, a tablet, a fitness tracking device, a processor, and/or a personal computing device) external to the first computer system, the notification. In some embodiments, in response to detecting that the set of one or more subjects has left the environment, in accordance with a determination that a second subject (e.g., a particular subject such as a resident of the environment, and/or a particular type of subject) is detected in (and/or remains within) the environment, the computer system forgoes output of a notification (e.g., 696) corresponding to the environment, wherein the second subject is different from the first subject (e.g., as described above with respect to FIG. 6B). Selectively outputting a notification depending on who is detected as remaining in an environment allows the computer system to provide information about the environment when only particular subjects remain in the environment, thereby performing an operation when a set of conditions has been met without requiring further user input.

In some embodiments, in response to detecting that the set of one or more subjects has left the environment and in accordance with a determination that a subject (e.g., 672) is detected in (and/or remains within) the environment, the computer system forgoes output of a notification corresponding to the environment (e.g., as described above with respect to FIG. 6B). Selectively outputting a notification depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, the notification (e.g., 696) corresponding to the environment (e.g., 612) is a first notification corresponding to the environment. In some embodiments, in response to detecting that the set of one or more subjects has left the environment and in accordance with a determination that a subject (e.g., 612) is detected in (and/or remains within) the environment, the computer system outputs a second notification corresponding to the environment, wherein the second notification is different from (e.g., includes different content than and/or has a different appearance from) the first notification (e.g., as described above with respect to FIG. 6B). Outputting a different notification depending on whether a subject remains in an environment in response to detecting that a set of one or more subjects has left the environment allows the computer system to provide information about the environment when people leave the environment, thereby performing an operation when a set of conditions has been met without requiring further user input.

In some embodiments, detecting that the set of one or more subjects (e.g., represented by 660 and/or 627) has left the environment includes detecting that a personal device (e.g., 424) of the set of one or more subjects is no longer in the environment (e.g., 612) (e.g., as described above with respect to FIGS. 6A-6C).

In some embodiments, the notification (e.g., 696) corresponding to the environment is output after a predetermined amount of time (e.g., 30 seconds to 10 minutes) has passed since detecting that the set of one or more subjects (e.g., represented by 660 and/or 627) has left the environment (e.g., 612) (e.g., as described above with respect to FIG. 6C). In some embodiments, the predetermined amount of time is a non-zero amount of time. Outputting a notification after a predetermined amount of time has passed since detecting that a set of one or more subjects has left an environment depending on whether a subject is detected in the environment in response to detecting that the set of one or more subjects has left the environment allows the computer system to wait to confirm that the set of one or more subjects have actually left before providing information about the environment when no one remains in the environment, thereby performing an operation when a set of conditions has been met without requiring further user input.

In some embodiments, outputting the notification (e.g., 696) corresponding to the environment includes outputting, via one or more speakers that are in communication with the computer system, audio (e.g., as described above with respect to FIG. 6C). Selectively outputting audio depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, outputting the notification (e.g., 696) corresponding to the environment includes displaying, via one or more display components that are in communication with the computer system, content (e.g., as described above with respect to FIG. 6C). Selectively displaying content depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, outputting the notification (e.g., 696) includes sending, to another computer system (e.g., a personal device of an administrator of the environment and/or the computer system) separate from the computer system, the notification (e.g., as described above with respect to FIG. 6C). Selectively sending a notification to another computer system depending on whether a subject is detected in an environment in response to detecting that a set of one or more subjects has left the environment allows the computer system to provide information about the environment when no one remains in the environment, thereby performing an operation when a set of conditions has been met without requiring further user input.

In some embodiments, outputting the notification (e.g., 696) includes sending, to a plurality of different computer systems (e.g., personal device of different administrators of the environment and/or the computer system) separate from the computer system, the notification (e.g., as described above with respect to FIG. 6C). Selectively sending notifications to other computer systems depending on whether a subject is detected in an environment in response to detecting that a set of one or more subjects has left the environment allows the computer system to provide information about the environment when no one remains in the environment, thereby performing an operation when a set of conditions has been met without requiring further user input.

Note that details of the processes described above with respect to process 700 (e.g., FIG. 7) are also applicable in an analogous manner to other processes described herein. For example, process 700 optionally includes one or more of the characteristics of the various processes described above with reference to process 700. For example, the status of the environment in process 700 can include a status of the one or more accessory devices in process 900. For brevity, these details are not repeated herein.

FIGS. 8A-8G illustrate exemplary user interfaces for managing access during an emergency in accordance with some embodiments. The user interfaces in these figures are used to illustrate the processes described below, including the processes in FIG. 9.

In some embodiments, managing access during an emergency includes an administrator receiving a notification of an activity in an environment. In some embodiments, the environment is a location (e.g., a house, an apartment, and/or a location) that includes multiple accessories e.g., a camera, a speaker, and/or other type of accessory) and/or sensors (e.g., a camera, a LiDAR detector, a motion sensor, an infrared sensor, ultra-wideband (UWB) and/or a microphone) in communication with each other and/or a resident device. In such embodiments, a camera accessory can detect the activity (e.g., a guest, a noise, and/or a sensor has been activated) and communicate with the resident device within the environment. In some embodiments, the resident device is a computer system that corresponds to and/or is in communication with accessories within the environment.

In some embodiments, the resident device includes a camera. In some embodiments, in response to receiving a communication that an activity is detected in the environment, the resident device communicates with a personal device of an administrator (e.g., personal device 424). In some embodiments, an administer is a resident of the environment with control of access to the environment and/or to the one or more accessories in the environment for others. In some embodiments, a resident is a person and/or a device with access to the environment and/or to the one or more accessories in the environment but does not have control of access for others.

FIGS. 8A-8G illustrate personal device 424 as a smart phone. It should be recognized that personal device 424 can be other types of computer systems such as a tablet, a smart watch, a laptop, a communal device, an accessory, a personal gaming system, a desktop computer, a fitness tracking device, and/or a head-mounted display (HMD) device. In some embodiments, personal device 424 includes and/or is in communication with one or more input devices (e.g., a sensor, a camera, a lidar detector, a motion sensor, an infrared sensor, a touch-sensitive surface, a physical input mechanism, and/or a microphone). In some embodiments, personal device 424 includes and/or is in communication with one or more output devices (e.g., a display screen, a projector, a touch-sensitive display, and/or a speaker).

While the examples in FIGS. 8A-8G include personal device 424 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, another computer system within the environment detects one or more inputs.

It should be recognized that, before FIG. 8A, the resident device detected an activity (e.g., smoke within the environment in the environment. In response to detecting the activity in the environment, the resident device attempted to identify the activity. In some embodiments, identification is defined as the resident device detecting motion in the environment and, in response to detecting the activity, attempting to identify any issues in the environment. In some embodiments, attempting to identity any issues in the environment includes analyzing one or more images, including a video feed, through media captured by a camera included in the resident device or in communication with the resident device. It should be recognized that the resident device was able to identify smoke and then, in response, communicate information of the smoke to personal device 424.

As illustrated in FIG. 8A, personal device 424 displays lock screen user interface 600. Lock screen user interface 600 includes an indication of the date and time “Friday, October 11” and “9:55” as well as, in response to receiving communication from the resident device, notification 800. It should be recognized that more, fewer, and/or different elements can be included in lock screen user interface 600.

As illustrated in FIG. 8A, notification 800 includes activity indication 812 (e.g., “Smoke detected.”) that includes information about the type of activity that was detected and identified in the environment by the resident device. Additionally, as illustrated in FIG. 8A, notification 800 includes view activity control 824 and get help control 836. In some embodiments, notification 800 includes other indications of the activity such as a location that the activity was detected in (e.g., kitchen and/or front door) and/or a time the activity was first detected. In some embodiments, personal device 424 does not display notification 800 if it is determined that the administrator or a resident is in the environment and/or that the activity can be ignored. In some embodiments, personal device 424 displays notification 800 on another user interface, such as a home user interface, an internet user interface, and/or a landing page user interface.

In some embodiments, in response to detecting an input directed to get help control 836, personal device 424 initiates a communication with emergency service (e.g., 911 and/or a security company) and/or an emergency contact. At FIG. 8A, personal device 424 detects input 805a directed to view activity control 824. It should be recognized that input 805a is an example of a selection input as tap inputs but can be other inputs, such as a mouse click, a verbal input (e.g., “Show me the activity.”), and/or a button press.

As illustrated in FIG. 8B, in response to detecting input 805a, personal device 424 ceases display of lock screen user interface 600 and displays activity user interface 848 that includes live feed 860. Live feed 860 is captured by a camera connected to and/or in communication with the resident device within the environment and is transmitted to personal device 424. Additionally, personal device 424 displays get help control 836 overlaid on of live feed 860.

At FIG. 8B, personal device 424 detects input 805b directed to get help control 448c. It should be recognized that input 805b is an example of a selection input as a tap input but can be other inputs, such as a mouse click, a verbal input (e.g., “I don't know who that is.”, “Call my emergency contact.”, and/or “Call 911”), and/or a button press.

As illustrated in FIG. 8C, in response to detecting input 805b, personal device 424 displays menu 822 while maintaining display of live feed 860. Menu 822 includes emergency contact control 822a and contact emergency services control 822b. In some embodiments, in response to detecting an input directed to emergency contact control 822a, personal device 424 ceases display of activity user interface 848 and displays a call user interface with the administrator's emergency contact. In some embodiments, the administrator's emergency contact is a contact that that the administrator preselected for emergency conditions and/or is automatically set based on frequency of contact (e.g., calls and/or texts). In some embodiments, in a scenario where the administrator has multiple emergency contacts, personal device 424 displays a menu with a list of each emergency contact to allow the administrator to choose which emergency contact to call.

At FIG. 8C, personal device 424 detects input 805c directed to contact emergency services control 822b. It should be recognized that input 805c is an example of a selection input as tap inputs but can be other inputs, such as a mouse click, a verbal input (e.g., “Call 911.”), and/or a button press.

As illustrated in FIG. 8D, in response to detecting an input directed to contact emergency services control 822b, personal device 424 initiates an emergency call, ceases display of activity user interface 848, and displays call user interface 884. As illustrated in FIG. 8D, call user interface 884 includes a number of controls (e.g., control 896) that correspond to various functionalities that personal device 424 can perform while personal device 424 is a participant in the emergency call. During the emergency call, personal device 424 and the other computer system (e.g., computer system of 911) exchange audio data without exchanging video data. In some embodiments, video data from personal device 424 is able to be sent to the other computer system.

Between FIGS. 8D-8E , time has passed (e.g., thirty-seven seconds). After the time has passed and in response to a determination that the administrator is on the emergency call with emergency services, personal device 424 outputs a request to share home access with emergency services. In some embodiments, personal device 424 outputs the request after a predefined amount of time has passed since the emergency call began. In some embodiments, personal device 424 outputs the request after a determination that nobody is in the environment at the time of the activity. In some embodiments, personal device 424 outputs the request as an audio output from a speaker of personal device 424. As illustrated in FIG. 8E, personal device 424 outputs the request by displaying prompt 808 within call user interface 884. Prompt 808 is a control that, when tapped on, allows the homeowner to share home access with emergency services.

At FIG. 8E, personal device 424 detects input 805e directed to prompt 808. It should be recognized that input 805e is an example of a selection input as tap inputs but can be other inputs, such as a mouse click, a verbal input (e.g., “Yes, I want to share access.”), and/or a button press.

It should also be recognized that FIG. 8F is an example of personal device 424 outputting a request to share home access with emergency services. In some embodiments, personal device 424 does not display FIG. 8E and moves directly to displaying user interface elements as illustrated in FIG. 8F.

As illustrated in FIG. 8F, in response to detecting an input 805e, personal device 424 displays accessory device menu 820 while maintaining the emergency call with emergency services. Accessory device menu 820 includes identification of multiple home accessory devices within the environment. As illustrated in FIG. 8F, personal device 424 includes light control 832, camera 1 control 844, lock control 856, and camera 2 control 868. At FIG. 8F, all the home accessory devices displayed are shaded to indicate that they are selected to share. In some embodiments, the administrator selects each accessory device control. In some embodiments, personal device 424 detects an input (e.g., a tap input or a voice request to deselect light control 832) corresponding to light control 832 and, in response to the input corresponding to light control 832, deselects light control 865. In such embodiments, personal device 424 removes the shading inside light control 865 to indicate that the light corresponding to light control 832 will not be shared with emergency services. In some embodiments, a live feed preview of an accessory device is displayed within accessory device menu 820 for accessory device controls that include cameras. For example, camera 1 control 844 can includes live feed 860 as described above with respect to FIGS. 8B and 8C.

It should be recognized that more, less and/or of different accessory device controls can be included within accessory device menu 820. In some embodiments, accessory device menu 820 includes other accessory devices above and/or below options illustrated in FIG. 8F. For example, in response to detecting an upward swipe input, personal device 424 scrolls down to show other possible accessories devices available. In some embodiments, accessory device menu 820 includes all accessories within an ecosystem of the environment. In some embodiments, accessory device menu 82 only includes accessory devices that are relevant to the activity. For example, in a scenario where the activity is located in a kitchen of a two story home, personal device 424 provides options that are relevant to accessing the kitchen and not the entire home (e.g., personal device 424 does not display accessory devices on the second floor and/or the bedrooms). In some embodiments, different sets of accessories are displayed in accessory device menu 820. For example, in a scenario where multiple accessories are part of a of a defined location (e.g., living room, bedroom, and/or kitchen), the administrator can pick to share access to the kitchen but not the bedroom and/or living room. In response to the administrator choosing to share access to the kitchen, personal device 424 provides access a set of accessory devices corresponding to the kitchen with emergency services.

As illustrated in FIG. 8F, in response to detecting input 805e, personal device 424 displays not now control 880 and share control 892. In some embodiments, in response to detecting an input directed to not now control 880, computer system ceases display of accessory device menu 820 and displays call user interface 884 in a similar manner as illustrated in FIG. 8E that includes a control to share home access later in the call.

At FIG. 8F, personal device 424 detects input 805f directed to share control 892. It should be recognized that input 805f is an example of a selection input as tap inputs but can be other inputs, such as a mouse click, a verbal input (e.g., “Share these accessories.”), and/or a button press.

As illustrated in FIG. 8G, in response to detecting input 805f, personal device 424 provides access of the accessories chosen from accessory device menu 820 to emergency services while on the emergency call. Providing access of the accessories allows emergency services to monitor and/or access the environment while the administrator is on the emergency call. In some embodiments, providing access includes sending data (e.g., live feeds, access keys, and/or PIN codes) to a computer system corresponding to emergency services. In some embodiments, providing access includes disarming one or more accessories devices for a predefined amount of time. In some embodiments, personal device 424 revokes access of the accessories chosen from accessory device menu 820 to emergency services after the call is over. In some embodiments, personal device 424 revokes access of the accessories chosen from accessory device menu 820 to emergency services after a predefined amount of time (e.g., one hour to one day) has passed after the call is over.

Also illustrated in FIG. 8G, in response to detecting input 805f, personal device 424 ceases display of accessory device menu 820 and displays indication 804 (e.g., “4 accessories devices shared”). In some embodiments, indication 804 is displayed for a predefined amount of time. In some embodiments, indication 804 is always displayed while the administrator is on the call with emergency services. In some embodiments, indication 804 includes a control to stop providing access. In some embodiments, in response to an input directed to indication 804, personal device 424 displays accessory device menu 820, as described with respect to FIG. 8F.

FIG. 9 is a flow diagram illustrating a process (e.g., process 900) for providing access to accessories in an environment in accordance with some embodiments. Some operations in process 900 are, optionally, combined, the orders of some operations are, optionally, changed, and some operations are, optionally, omitted.

As described below, process 900 provides an intuitive way for providing access to accessories in an environment. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., 424) that is in communication (e.g., wired communication and/or wireless communication) with (and/or includes) one or more input devices (e.g., a camera, a depth sensor, a microphone, a hardware input mechanism, a rotatable input mechanism, a physical input mechanism, and/or a touch-sensitive surface) and one or more output devices (e.g., a display component, an audio generation component, and/or a haptic generation component) including one or more display components (e.g., display screen, a projector, and/or a touch-sensitive display). In some embodiments, the first computer system is a watch, a phone, a tablet, a fitness tracking device, a processor, a head-mounted display (HMD) device, and/or a personal computing device. In some embodiments, the display component includes a display screen, a projector, and/or a touch-sensitive display. In some embodiments, the audio generation component includes a speaker, a smart speaker, a soundbar, a headphone, an earphone, an earbud, an audio jack, an optical audio output, and/or Bluetooth audio output.

The computer system displays (902), via the one or more display components, a call user interface (e.g., 884) corresponding to a connection (e.g., a call, a wired and/or wireless connection, an audio call, and/or a video call) with a resource (e.g., emergency contact, an Emergency Call Center (ECC), and/or 911) for emergency assistance. In some embodiments, the connection is established in response to detecting, via the one or more input devices, a set of one or more inputs that corresponds to a request to contact the resource for emergency assistance. In some embodiments, the connection is established in response to detecting, via the one or more input devices, an input corresponding to a user interface element displayed in response to receiving an indication (e.g., an alert and/or notification) of an activity (e.g., video, image, motion sense, loud noise, fire, glass break and/or door opening/closing) in an environment (e.g., a home, a room, a yard, and/or a building). In some embodiments, the indication of the activity is received from an external computer system (e.g., an external computer system that detected the activity and/or another external computer system different from the external computer system that detected the activity).

While displaying the call user interface corresponding to the connection with the resource for emergency assistance (and/or while maintaining the connection with the resource for emergency assistance), the computer system outputs (904), via the one or more output devices, a prompt (e.g., 808 and/or 820) to share access to one or more other computer systems (e.g., represented by 832, 844, 856, and/or 868) (e.g., one or more accessory devices) with the resource for emergency assistance (e.g., a personal device and/or computer system of the resource for emergency assistance) (e.g., as described above with respect to FIGS. 8D-8F). In some embodiments, outputting the prompt includes displaying, via the one or more display components, the prompt. In some embodiments, outputting the prompt includes auditorily outputting, via one or more speakers of the one or more output devices, the prompt.

In conjunction with (e.g., after or while) outputting the prompt (and/or while maintaining the connection with the resource for emergency assistance), the computer system detects (906), via the one or more input devices, an input (e.g., 805e and/or 805f) (e.g., a tap input and/or a voice input) corresponding to a request to share access to one or more other computer systems (e.g., one or more accessory devices) with the resource for emergency assistance (e.g., as described above with respect to FIGS. 8E-8F).

In response to detecting the input corresponding to the request to share access to one or more other computer systems with the resource for emergency assistance (and/or while maintaining the connection with the resource for emergency assistance), the computer system shares (908), to the resource for emergency assistance, access to a respective set of one or more other computer systems, wherein the respective set of one or more other computer systems do not include the computer system (e.g., as described above with respect to FIGS. 8E-8G). In some embodiments, sharing access includes sending data (e.g., video and/or audio) to the resource for emergency assistance. In some embodiments, sharing access includes providing a pin code to allow entry to the environment. In some embodiments, after outputting the prompt without detecting, via the one or more input devices, an input corresponding to a request to share access to one or more other computer systems with the resource for emergency assistance, the computer system forgoes share of access of one or more other computer systems to the resource for emergency assistance. In some embodiments, while forgoing share of access of one or more other computer systems devices to the resource for emergency assistance, the computer system maintains the connection with the resource for emergency assistance. Sharing, to a resource for emergency assistance, access to a set of computer systems while displaying a call user interface corresponding to a connection with the resource for emergency assistance allows the computer system to facilitate help from the resource while on a call with the resource, thereby reducing the number of inputs needed to perform an operation and/or performing an operation when a set of conditions has been met without requiring further user input.

In some embodiments, after sharing, to the resource for emergency assistance, access to the respective set of one or more other computer systems (e.g., represented by 832, 844, 856, and/or 868), the computer system maintains the connection with the resource for emergency assistance (e.g., as described above with respect to FIGS. 8F-8G). After sharing, to a resource for emergency assistance, access to a set of one or more computer systems, maintaining a connection with the resource for emergency assistance allows a user of the computer system to continue obtaining help from the resource even after the access is shared, thereby performing an operation when a set of conditions has been met without requiring further user input.

In some embodiments, in response to detecting that the connection with the resource for emergency assistance has ceased, the computer system ceases share of, to the resource for emergency assistance, access to the respective set of one or more other computer systems (e.g., represented by 832, 844, 856, and/or 868) (e.g., as described above with respect to FIG. 8G). No longer sharing, to a resource for emergency assistance, access to a set of one or more computer system to response to detecting that a connection with the resource for emergency assistance has ceased allows the computer system to share while the connection is maintained but maintain privacy and security after the connection is over without requiring an explicit input to revoke the access, thereby reducing the number of inputs needed to perform an operation and/or performing an operation when a set of conditions has been met without requiring further user input.

In some embodiments, after detecting that the connection with the resource for emergency assistance has ceased and in response to a determination that a predefined period of time (e.g., 1 minute to 5 hours) has passed since the connection with the resource for emergency assistance has ceased, the computer system ceases share of, to the resource for emergency assistance, access to the respective set of one or more other computer systems (e.g., represented by 832, 844, 856, and/or 868) (e.g., as described above with respect to FIG. 8G). In some embodiments, after detecting that the connection with the resource for emergency assistance has ceased and in response to a determination that the predefined period of time has not passed since the connection with the resource for emergency assistance has ceased, the computer system maintains, for the resource for emergency assistance, access to the respective set of one or more other computer systems. No longer sharing, to a resource for emergency assistance, access to a set of one or more computer system in response to a determination that a predefined period of time has passed since a connection with the resource for emergency assistance has ceased allows the computer system to maintain access to the resource for some time after the connection is over but still not require an explicit input to revoke the access, thereby reducing the number of inputs needed to perform an operation and/or performing an operation when a set of conditions has been met without requiring further user input.

In some embodiments, outputting the prompt (e.g., 808 and/or 820) to share access to one or more other computer systems (e.g., 808 and/or 820) with the resource for emergency assistance includes displaying, via the one or more display components, the prompt within the call user interface (e.g., as described above with respect to FIGS. 8E-8F). Displaying a prompt to share access to one or more computer system within a call user interface allows the computer system to couple sharing access with a communication without requiring navigating away from the call user interface, thereby reducing the number of inputs needed to perform an operation and/or performing an operation when a set of conditions has been met without requiring further user input.

In some embodiments, the respective set of one or more other computer systems includes a first computer system (e.g., represented by 832 and/or 844) and a second computer system (e.g., represented by 856, and/or 868) separate from the first computer system. In some embodiments, the prompt (e.g., 820) includes an identification of the first computer system and an identification of the second computer system (e.g., as described above with respect to FIG. 8F). In some embodiments, the identification of the second computer system is separate from the identification of the first computer system. Identifying multiple computer systems within a prompt to share access to the multiple computer systems allows the computer system to indicate which computer systems are being provided access, thereby providing improved visual feedback to the user and/or performing an operation when a set of conditions has been met without requiring further user input.

In some embodiments, the respective set of one or more other computer systems includes a first computer system (e.g., represented by 844) and a second computer system (e.g., represented by 868) separate from the first computer system. In some embodiments, the prompt (e.g., 820) includes video (and/or an indication and/or a representation of video) received from the first computer system and video (and/or an indication and/or a representation of video) received from the second computer system (e.g., as described above with respect to FIG. 8F). In some embodiments, the video received from the second computer system is separate from the video received from the first computer system. Including video from multiple computer systems in a prompt to share access to the multiple computer systems allows the computer system to show what will be shared in a process for sharing, thereby providing improved visual feedback to the user and/or performing an operation when a set of conditions has been met without requiring further user input.

In some embodiments, the respective set of one or more other computer systems includes a first computer system (e.g., represented by 832 and/or 844) and a second computer system (e.g., represented by 856, and/or 868) separate from the first computer system. In some embodiments, the prompt includes a control for modifying a state of the first computer system and a control for modifying a state of the second computer system (e.g., as described above with respect to FIG. 8F). In some embodiments, the control for modifying the state of the second computer system is separate from the control for modifying the state of the first computer system. In some embodiments, the control for modifying the state of the second computer system and/or the control for modifying the state of the first computer system is selectable such that each control can be selected by detecting, via the one or more input devices, an input corresponding to a control. A prompt to share access to multiple computer systems including controls for selecting each computer system allows the computer system to provide functionality for selecting which computer systems to share, thereby providing improved visual feedback to the user and/or performing an operation when a set of conditions has been met without requiring further user input.

In some embodiments, the respective set of one or more other computer systems includes a first computer system (e.g., represented by 832 and/or 844) and a second computer system separate from the first computer system. In some embodiments, the second computer system (e.g., represented by 856, and/or 868) is a different type (e.g., a camera, a lock, a speaker, and/or the like) of computer system than the first computer system (e.g., as described above with respect to FIG. 8F). Sharing, to a resource for emergency assistance, access to multiple different types of computer systems while displaying a call user interface corresponding to a connection with the resource for emergency assistance allows the computer system to provide different types of functionality using different types of computer systems to the resource for emergency assistance, thereby performing an operation when a set of conditions has been met without requiring further user input.

In some embodiments, sharing, to the resource for emergency assistance, access to the respective set of one or more other computer systems includes: in accordance with a determination that the respective set of one or more other computer systems is a first set of one or more other computer systems (e.g., represented by 832 and 844), sharing, to the resource for emergency assistance, access to the first set of one or more other computer systems (e.g., as described above with respect to FIGS. 8F-8G); and in accordance with a determination that the respective set of one or more other computer systems is a second set of one or more other computer systems (e.g., represented by 856, and 868), sharing, to the resource for emergency assistance, access to the second set of one or more other computer systems (e.g., as described above with respect to FIGS. 8F-8G) (e.g., without sharing access to the first set of one or more other computer system). Sharing, to a resource for emergency assistance, access to different sets of computer systems while displaying a call user interface corresponding to a connection with the resource for emergency assistance allows the computer system to customize access that it is giving for help from the resource while on a call with the resource, thereby reducing the number of inputs needed to perform an operation and/or performing an operation when a set of conditions has been met without requiring further user input.

In some embodiments, while the connection with the resource for emergency assistance is maintained, the computer system detects, via the one or more input devices, an input (e.g., a tap input and/or a voice request) corresponding to a request to select the respective set of one or more other computer systems, wherein the determination that the respective set of one or more other computer systems is the first set of one or more other computer systems (e.g., represented by 832 and 844) is based on the input corresponding to the request to select the respective set of one or more other computer systems, and wherein the determination that the respective set of one or more other computer systems is the second set of one or more other computer systems (e.g., represented by 856, and 868) is based on the input corresponding to the request to select the respective set of one or more other computer systems (e.g., as described above with respect to FIG. 8F). Sharing, to a resource for emergency assistance, access to different sets of computer systems selected while displaying a call user interface corresponding to a connection with the resource for emergency assistance allows the computer system to customize access that it is giving for help from the resource while on a call with the resource, thereby reducing the number of inputs needed to perform an operation and/or performing an operation when a set of conditions has been met without requiring further user input.

In some embodiments, the determination that the respective set of one or more other computer systems is the first set of one or more other computer systems (e.g., represented by 832 and 844) includes a determination that an emergency (and/or an event) is located at a first location. In some embodiments, the determination that the respective set of one or more other computer systems is the second set of one or more other computer systems (e.g., represented by 856, and 868) includes a determination that the emergency is located at a second location different from the first location (e.g., as described above with respect to FIG. 8F). Sharing, to a resource for emergency assistance, access to different sets of computer systems depending on a location of an emergency while displaying a call user interface corresponding to a connection with the resource for emergency assistance allows the computer system to customize access that it is giving for help from the resource while on a call with the resource, thereby reducing the number of inputs needed to perform an operation and/or performing an operation when a set of conditions has been met without requiring further user input.

In some embodiments, before displaying the call user interface (e.g., 884) corresponding to the connection with the resource for emergency assistance, the computer system displays, via the one or more display components, a notification (e.g., 800) of an activity (e.g., 812) (e.g., a stranger is at your home, a guest has arrived in your house, a person is in your living room, and/or a person from your home is calling you) at a location, wherein the connection is initiated from the notification of the activity at the location (e.g., as described above with respect to FIGS. 8A-8C). In some embodiments, the location is where the respective set of one or more other computer systems are located. In some embodiments, the computer system is at the location. In some embodiments, the computer system is away from the location. Initiating a connection with a resource for emergency assistance from a notification of an activity at a location allows the computer system to anticipate needs of a user and facility help from the resource without requiring the user navigate to a user interface for calling and entering a number, thereby reducing the number of inputs needed to perform an operation and/or performing an operation when a set of conditions has been met without requiring further user input.

In some embodiments, the computer system (e.g., 424) is a first computer system. In some embodiments, the notification (e.g., 800) is received from a second computer system (e.g., a resident device as described above) different from the first computer system. In some embodiments, the second computer system detected the activity (e.g., 812) at the location (e.g., as described above with respect to FIG. 8A). In some embodiments, the second computer system manages communication with and/or from the respective set of one or more other computer systems. Initiating a connection with a resource for emergency assistance from a notification of an activity at a location that is received from a computer system that detected the activity allows the computer system to anticipate needs of a user and facility help from the resource without requiring the user navigate to a user interface for calling and entering a number, thereby reducing the number of inputs needed to perform an operation and/or performing an operation when a set of conditions has been met without requiring further user input.

In some embodiments, the notification (e.g., 800) includes an identification of the location (e.g., as described above with respect to FIG. 8A). Initiating a connection with a resource for emergency assistance from a notification of an activity at a location that includes an identification of the location allows a user to understand where the activity is located when obtaining help for the activity, thereby reducing the number of inputs needed to perform an operation and/or performing an operation when a set of conditions has been met without requiring further user input.

In some embodiments, the notification (e.g., 800) includes media (e.g., video and/or audio) of (and/or from, associated with, corresponding to, and/or captured of) the location (e.g., as described above with respect to FIG. 8A). Initiating a connection with a resource for emergency assistance from a notification of an activity at a location that includes media of the location allows a user to understand what is occurring at the location when obtaining help for the activity, thereby reducing the number of inputs needed to perform an operation and/or performing an operation when a set of conditions has been met without requiring further user input.

In some embodiments, after (and/or in response to) sharing, to the resource for emergency assistance, access to the respective set of one or more other computer systems (e.g., represented by 832, 844, 856, and/or 868), the computer system displays, via the one or more display components, an indication (e.g., 804) that access was shared (e.g., as described above with respect to FIG. 8G). After sharing, to a resource for emergency assistance, access to a set of one or more computer systems, displaying an indication that access was shared allows the computer system to indicate a result of an operation after performing the operation, thereby performing an operation when a set of conditions has been met without requiring further user input.

In some embodiments, the indication (e.g., 804) that access was shared includes a control to stop sharing access. In some embodiments, while displaying the indication that access was shared, the computer system detects, via the one or more input devices, an input (e.g., a tap input and/or a voice request) corresponding to the control to stop sharing access (e.g., as described above with respect to FIG. 8G). In some embodiments, in response to detecting the input corresponding to the control to stop sharing access, the computer system ceases share of (and/or stops sharing), to the resource for emergency assistance, access to the respective set of one or more other computer systems (e.g., the resource for emergency assistance no longer has access to the respective set of one or more other computer system) (e.g., as described above with respect to FIG. 8G). After sharing, to a resource for emergency assistance, access to a set of one or more computer systems, displaying an indication that access was shared including a control to stop sharing access to the set of one or more computer systems allows the computer system to indicate a result of an operation after performing the operation with a way to reverse the result, thereby performing an operation when a set of conditions has been met without requiring further user input.

In some embodiments, the indication (e.g., 804) that access was shared includes an identification of a number of computer systems included in the respective set of one or more other computer system (e.g., represented by 832, 844, 856, and/or 868) (e.g., as described above with respect to FIG. 8G). After sharing, to a resource for emergency assistance, access to a set of one or more computer systems, displaying an indication that access was shared including an identification of a number of computer systems included in the set of one or more computer systems allows the computer system to indicate a result of an operation after performing the operation with a magnitude of the operation, thereby performing an operation when a set of conditions has been met without requiring further user input.

In some embodiments, the indication (e.g., 804) that access was shared includes an identification (e.g., a name and/or an identifier assigned, by a user and/or automatically, to the respective set of one or more other computer systems) of the respective set of one or more other computer systems(e.g., represented by 832, 844, 856, and/or 868) (e.g., as described above with respect to FIG. 8G) (e.g., in accordance with a determination that the respective set of one or more other computer systems includes a particular computer system, the indication that access was shared includes an identification, such as a name and/or an identifier assigned, by a user and/or automatically, to the particular computer system, of the particular computer system). After sharing, to a resource for emergency assistance, access to a set of one or more computer systems, displaying an indication that access was shared including an identification of the set of one or more computer systems allows the computer system to indicate a result of an operation after performing the operation with an identification of what was done, thereby performing an operation when a set of conditions has been met without requiring further user input.

In some embodiments, the prompt (e.g., 808 and/or 820) to share access to one or more other computer systems with the resource for emergency assistance is output in response to a determination that a predefined period of time (e.g., 5 seconds to 5 minutes) has passed since initiating the connection with the resource for emergency assistance (e.g., as described above with respect to FIGS. 8D-8F). Outputting a prompt to share access to one or more computer system with a resource for emergency assistance in response to a determination that a predefined period of time has passed since initiating a connection with the resource for emergency assistance allows a user to first interact with the resource before being prompted to provide access, thereby, performing an operation when a set of conditions has been met without requiring further user input.

Note that details of the processes described above with respect to process 900 (e.g., FIG. 9) are also applicable in an analogous manner to the processes described herein. For example, process 700 optionally includes one or more of the characteristics of the various processes described herein with reference to process 900. For example, the status of the environment in process 700 is detected via one or more accessory devices in process 900. For brevity, these details are not repeated herein.

FIGS. 10A-10V illustrate exemplary user interfaces for displaying and ceasing to display content in response to input in accordance with some embodiments. The user interfaces in these figures are used to illustrate the processes described below, including the processes in FIGS. 11 and 12.

FIGS. 10A-10V illustrate computer system 1000 as a smart phone. It should be recognized that computer system 1000 can be other types of computer systems such as a tablet, a smart watch, a laptop, a communal device, a smart speaker, an accessory, a personal gaming system, a desktop computer, a fitness tracking device, and/or a head-mounted display (HMD) device. In some embodiments, computer system 1000 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 1000 includes and/or is in communication with one or more output devices (e.g., a display screen, a projector, a touch-sensitive display, a speaker, and/or a movement component). In some embodiments, computer system 1000 includes one or more components and/or features described above in relation to computer system 100 and/or electronic device 200.

FIGS. 10A-10V are split between a left side and a right side to illustrate a subject in a physical environment interacting with computer system 1090 via computer system 1000. In the examples illustrated in FIGS. 10A-10V, the right side illustrates a top-down schematic view of physical environment 1006 that includes tablet representation 1008 (e.g., representing a tablet located in the environment, and first user representation 1004 (e.g., a person interacting with computer system 1000 by providing inputs, the first user). In some embodiments, the relative positioning of first user representation 1010 is indicative of relative physical positioning of the first user in a physical environment. The left side of FIGS. 10A-10V illustrate output of computer system 1000. While FIGS. 10A-10V illustrate computer system 1000 outputting particular content, it should be recognized that such content is merely for explanatory purposes and that such content can be in different forms, at different locations, at different sizes, include different content, and/or that more, fewer, and/or different content can be output in accordance with techniques described herein.

While the examples in FIGS. 10A-10V include computer system 1090 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, inputs detected by computer system 1090 are passive inputs that are not purposefully directed at computer system 1090 by a subject (e.g., a person, an animal, an object, and/or a device). Examples of such inputs include, but are not limited to, motion of the subject through the environment, location of the subject within the environment, direction that the subject is facing and/or looking, light levels within the environment, and/or sound levels within the environment.

FIG. 10A illustrates computer system 1000 displaying environment activities user interface 1002. As illustrated in FIG. 10A, within environment activities user interface 1002, computer system 1000 displays one or more indications of activities detected by computer system 1090 within in the environment in the order that they were detected.

FIG. 10B illustrates computer system 1000 displaying user activity user interface 1020. As illustrated in FIG. 10B, within user activity user interface 1020, computer system 1000 displays one or more indications of activities of a registered user (e.g., the first user) that are detected by computer system 1090 within the environment. As illustrated in FIG. 10B, computer system 1000 displays the indications of activities of the registered user in the order that they were detected.

FIG. 10C illustrates computer system 1000 displaying user activity user interface 1020 after a recognition scenario. In this recognition scenario, when the first user enters the environment, computer system 1090 detects computer system 1000, which is associated with the first user, and the first user's face is recognized by computer system 1090 via one or more cameras in communication with computer system 1090. At FIG. 10C, in response to the first user being detected at the environment, via computer system 1090 detecting computer system 1000, computer system 1090 outputs a chime via living room smart speaker, as indicated by music notes 1022. Also at FIG. 10C, in response to the first user being recognized by computer system 1090, computer system 1090 outputs a greeting to the first user (e.g., “Welcome home, Jane.”) via the living room smart speaker, as indicated by output 1024. At FIG. 10C, in response to the first user arriving at the environment with computer system 1000 and computer system 1090 recognizing the first user, computer system 1090 activates the cooling of the environmental control system of the environment to 68 degrees. It should be noted that this is just an example and that other automations of the environment can be activated, such as lights, shades, music, televisions, and/or locks.

FIG. 10D illustrates computer system 1000 displaying user activity user interface 1020 after a first scenario where computer system 1090 does not recognize the first user and requires a second form of authentication to confirm the user. At FIG. 10D, the first user arrives at the environment and is detected by computer system 1090 by detecting computer system 1000. At FIG. 10D, in response to the first user being detected at the environment, via computer system 1090 detecting computer system 1000, computer system 1090 outputs a chime via living room smart speaker, as indicated by music notes 1022. At FIG. 10D, in response to the first user arriving at the environment with their face obscured (e.g., wearing a head, scarf, facemask, makeup, and/or glasses), computer system 1090 requires the first user to verify their identity in a secondary manner. At FIG. 10D, the first user uses a facial recognition scan to unlock computer system 1000 via one or more cameras of computer system 1000. At FIG. 10D, in response to the first user unlocking computer system 1000 via facial recognition scan, computer system 1090 makes a determination that the first user is authenticated. At FIG. 10D, in response to computer system 1090 making a determination that the first user is authenticated, computer system 1090 computer system 1090 outputs a greeting to the first user (e.g., “Welcome home, Jane.”) via the living room smart speaker, as indicated by output 1024. At FIG. 10D, in response to the first user arriving at the environment with computer system 1000 and computer system 1090 making the determination that the first user is authenticated, computer system 1090 activates the cooling of the environmental control system of the environment to 68 degrees. It should be noted that this is just an example and that other automations of the environment can be activated, such as lights, shades, music, televisions, and/or locks.

FIG. 10E illustrates computer system 1000 displaying user activity user interface 1020 after a second scenario where computer system 1090 does not recognize the first user and requires a second form of authentication to confirm the user. At FIG. 10E, the first user arrives at the environment and is detected by computer system 1090 by detecting computer system 1000. At FIG. 10E, in response to the first user being detected at the environment, via computer system 1090 detecting computer system 1000, computer system 1090 outputs a chime via living room smart speaker, as indicated by music notes 1022. At FIG. 10E, in response to the first user arriving at the environment with their face obscured (e.g., wearing a head, scarf, facemask, makeup, and/or glasses), computer system 1090 requires the first user to verify their identity in a secondary manner. At FIG. 10E, the first user walks up the tablet and the first user's face is recognized by the camera of the tablet. At FIG. 10E, in response to the tablet recognizing the first user's face, computer system 1090 makes a determination that the first user is authenticated. At FIG. 10E, in response to computer system 1090 making a determination that the first user is authenticated, computer system 1090 computer system 1090 outputs a greeting to the first user (e.g., “Welcome home, Jane.”) via the living room smart speaker, as indicated by output 1024. At FIG. 10E, in response to the first user arriving at the environment with computer system 1000 and computer system 1090 making the determination that the first user is authenticated, computer system 1090 activates the cooling of the environmental control system of the environment to 68 degrees. It should be noted that this is just an example and that other automations of the environment can be activated, such as lights, shades, music, televisions, and/or locks.

FIG. 10F illustrates computer system 1000 displaying user activity user interface 1020 after a third scenario where computer system 1090 does not recognize the first user and requires a second form of authentication to confirm the user. At FIG. 10F, the first user arrives at the environment and is detected by computer system 1090 by detecting computer system 1000. At FIG. 10F, in response to the first user being detected at the environment, via computer system 1090 detecting computer system 1000, computer system 1090 outputs a chime via living room smart speaker, as indicated by music notes 1022. At FIG. 10F, in response to the first user arriving at the environment with their face obscured (e.g., wearing a head, scarf, facemask, makeup, and/or glasses), computer system 1090 requires the first user to verify their identity in a secondary manner. At FIG. 10F, computer system 1090 sends a notification to the first user's devices requesting that the first user confirm that it is them at the environment. At FIG. 10F, the first user confirms on the first user's smart watch that it is the first user in the environment. At FIG. 10F, in response to the user confirming on the first user's smart watch that it is the first user in the environment, computer system 1090 makes a determination that the first user is authenticated. At FIG. 10F, in response to computer system 1090 making a determination that the first user is authenticated, computer system 1090 computer system 1090 outputs a greeting to the first user (e.g., “Welcome home, Jane.”) via the living room smart speaker, as indicated by output 1024. At FIG. 10F, in response to the first user arriving at the environment with computer system 1000 and computer system 1090 making the determination that the first user is authenticated, computer system 1090 activates the cooling of the environmental control system of the environment to 68 degrees. It should be noted that this is just an example and that other automations of the environment can be activated, such as lights, shades, music, televisions, and/or locks.

FIG. 10G illustrates computer system 1000 displaying user activity user interface 1020 after a scenario where the first user arrives at the environment without computer system 1000. At FIG. 10F, the first user arrives at the environment and is identified by computer system 1090 via one or more cameras in communication with computer system 1090. At FIG. 10G, in response to computer system 1090 detecting the first user at the environment while not detecting computer system 1000, computer system 1090 outputs a chime via living room smart speaker, as indicated by music notes 1022. At FIG. 10G, in response to computer system 1090 detecting the first user at the environment while not detecting computer system 1000, computer system 1090 outputs content via the living room smart speaker requesting that the first user verify their identity in a secondary manner (e.g., “Hi, Jane. Can you confirm it is you by verifying your PIN.”), as indicated by content 1026. At FIG. 10G, the first user enters their PIN via the tablet. At FIG. 10G, in response to the first user entering their PIN via the tablet, computer system 1090 makes a determination that the first user is authenticated. In some embodiments, in response to computer system 1090 making a determination that the first user is authenticated, computer system 1090 computer system 1090 outputs a greeting to the first user (e.g., “Welcome home, Jane.”) via the living room smart speaker. At FIG. 10G, in response to the first user arriving at the environment with computer system 1000 and computer system 1090 making the determination that the first user is authenticated, computer system 1090 activates the cooling of the environmental control system of the environment to 68 degrees. It should be noted that this is just an example and that other automations of the environment can be activated, such as lights, shades, music, televisions, and/or locks.

FIG. 10H illustrates computer system 1000 displaying user activity user interface 1020 after a scenario where the first user arrives at the environment while another registered occupant of the environment (e.g., a second user) is already recognized by computer system 1090 at the environment. At FIG. 10H, in response to detecting the first user in the environment, via detecting computer system 1000 and/or identifying the first user via one or more cameras in communication with computer system 1090, while the second user is already in the environment, computer system 1090 outputs a chime via living room smart speaker, as indicated by music notes 1022. At FIG. 10H, in response to detecting the first user in the environment while detecting the second user is already in the environment, computer system 1090 outputs content via the living room smart speaker alerting the second user that the first user has arrived at the environment (e.g., “Jane is home.”), as indicated by content 1028. At FIG. 10H, in response to the second user already being in the environment when the first user is detected, computer system 1090 does not activate the cooling of the environmental control system.

FIG. 10I illustrates computer system 1000 displaying lock screen user interface 1032. At FIG. 10I, a first guest (e.g., Phil), who is registered with computer system 1090, arrives at the environment, as indicated by first guest representation 1034 being illustrated within physical environment 1006, and is recognized by computer system 1090. As illustrated in FIG. 10I, in response to computer system 1090 recognizing the first guest, computer system 1000 displays recognized guest indicator 1050 overlayed on lockscreen user interface 1032. As illustrated in FIG. 10I, in response to computer system 1090 continuing to detect the first guest at the environment, computer system 1000 displays recognized guest indicator 1050 indicating that the first guest is at the environment (e.g., Phil is at your home).

At FIG. 10H, at a time after FIG. 10I, the first guest (e.g., Phil) who is registered with computer system 1090 is no longer at the environment, as indicated by first guest representation 1034 not being illustrated within physical environment 1006, and is no longer detected by computer system 1090. As illustrated in FIG. 10H, in response to computer system 1090 no longer detecting the first guest, computer system 1000 displays recognized guest indicator 1050 overlayed on lock screen user interface 1032. As illustrated in FIG. 10H, in response to computer system 1090 no longer detecting the first guest at the environment, computer system 1000 displays recognized guest indicator 1050 indicating that the first guest was formerly at the environment (e.g., Phil visited your home).

FIG. 10J illustrates computer system 1000 displays recognized guest activity user interface 1046. As illustrated in FIG. 10J, within recognized guest activity user interface 1046, computer system 1000 displays one or more indications of activities of a recognized guest (e.g., the first guest) that are detected by computer system 1090 within the environment. As illustrated in FIG. 10J, computer system 1000 displays the indications of activities of a recognized guest in the order that they were detected.

FIG. 10K illustrates computer system 1000 displaying lock screen user interface 1032. At FIG. 10K, a second guest (e.g., John the plumber), who is not registered with computer system 1090, arrive at the environment. In response, computer system 1090 outputs content requesting that the unregistered guess.

FIG. 11 is a flow diagram illustrating a process (e.g., process 1100) for displaying a live feed of various cameras in accordance with some embodiments. Some operations in process 1100 are, optionally, combined, the orders of some operations are, optionally, changed, and some operations are, optionally, omitted.

As described below, process 1100 provides an intuitive way for displaying a live feed of various cameras. Process 1100 reduces the cognitive burden on a user, thereby creating a more efficient human-machine interface. For battery-operated computing devices, enabling a user to interact with such devices faster and more efficiently conserves power and increases the time between battery charges.

In some embodiments, process 1100 is performed at a computer system that is in communication (e.g., wired or wirelessly) with (and/or includes) one or more output devices (e.g., a display generation component, an audio generation component, and/or a haptic generation component). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system receives (1102) an indication that a set of one or more operations (e.g., lowering blinds, powering on lights, powering on television, adjusting thermostat, and/or locking door) is performed based on (e.g., in response to detecting and/or in conjunction with) a subject entering an environment (e.g., a home, a room, an office, an environment of the computer system and/or an environment different from the environment of the computer system). In some embodiments, the set of one or more operations is a preconfigured automation. In some embodiments, the subject previously selected, set, and/or identified the set of one or more operations.

In response to (1104) (e.g., and/or in conjunction with) receiving the indication that the set of one or more operations is performed based on the subject entering the environment, in accordance with a determination that a first set of one or more criteria is satisfied (e.g., that the subject is a first subject, that the set of one or more operations includes a particular operation, that the one or more operations are performed at a specific time of day, and/or that the one or more operations are performed at a specific location of the environment), the computer system outputs (1106) (e.g., audibly outputs and/or visually outputs), via the one or more output devices, an indication (e.g., a notification and/or an audible description) that includes a first explanation regarding (e.g., for and/or corresponding to) performance of the set of one or more operations (e.g., why the one or more operations are being performed and/or what event and/or activity triggered the performance of the one or more operations).

In response to (1104) receiving the indication that the set of one or more operations is performed based on the subject entering the environment, in accordance with a determination that a second set of one or more criteria (e.g., that the subject is a first subject, that the set of one or more operations includes a particular operation, that the one or more operations are performed at a specific time of day, and/or that the one or more operations are performed at a specific location of the environment) is satisfied, the computer system outputs (1108) (e.g., audibly outputs and/or visually outputs), via the one or more output devices, the indication that includes a second explanation (e.g., why the one or more operations are being performed and/or what event and/or activity triggered the performance of the one or more operations) regarding (e.g., for and/or corresponding to) performance of the set of one or more operations, wherein the second explanation is different from the first explanation, and wherein the first set of one or more criteria is different from the second set of one or more criteria. In some embodiments, while displaying a notification that indicates a first device (e.g., a first accessory device, such as a camera) is being remotely accessed (e.g., by emergency services), the computer system receives an indication that a second device (e.g., a second accessory device, such as a camera) is being remotely accessed (e.g., by emergency services) and, in response, update notification to indicate that the second device is being remotely accessed (e.g., by emergency services). In some embodiments, the second device is separate and/or different from the first device. Performing an operation when a set of conditions has been met without requiring further user input (such as by outputting different explanations of why one or more operations are performed based on which set of criteria is satisfied) enhances the operability of the device by reducing unnecessary inputs and/or steps to navigate through different user interfaces or sets of controls, reducing energy usage by the device. Providing improved feedback (such as by outputting an explanation regarding a performance of one or more operations) enhances the operability of the device by reducing accidental and mistaken inputs, reducing energy usage by the device. Reducing the number of inputs needed to perform an operation (such as by outputting an explanation regarding a performance of one or more operations in response to receiving an indication that the set of one or more operations are performed) enhances the operability of the device by reducing the number of inputs and time required to perform a particular operation, reducing energy usage by the device.

In some embodiments, outputting the indication includes outputting an identification of the subject (e.g., a graphical identification and/or a textual identification). In some embodiments, the identification of the subject is an image, video, representation of the name of the subject, and/or initials of the subject.

In some embodiments, the computer system is in communication (e.g., wired and/or wirelessly) with (or includes) one or more display components (e.g., a display screen, a projector, a head mounted display, and/or a touch-sensitive display). In some embodiments, outputting the indication includes displaying, via the one or more display components, the indication. In some embodiments, while displaying the indication, the computer system displays, via the one or more display components, one or more indications (e.g., a textual indication and/or a graphical indication) of one or more activities (e.g., subjects who have entered the environment, subjects who have exited the environment, that a subject is cooking in the environment, that playback of media has started, that an accessory device has been turned on or off) performed (e.g., currently performed or previously performed) in the environment. In some embodiments, computer system updates display of the one or more indications as additional activities are detected as being performed in the environment. In some embodiments, the one or more activities correspond to a single subject.

In some embodiments, the one or more activities are performed by the subject.

In some embodiments, at least one activity of the one or more activities is performed by another subject different from the subject.

In some embodiments, the indication includes an icon (e.g., a graphical representation and/or graphical element) corresponding to (e.g., directed to, of, related to, representative of, and/or associated with) one or more accessories (e.g., lights, thermostat, speakers, and/or television) that performed the set of one or more operations.

In some embodiments, the computer system is in communication (e.g. wired and/or wireless communication) with (or includes) one or more display components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, after outputting the second indication, the computer system detects, via the one or more input devices, an input (e.g., a tap input, a swipe input, voice command and/or air gesture) corresponding to (e.g., directed to, related to, and/or associated with) a request to display one or more representations of activities detected in the environment. In some embodiments, in response to detecting the input corresponding to the request to display the one or more representations of activities detected in the environment, the computer system displays, via the one or more display components, the indication (e.g., with the first explanation, the second explanation, or an explanation different from the first explanation and the second explanation). In some embodiments, in response to detecting the input corresponding to the request to display the one or more representations of activities detected in the environment, the computer system displays one or more representations of activities detected in the environment.

In some embodiments, the indication that includes the first explanation further includes an identification of the subject (e.g., as described above with respect to FIG. 13D) (e.g., a graphical identification and/or a textual identification). In some embodiments, the identification of the subject is an image, video, representation of the name of the subject, and/or initials of the subject. In some embodiments, the indication that includes the second explanation further includes the identification of the subject.

In some embodiments, the computer system is in communication (e.g., wired and/or wirelessly) with (or includes) one or more display components (e.g., a display screen, a projector, a head mounted display, and/or a touch-sensitive display). In some embodiments, outputting the indication that includes the first explanation includes displaying, via the one or more display components, the indication that includes the first explanation. In some embodiments, outputting the indication that includes the second explanation includes displaying, via the one or more display components, the indication that includes the second explanation. In some embodiments, in response to (e.g., and/or in conjunction with) receiving the indication that the set of one or more operations is performed based on the subject entering the environment, the computer system displays, via the one or more display components, one or more indications (e.g., a textual indication and/or a graphical indication) of one or more activities (e.g., subjects who have entered the environment, subjects who have exited the environment, that a subject is cooking in the environment, that playback of media has started, that an accessory device has been turned on or off) performed (e.g., currently performed or previously performed) in the environment (e.g., as described above with respect to FIG. 13D). In some embodiments, computer system updates display of the one or more indications as additional activities are detected as being performed in the environment. In some embodiments, the one or more activities correspond to a single subject.

In some embodiments, the one or more activities are determined to be performed by the subject (e.g., as described above with respect to FIG. 13D).

In some embodiments, at least one activity of the one or more activities is determined to be performed by another subject different from the subject (e.g., as described above with respect to FIG. 13D).

In some embodiments, the indication that includes the first explanation includes an icon (e.g., a graphical representation and/or graphical element) corresponding to (e.g., directed to, of, related to, representative of, and/or associated with) one or more accessories (e.g., lights, thermostat, speakers, and/or television) that performed the set of one or more operations (e.g., as described above with respect to FIG. 13D). In some embodiments, the indication that includes the second explanation includes the icon corresponding to the one or more accessories that performed the set of one or more operations.

In some embodiments, the computer system is in communication (e.g. wired and/or wireless communication) with (or includes) one or more display components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, after outputting the indication that includes the first explanation, the computer system detects, via the one or more input devices, an input (e.g., a tap input, a swipe input, voice command and/or air gesture) corresponding to (e.g., directed to, related to, and/or associated with) a request to view activity detected in the environment (e.g., as described above with respect to FIG. 13D). In some embodiments, in response to detecting the input corresponding to the request to view activity detected in the environment, the computer system displays, via the one or more display components, the indication that includes the first explanation (e.g., as described above with respect to FIG. 13D).

Note that details of the processes described above with respect to process 1100 (e.g., FIG. 11) are also applicable in an analogous manner to other processes described herein. For example, process 1200 optionally includes one or more of the characteristics of the various processes described above with reference to process 1100. For example, the one or more camera feeds of process 1100 can be displayed in response to detecting the identity of the subject as described process 1200. For brevity, these details are not repeated herein.

FIG. 12 is a flow diagram illustrating a process (e.g., process 1200) for assisting a subject with an authentication process in accordance with some embodiments. Some operations in process 1200 are, optionally, combined, the orders of some operations are, optionally, changed, and some operations are, optionally, omitted.

As described below, process 1200 provides an intuitive way for assisting a subject with an authentication process. Process 1200 reduces the cognitive burden on a user, thereby creating a more efficient human-machine interface. For battery-operated computing devices, enabling a user to interact with such devices faster and more efficiently conserves power and increases the time between battery charges.

In some embodiments, process 1200 is performed at a computer system. In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system receives (1202) an indication that an identified subject (e.g., a registered user, a known person, a recognized animal, another associated computer system different from the computer system, a device, and/or an object) with a respective authentication level is detected (and/or present) in an environment (e.g., a physical environment, such as a home, a room, a yard, and/or a building). In some embodiments, the indication that the identified subject with the respective authentication level is detected in the environment is received from another computer system external to the computer system. In some embodiments, the computer system is in communication with one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the indication that the identified subject with the respective authentication level is detected in the environment is detected via the one or more input devices.

In response to (1204) receiving the indication that the identified subject with the respective authentication level is detected in the environment, in accordance with a determination that the respective authentication level satisfies a first set of one or more criteria, wherein the first set of one or more criteria includes a criterion that is satisfied when the respective authentication level is a first authentication level (e.g., is authenticated and/or has been identified in two different manners), the computer system initiates (1206) an automation (e.g., operation and/or function).

In response to (1204) receiving the indication that the identified subject with the respective authentication level is detected in the environment, in accordance with a determination that the respective authentication level satisfies a second set of one or more criteria, wherein the second set of one or more criteria includes a criterion that is satisfied when the respective authentication level is a second authentication level (e.g., is identified but not authenticated and/or has one identification but not a second separate identification), the computer system forgoes (1208) initiation of the automation, wherein the second authentication level is different from the first authentication level. In some embodiments, the first authentication level is higher than the second authentication level.

In some embodiments, the automation is a first automation. In some embodiments, after initiating the first automation, the computer system receives an indication that the identified subject has a third authentication level different from the first authentication level (and/or the second authentication level). In some embodiments, in response to receiving the indication that the identified subject has the third authentication level, the computer system initiates a second automation different from the first automation. In some embodiments, the second automation requires the third authentication level while the first automation requires the first authentication level.

In some embodiments, the computer system is a first computer system. In some embodiments, initiating the automation includes sending, to a second computer system, a request to change an accessory device to a first state. In some embodiments, the second computer system is different from the first computer system. In some embodiments, the second computer system is the accessory device. In some embodiments, the second computer system is separate from the accessory device. In some embodiments, the second computer system is a light source, a watch, a phone, a tablet, a fitness tracking device, a processor, a head-mounted display (HMD) device, an accessory device, a communal device, a media device, a speaker, a television, and/or a personal computing device. In some embodiments, the second computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

In some embodiments, the computer system is a first computer system. In some embodiments, the first set of one or more criteria includes a criterion that is satisfied when the automation includes changing a state of a security accessory device (e.g., a lock and/or a garage). In some embodiments, the second set of one or more criteria includes a criterion that is satisfied when the automation does not include changing a state of a security accessory device (e.g., a lock and/or a garage).

In some embodiments, the identified subject is a first identified subject. In some embodiments, the automation is a first automation. In some embodiments, after initiating the first automation, the computer system receives an indication that a second identified subject has a fourth authentication level, wherein the second identified subject is different from the first identified subject. In some embodiments, the fourth authentication level is the same as the first authentication level or the second authentication level. In some embodiments, the fourth authentication level is different from the first authentication level and/or the second authentication level. In some embodiments, in response to receiving the indication that the second identified subject has the fourth authentication level, the computer system initiates a third automation different from the first automation. In some embodiments, the third automation corresponds to the second identified subject and does not correspond to the first identified subject. In some embodiments, the first automation corresponds to the first identified subject and does not correspond to the second identified subject. In some embodiments, the first automation and/or the second automation does not correspond to a specific subject but instead corresponds to detecting any subject enter the environment.

In some embodiments, the identified subject is a first identified subject. In some embodiments, the automation is a first automation. In some embodiments, after initiating the first automation, the computer system receives an indication that a third identified subject has a fifth authentication level, wherein the third identified subject is different from the first identified subject. In some embodiments, in response to receiving the indication that the third identified subject has the fifth authentication level, the computer system forgoes initiation of am automation (e.g., any automation).

In some embodiments, the indication that the identified subject is detected in the environment is received from a personal device (e.g., a phone, computer system, and/or tablet) corresponding to (e.g., owned by and/or of) the identified subject. In some embodiments, the personal device detects the identified subject is in the environment.

Note that details of the processes described above with respect to process 1200 (e.g., FIG. 12) are also applicable in an analogous manner to the processes described herein. For example, process 1100 optionally includes one or more of the characteristics of the various processes described herein with reference to process 1200. For example, the notification to authenticate a subject as described in process 1200 can be sent while a camera feed described in process 1100 is displayed. For brevity, these details are not repeated herein.

FIGS. 13A-13G illustrate exemplary environments for depicting performance of automations in accordance with some embodiments. The environments in these figures are used to illustrate the processes described below, including the processes in FIG. 14.

FIGS. 13A-13G illustrate environment 1302 that includes first portion 1302a and second portion 1302b. As illustrated in FIG. 13A, first portion 1302a includes computer system 1300. At FIGS. 13A-13G, environment 1302 is a home, first portion 1302a is a living room, second portion 1302b is a bedroom, and computer system 1300 is a tablet. It should be recognized that a home is an example of an environment that can be used with techniques described herein and that other types of environments can also be used, such as an office, an outdoor space, and/or a room. It should also be recognized that a room is an example of a portion of an environment that can be used with techniques described herein and that other types of division can also be used, such as part of a room, a number of devices, and/or which user account is logged into different devices. It should also be recognized that computer system 1300 can be other types of computer systems such as a hub device, a smart phone, a smart watch, a laptop, a communal device, a smart speaker, an accessory, a personal gaming system, a desktop computer, a fitness tracking device, and/or a head-mounted display (HMD) device. In some embodiments, computer system 1300 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 1300 includes and/or is in communication with one or more output devices (e.g., a display screen, a projector, a touch-sensitive display, a speaker, and/or a movement component). In some embodiments, computer system 1300 includes one or more components and/or features described above in relation to computer system 1000.

As illustrated in FIG. 13A, environment 1302 includes lights 1304, speaker 1322, speaker 1338, television 1340, and lock 1330. In some embodiments, computer system 1300 is in communication (e.g., wireless communication and/or wired communication) with each of lights 1304, speaker 1322, speaker 1338, television 1340, and lock 1330. In some embodiments, lights 1304, speaker 1322, speaker 1338, television 1340 and/or lock 1330 are registered with computer system 1300. In some embodiments, computer system 1300, lights 1304, speaker 1322, speaker 1338, television 1340 and/or lock 1330 are registered with a common user account. At FIG. 13A, lights 1304 are powered off (e.g., as indicated by the hatching pattern within lights 1304), lock 1330 is in a locked state and speaker 1322, speaker 1338, and television 1340 are not outputting content (e.g., audio content and/or visual content).

FIG. 13A illustrates individual 1312 (e.g., hereinafter referred to as Greg) outside of environment 1302. In some embodiments, Greg and/or a personal device of Greg is registered with computer system 1300 and/or one or more computer systems (e.g., lights 1304, speaker 1322, speaker 1338, television 1340 and/or lock 1330) within environment 1302.

At FIG. 13B, Greg is detected as entering environment 1302. In some embodiments, computer system 1300 detects Greg as entering environment 1302. For example, one or more cameras of computer system 1300 detect that Greg is positioned within environment 1302. In some embodiments, one or more cameras and/or one or more microphones external to computer system 1300 detect that Greg enter environment 1302. In such embodiments, computer system 1300 receives an indication that Greg enters environment 1302. In some embodiments, Greg is detected as entering environment 1302 in response to computer system 1300 receiving a signal from the personal device of Greg. For example, Greg is detected as entering environment 1302 in response to computer system 1600 receiving a signal from a smart phone of Greg.

At FIG. 13B, Greg is unable to be identified once within environment 1302. In some embodiments, Greg cannot be identified because a portion of his face is covered. For example, Greg is wearing a scarf and/or a hat such that one or more facial features (e.g., eyes, mouth, nose and/or ears) of Greg are covered. In some embodiments, Greg cannot be identified because the personal device of Greg is not within a predetermined distance of a computer system responsible for identifying subjects within environment 1302. For example, a smart phone and/or a smart watch of Greg is not within a predetermined distance of computer system 1300. In some embodiments, Greg cannot be identified because Greg is not registered with computer system 1300 and/or a computer system that is responsible for identifying subjects who enter environment 1302.

At FIG. 13B, because Greg cannot be identified, computer system 1300 does not cause performance of one or more automations (e.g., one or more operations of one or more devices). That is, when a subject that cannot be identified is detected as entering environment 1302 the subject does not have the necessary level of authentication to cause performance of the one or more automations. In some embodiments, computer system 1300 causes one or more devices within environment 1302 to perform one or more default automations when an unidentified subject is detected as entering environment 1302. For example, computer system 1300 causes television 1340 to power on based on a determination that an unidentified subject enters environment 1302. In some embodiments, Greg is able to be identified. In such embodiments, computer system 1300 does not cause performance of any automation (e.g., including or not including the one or more default automations) because no automations are preconfigured for Greg.

An amount of time elapses between FIGS. 13B and 13C. FIG. 13C illustrates individual 1324 (e.g., hereinafter referred to as Veronica) outside of environment 1302. Computer system 1300 has previously registered a first automation with Veronica. The first automation requires a single factor authentication of Veronica. In some embodiments, a personal device (e.g., smart phone, smart watch, and/or tablet) of Veronica is registered with computer system 1300 and/or environment 1302. In some embodiments, Veronica and/or a personal device of Veronica is registered with computer system 1300 and/or one or more computer systems (e.g., lights 1304, speaker 1322, speaker 1338, television 1340 and/or lock 1330) within environment 1302.

At FIG. 13D, Veronica is detected as entering environment 1302. In some embodiments, computer system 1300 detects Veronica as entering environment 1302. For example, one or more cameras of computer system 1300 detect that Veronica is positioned within environment 1302. In some embodiments, one or more cameras and/or one or more microphones external to computer system 1300 detect that Veronica enters environment 1302. In such embodiments, computer system 1300 receives an indication that Veronica enters environment 1302. In some embodiments, Veronica is detected as entering environment 1302 in response to computer system 1300 receiving a signal from the personal device of Veronica.

At FIG. 13D, Veronica is identified. In some embodiments, Veronica is identified using an image of Veronica. For example, Veronica is identified using an image that is captured by one or more cameras of computer system 1300. For another example, Veronica is identified using an image that is captured by one or more cameras that are external to computer system 1300. In such embodiments, computer system 1300 receives an indication of the identity of Veronica. In some embodiments, Veronica is identified via a signal that computer system 1300 receives from the personal device of Veronica. For example, Veronica is identified in response to computer system 1300 (e.g., or a different computer system) receiving a signal from a smartphone of Veronica. In some embodiments, a computer system other than computer system 1300 identifies Veronica. In such embodiments, computer system 1300 receives an indication of the identity of Veronica.

At FIG. 13D, because Veronica is identified after entering environment 1302, Veronica satisfies the single factor authentication requirement of the first automation. As a result, computer system 1300 causes the performance of the first automation. As part of causing the performance of the first automation, as indicated by the presence of music note 1334 near speaker 1322, computer system 1300 causes speaker 1322 to output media (e.g., a song, podcast, and/or audiobook). In some embodiments, computer system 1300 does not cause the initiation of the first automation based on the state of speaker 1322. For example, if speaker 1322 is already outputting content when Veronia enters environment 1302 and is identified (e.g., satisfies the single factor authentication requirement of the first automation), computer system 1300 does not cause speaker 1322 to output the media. For another example, if the first automation includes locking a door within environment 1302, computer system 1300 does not lock the door if a determination is made that the door is ajar. In some embodiments, computer system 1300 does not cause the initiation of the first automation if Veronica does not satisfy the single factor authentication requirement of the first automation.

The contrast of FIGS. 13B and 13D highlight different behavior of computer system 1300 when individuals with different authentication levels are detected as entering environment 1302. That is, at FIG. 13B, because Greg is not able to be identified after being detected as entering environment 1302, computer system 1300 does not cause performance of an automation. To the contrary, at FIG. 13D, because Veronica is identified after being detected as entering environment 1302 (e.g., the authentication level of Veronica is greater than the authentication level of Greg), computer system 1300 causes performance of the first automation.

In some embodiments, based on Veronica being authenticated after entering environment 1302, computer system 1300 causes initiation of one or more automations that are based on a detected context. In some embodiments, the detected context is a characteristic of Veronica such as the location of Veronica within environment 1302. For example, based on Veronica being authenticated after entering environment 1302 and Veronica being within a predetermined distance of speaker 1338, computer system 1300 causes speaker 1338 to output the media (e.g., and not speaker 1322 or in conjunction with speaker 1322) as part of initiating the first automation. In some embodiments, the detected context is a characteristic of environment 1302. For example, based on Veronica being authenticated after entering environment 1302, computer system 1300 causes the initiation of an automation that decreases a temperature setting of a thermostat when a determination is made the temperature in environment 1302 is greater than a threshold.

In some embodiments, as a part of initiating the first automation, computer system 1300 causes a personal device of a resident and/or registered subject of environment 1302 to output an indication of the first automation. For example, as part of initiating the first automation, computer system 1300 causes a smart phone of the resident and/or registered subject of environment 1302 to display an indication of the operations included in the first automation and/or an explanation for the performance of the first automation (e.g., Veronica was detected in environment 1302). For another example, at FIG. 13D, as part of initiating the first automation, computer system 1300 audibly outputs “the speaker is now playing”. As an additional example, as part of initiating the first automation, computer system 1300 displays a representation of speaker 1322 and/or causes a device of the resident and/or registered subject of environment 1302 to display a representation of speaker 1322.

In some embodiments, the indication of the first automation includes an indication of who is detected in environment 1302. In some embodiments, the indication of the first automation includes a time at which the first automation is performed. In some embodiments, computer system 1300 outputs the indication of the first automation.

In some embodiments, the indication of the first automation is based on who is detected as entering environment 1302 and/or the reasoning for the performance of the first automation. For example, the indication of the first automation includes a description that Veronica is detected in the environment as the reasoning for performance of the first automation when the presence of Veronica in environment 1302 is the cause for the performance of the first automation. In some embodiments, in response to detecting an input while displaying the indication of the first automation, computer system 1300 displays indications of previous activities that were detected within environment 1302. For example, in response to detecting an input while displaying the indication of the first automation, computer system 1300 displays an indication of one or more activities that Veronica and/or someone other than Veronica previously performed within environment 1302. In some embodiments, the indication of the first automation includes an indication of one or more activities that the subject who is detected as entering environment 1302 is performing. For example, the indication of the first automation includes an indication that Veronica is sitting on a couch when it is determined that Veronica is sitting on the couch after entering environment 1302. In some embodiments, the indication of the first automation includes representations of one or more activities that subjects different from the subject who is detected as entering environment 1302 are performing.

In some embodiments, because Veronica is identified after entering environment 1302, computer system 1300 causes performance of a default set of one or more automations instead of one or more automations that are preconfigured for Veronica. For example, based on Veronica being authenticated after entering environment 1302, computer system 1300 causes performance of an automation that is performed whenever an individual is identified after entering environment 1302. In some embodiments, computer system 1300 does not cause performance of an automation when an individual is detected as entering environment 1302 and is identified because no automation is preconfigured for the individual. For example, if no automation is preconfigured for Veronica, computer system 1300 does not cause performance of an automation based on Veronica being authenticated after entering environment 1302.

An amount of time elapses between FIGS. 13D and 13E. FIG. 13E illustrates individual 1318 (e.g., hereinafter referred to as Alva) outside of environment 1302. Computer system 1300 has previously registered a second automation and a third automation with Alva. The second automation requires a single factor authentication of Alva to be performed and the third automation requires a two-factor authentication of Alva to be performed. In some embodiments, a personal device (e.g., smartphone, smartwatch, and/or tablet) of Alva is registered with computer system 1300 and/or environment 1302. In some embodiments, Alva and/or the personal device of Alva is registered with computer system 1300 and/or one or more computer systems (e.g. lights 1304, speaker 1322, speaker 1338, television 1340 and/or lock 1330) within environment 1302.

At FIG. 13F, Alva is detected as entering environment 1302. In some embodiments, computer system 1300 detects Alva as entering environment 1302. For example, one or more cameras of computer system 1300 detect that Alva is positioned within environment 1302. In some embodiments, one or more cameras and/or one or more microphones external to computer system 1300 detect that Alva enters environment 1302. In such embodiments, computer system 1300 receives an indication that Alva enters environment 1302. In some embodiments, computer system 1300 detects that Alva is within environment 1302 in response to receiving a signal from the personal device of Alva.

At FIG. 13F, Alva is identified. In some embodiments, Alva is identified via an image of Alva. For example, Alva is be identified using an image that is captured by one or more cameras of computer system 1300. For another example, Alva is be identified using an image that is captured by one or more cameras that are external to computer system 1300. In some embodiments, Alva is identified via a signal that is received by computer system 1300 from the personal device of Alva. For example, Alva is identified in response to computer system 1300 (e.g., or a different computer system) receiving a signal from a smartphone of Alva. In some embodiments, a computer other than computer system 1300 identifies Alva. In such embodiments, computer system 1300 receives an indication of the identity of Alva.

At FIG. 13F, a determination is made that Alva satisfies the single factor authentication requirement of the second automation. Based on the determination that Alva satisfies the single factor authentication requirement of the second automation, computer system 1300 causes performance of the second automation that is registered with Alva. More specifically, as indicated by the presence of music note 1344, computer system 1300 causes television 1340 to output media (e.g., a television show, a movie, and/or a song) and powers on lights 1304 (e.g., as indicated by the lack of hatching within lights 1304). At FIG. 13F, computer system 1300 does not cause the performance of the third automation that is registered with Alva because the performance of the third automation requires a two-factor authentication. In some embodiments, computer system 1300 causes television 1340 to output the media and powers on lights 1304 in a serial manner. For example, computer system 1300 first causes television 1340 to output the media and then powers on lights 1304. In some embodiments, computer system 1300 causes television 1340 to output the media and powers on lights 1304 at the same time. In some embodiments, the second automation includes additional operations. For example, the second automation includes speaker 1322 outputting media that corresponds to a television show that is being output by television 1340.

The contrast of FIGS. 13D and 13F show that computer system 1300 causes the performance of different types of automations based on who is detected as entering environment 1302. More specifically, at FIG. 13D, computer system 1300 causes performance of the first automation (e.g., causes speaker 1322 to output media) based on Veronica being authenticated after entering environment 1302 and, at FIG. 13F, computer system 1300 causes performance of the second automation (e.g., causes television 1340 to output media and powers on lights 1304) based on Alva being authenticated after entering environment 1302. In some embodiments, computer system 1300 causes performance of the same automation irrespective of the identity of a subject who is detected as entering environment 1302. For example, computer system 1300 causes performance of the first automation when Alva or Veronica is authenticated after entering environment 1302.

At FIG. 13G, Alva approaches computer system 1300 and computer system 1300 authenticates Alva. Accordingly, at FIG. 13G, Alva has been authenticated via two different authentication processes. Accordingly, at FIG. 13G, Alva satisfies the two-factor authentication requirement of the third automation. In some embodiments, computer system 1300 authenticates Alva by capturing an image and/or video of Alva. In some embodiments, computer system 1300 authenticates Alva in response to receiving a signal from the personal device of Alva. In some embodiments, computer system 1300 authenticates Alva in response to detecting the entry of a passphrase that corresponds to Alva. For example, while computer system 1300 displays a number pad, computer system 1300 detects one or more inputs that correspond to the selection of one or more numbers that correspond to the passphrase of Alva. In some embodiments, Alva is identified via a first modality and Alva is authenticated via a second modality. For example, Alva is identified via an image and Alva is authenticated via a pass phrase. In some embodiments, Alva is authenticated by a computer system other than computer system 1300. For example, one of speaker 1322, speaker 1338, television 1340 and/or lock 1330 authenticates Alva. In some embodiments, Alva is detected within environment 1302 by a second modality and Alva is authenticated via a second modality. For example, computer system 1300 detects that Alva is within environment 1302 in response to receiving a signal from a personal device of Alva and Alva is authenticated via one or more cameras.

At FIG. 13G, Alva has the authentication level that is required for performance of the third automation. That is, when Alva is authenticated via a single authentication process (e.g., the status of Alva at FIG. 13F), Alva has a first authentication level and, when Alva is authenticated via two authentication processes (e.g., the status of Alva at FIG. 13G), Alva has a second authentication level that is greater than the first authentication level.

At FIG. 13G, a determination is made that Alva satisfies the two-factor authentication requirement of the third automation e.g., Alva has been authenticated by two authentication processes). Based on the determination that Alva satisfies the two-factor authentication requirement of the third automation, computer system 1300 causes performance of the third automation. More specifically, at FIG. 13G, computer system 1300 causes lock 1330 to unlock (e.g., as indicated by the appearance of lock 1330 at FIG. 13G). In some embodiments, computer system 1300 causes performance of an automation that secures or unsecures a portion of environment 1302 based on a determination that a subject who has the necessary authentication level (e.g., is authenticated via two or more authentication processes) is detected within environment 1302. In some embodiments, computer system 1300 causes performance of the third automation based on a determination that Alva is authenticated via two or more authentication processes after entering environment 1302. In some embodiments, computer system 1300 causes performance of the third automation based on a determination that Alva is authenticated via a single authentication process after entering environment 1302.

In some embodiments, computer system 1300 outputs content based on a state of an object that Alva is interacting with. For example, when it is determined that Alva is kneading dough as part of following a bread recipe, computer system 1300 can output content based on a state of the dough. More specifically, if the dough is too dry, computer system 1300 can visually and/or audibly output “dough is too dry add some water” or if the dough contains too much flour, computer system 1300 can output “dough has too much flour.” In some embodiments, when the object contains an error state, computer system 100 outputs a suggestion for remedying the error state. In some embodiments, computer system 1300 can output content based on a detection of Alva performing an activity within environment 1302 and based on a future projected state of Alva. For example, if Alva is detected as placing dishes into a dishwasher at night, computer system 1300 can output “Would you like for the dishes to be dry by the time you wake up tomorrow?” Based on a detection of an affirmative answer to this question, computer system 1300 can cause the dishwasher to wash the dishes at a time that will result in the dishes being clean and dry by the time Alva wakes up the next morning. In some embodiments, computer system 600 determines what time Alva wakes up based on historical data of Alva. In some embodiments, computer system 1300 determines what time Alva wakes up based on detecting an input from Alva.

Of note, at FIG. 13G, Alva is positioned within first portion 1302a of environment 1302 and lock is positioned within second portion 1302b of environment 1302. That is, at FIG. 13G, computer system 1300 causes performance of an automation that changes a state of a device in a portion of environment 1302 (e.g., second portion 1302b) that Alva is not detected within. At FIG. 13G, because lock 1330 is unlocked, second portion 1302b of environment 1302 can now be accessed.

In some embodiments, based on a determination that Alva enters second portion 1302b of environment 1302, computer system 1300 causes one or more devices within environment 1302 to adjust a temperature of second portion 1302b of environment 1302 in a first manner based on one or more preferences of Alva. For example, based on determinations that Alva enters second portion 1302b of environment 1302 and that Alva likes second portion 1302b of environment 1300 to be cold, computer system 1300 causes a fan within second portion 1302b of environment 1300 to operate at a high setting. In some embodiments, based on a determination that Alva enters first portion 1302a of environment 1302, computer system 1300 causes one or more devices to adjust a temperature of first portion 1302a of environment 1302 in a second manner different from the first manner based on the preferences of Alva. For example, based on determinations that Alva enters first portion 1302a of environment 1302 and that Alva likes first portion 1302b of environment 1300 to be hot, computer system 1300 causes a heater within first portion 1302a of environment 1300 to operate at a high setting. That is, computer system 600 can cause one or more devices to adjust a temperature of a portion of environment 1300 differently based on which part of environment 1302 Alva is detected within.

In some embodiments, based on a determination that Alva is authenticated via two or more authentication processes, computer system 1300 causes lock 1330 to lock (e.g. secure second portion 1302b of environment 1302). In some embodiments, computer system 1300 causes lock 1330 to lock after a predetermined period of time has elapsed since computer system 1300 caused lock 1330 to unlock. For example, based on a determination that thirty minutes have elapsed since computer system 1300 caused lock 13301 to unlock, computer system 1300 causes lock 1330 to lock. In some embodiments, computer system 1300 causes lock 1330 to lock based on a determination that Alva exits environment 1302. In some embodiments, computer system 1300 causes lock 1330 to lock based on a determination that an individual that is not authorized to access second portion 1302b of environment 1302 is within a predetermined distance of second portion 1302b of environment. For example, computer system 1300 causes lock 1330 to lock based on determinations that Greg and/or Veronica is not authorized to accessed second portion 1302b of environment 1302 and is within the predetermined distance of second portion 1302b.

FIG. 14 is a flow diagram illustrating a process (e.g., process 1400) for initiating an automation in accordance with some embodiments. Some operations in process 1400 are, optionally, combined, the orders of some operations are, optionally, changed, and some operations are, optionally, omitted.

As described below, process 1400 provides an intuitive way for initiating an automation in accordance with some embodiments. Process 1400 reduces the cognitive burden on a user, thereby creating a more efficient human-machine interface. For battery-operated computing devices, enabling a user to interact with such devices faster and more efficiently conserves power and increases the time between battery charges.

In some embodiments, process 1400 is performed at a computer system (e.g., 1300). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system detects (1402) a subject (e.g., 1312, 1324, and/or 1318) (e.g., a user, a person, an animal, another computer system different from the computer system, a device, and/or an object) in an environment (e.g., 1302) (e.g., a physical environment, such as a home, a room, a yard, and/or a building and/or a virtual environment). In some embodiments, the computer system receives an indication that a subject is in the environment. In some embodiments, the indication that the subject is in the environment is received from another computer system external to the computer system. In some embodiments, the computer system is in communication with one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the subject is detected via the one or more input devices.

In response to (1404) (or after or in conjunction with) detecting the subject in the environment, in accordance with a determination that a first set of one or more criteria is satisfied, wherein the first set of one or more criteria includes a criterion that is satisfied when the subject has been authenticated with respect to a user account using a first set of one or more authentication techniques, the computer system initiates (1406) an automation (e.g., as described above with respect to FIGS. 13D, 13F, and/or 13G) (e.g., operation and/or function). In some embodiments, the user account is registered with the computer system. In some embodiments, the user account corresponds to the subject. In some embodiments, information and/or data related to the user account is stored on the computer system and/or accessible by the computer system. In some embodiments, another computer system authenticates the subject. In some embodiments, the computer system authenticates the subject.

In response to (1404) detecting the subject in the environment, in accordance with a determination that a second set of one or more criteria is satisfied (and the first set of one or more criteria is not satisfied), wherein the second set of one or more criteria includes a criterion that is satisfied when the subject has been authenticated with respect to the user account using a second set of authentication techniques (e.g., zero or more authentication techniques), the computer system forgoes (1408) initiation of the automation (e.g., as described above with respect to FIGS. 13B and/or 13F), wherein the first set of one or more authentication techniques is different from the second set of one or more authentication techniques. In some embodiments, in response to detecting the subject in the environment and in accordance with the determination that the second set of one or more criteria is satisfied, the computer system initiates another automation different from the automation. In some embodiments, an authentication technique is included in the first set of one or more authentication techniques and the second set of authentication techniques. In some embodiments, no authentication technique is included in both the first set of one or more authentication techniques and the second set of authentication techniques. In some embodiments, the first set of one or more authentication techniques results in the subject having a higher authentication level than the second set of authentication techniques. In some embodiments, the first set of one or more authentication techniques includes more authentication techniques than the second set of authentication techniques. In some embodiments, the first set of one or more authentication techniques includes the same number of authentication techniques as the second set of authentication techniques. In some embodiments, the second set of authentication techniques includes one or more authentication techniques. Performing an operation when a set of conditions has been met without requiring further user input (such as by initiating an automation when a subject is authenticated using a set of one or more authentication techniques) enhances the operability of the device by reducing unnecessary inputs and/or steps to navigate through different user interfaces or sets of controls, reducing energy usage by the device. Providing additional control options without cluttering a user interface with additional displayed controls (such as by initiating an automation when a subject is authenticated using a set of one or more authentication techniques) enhances the operability of the device by reducing unnecessary inputs and/or steps to navigate through different user interfaces or sets of controls, reducing energy usage by the device. Performing an operation when a set of conditions has been met without requiring further user input (such as initiating an automation when a subject has a requisite authentication level) enhances the operability of the device by reducing unnecessary inputs and/or steps to navigate through different user interfaces or sets of controls, reducing energy usage by the device. Automatically locking data, devices, and/or processes (such as by causing one or more devices to secure one or more areas) improves privacy and security by limiting the restricting access to various areas.

In some embodiments, the automation is a first automation. In some embodiments, after initiating the first automation, the computer system receives an indication that the subject has been authenticated with respect to the user account using a third set of one or more authentication techniques, wherein the third set of one or more authentication techniques is different from the first set of one or more authentication techniques (e.g., as described above with respect to FIGS. 13F and 13G). In some embodiments, the third set of one or more authentication techniques includes more or less authentication techniques than the first set of one or more authentication techniques and/or the second set of authentication techniques. In some embodiments, the third set of one or more authentication techniques is the second set of authentication techniques. In some embodiments, the third set of one or more authentication techniques is different from the second set of authentication techniques. In some embodiments, in response to receiving the indication that the subject has been authenticated with respect to the user account using the third set of one or more authentication techniques, the computer system initiates a second automation different from the first automation (e.g., as described above with respect to FIG. 13G). In some embodiments, the second automation requires that the subject be authenticated using the third set of one or more authentication techniques and the first automation requires the subject to be authenticated using the first set of one or more authentication techniques. In some embodiments, the second automation involves a different set of one or more devices than the first automation. In some embodiments, the second automation includes the set of one or more devices included in the first automation.

In some embodiments, the computer system is a first computer system. In some embodiments, initiating the automation includes sending, to a second computer system, a request to change an accessory device (e.g., 1304, 1322, 1340, 1330, and/or 1338) to a first state. In some embodiments, the second computer system is different from the first computer system. In some embodiments, the second computer system is the accessory device. In some embodiments, the second computer system is separate from the accessory device. In some embodiments, the second computer system is a light source, a watch, a phone, a tablet, a fitness tracking device, a processor, a head-mounted display (HMD) device, an accessory device, a communal device, a media device, a speaker, a television, and/or a personal computing device. In some embodiments, the second computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

In some embodiments, the computer system is a first computer system. In some embodiments, the first set of one or more criteria includes a criterion that is satisfied when the automation includes changing a state of a security accessory device (e.g., as described above with respect to FIG. 13G) (e.g., a lock and/or a garage) (and/or a first type of accessory device). In some embodiments, the second set of one or more criteria includes a criterion that is satisfied when the automation does not include changing a state of a security accessory device (e.g., a lock and/or a garage) (and/or the automation includes changing a state of a non-security accessory device and/or a second type of accessory device different from the first type of accessory device).

In some embodiments, the subject is a first subject (e.g., 1318, 1312, and/or 1324). In some embodiments, the automation is a first automation. In some embodiments, the user account is a first user account. In some embodiments, after (e.g., or while or in conjunction with) initiating the first automation, the computer system detects a second subject (e.g., 1318, 1312, and/or 1324) (e.g., a user, a person, an animal, another computer system different from the computer system, a device, and/or an object) different from the first subject in the environment. In some embodiments, the second subject and the first subject are registered with the computer system. In some embodiments, in response to detecting the second subject in the environment and in accordance with a determination that the second subject has been authenticated with respect to a second user account using a fourth set of one or more authentication techniques, the computer system initiates a third automation (e.g., operation and/or function) different from the first automation (e.g., as described above with respect to FIGS. 13D, 13F, and/or 13G). In some embodiments, the fourth set of one or more authentication techniques is the first set of one or more authentication techniques and/or the second set of authentication techniques. In some embodiments, the fourth set of one or more authentication techniques is different from the first set of one or more authentication techniques and/or the second set of authentication techniques. In some embodiments, the third automation corresponds to the second subject and does not correspond to the first subject. In some embodiments, the first automation corresponds to the first subject and does not correspond to the second subject. In some embodiments, the first automation and/or the second automation does not correspond to a specific subject but instead corresponds to detecting any subject enter the environment. In some embodiments, the second user account is different from the first user account.

In some embodiments, the subject is a first subject (e.g., 1318, 1312, and/or 1324). In some embodiments, the automation is a first automation. In some embodiments, the user account is a first user account. In some embodiments, after (or while, or in conjunction with) initiating the first automation, the computer system detects a third subject (e.g., 1318, 1312, and/or 1324), different from the first subject, in the environment. In some embodiments, the computer system detects the first subject in a first manner and detects the third subject in a second manner different from the first manner. In some embodiments, in response to detecting the third subject in the environment and in accordance with a determination that the third subject has been authenticated with respect to a third user account using the first set of one or more authentication techniques, the computer system forgoes initiation of an automation (e.g., as described above with respect to FIGS. 13D and/or 13F) (e.g., any automation) (and/or the first automation). In some embodiments, the computer system is not configured to perform an automation in response to detecting the third subject in the environment. In some embodiments, the third subject is registered with the computer system. In some embodiments, the third subject is not registered with the computer system. In some embodiments, the third user account is different from the first user account. In some embodiments, the computer system causes initiation of a default automation in response to detecting the third subject and in accordance with the determination that the third subject has been authenticated with respect to the third user account.

In some embodiments, the computer system detects the subject in in the environment via a communication with a personal device (e.g., a phone, computer system, and/or tablet) corresponding to (e.g., owned by and/or of) the subject. In some embodiments, the subject is authenticated via one or more cameras (e.g., as described above with respect to FIGS. 13D and/or 13F) (e.g., a periscope camera, a telephoto camera, a wide-angle camera, and/or an ultra-wide-angle camera). In some embodiments, the one or more cameras are integrated within the computer system. In some embodiments, the one or more cameras are external to the computer system. In some embodiments, the personal device detects the subject is in the environment.

In some embodiments, the computer system is in communication (e.g., wired communication and/or wireless communication) with (and/or includes) one or more output devices (e.g., a display component, an audio component, and/or a haptic component). In some embodiments, after initiating the automation and in accordance with a determination that the automation is performed (e.g., being performed, has been performed, is being initiated, and/or has been initiated), the computer system outputs (e.g., audibly outputting and/or visually outputting), via the one or more output devices, an indication (e.g., a graphical indication and/or textual indication) that the automation has been performed (e.g., as described above with respect to FIGS. 13D and 13F). In some embodiments, the computer system outputs the indication that the automation has been performed in two or more different modalities. In some embodiments, in response to detecting the subject and in accordance with the determination that the first set of one or more criteria is satisfied, the computer system outputs an indication that the automation will be initiated. In some embodiments, the computer system continues output of the indication that the automation will be initiated until the automation has completed. In some embodiments, the computer system outputs the indication that the automation will be initiated a single time. In some embodiments, the computer system outputs the indication that the automation has been performed a single time. In some embodiments, the computer system outputs an indication that the automation is no longer being performed. In some embodiments, the computer system outputs an indication of a state of one or more devices once the automation has been performed.

In some embodiments, the automation is a first automation. In some embodiments, in response to detecting the subject in the environment and in accordance with the determination that the second set of one or more criteria is satisfied, the computer system initiates a third automation (e.g., a set of one or more operations and/or functions), wherein the third automation is different from the first automation (e.g., as described above with respect to FIGS. 13D and 13F). In some embodiments, the third automation is a default automation. In some embodiments, the third automation is based on an identity of the subject. In some embodiments, the computer system performs the third automation. In some embodiments, the computer system causes one or devices external to the computer system to perform the third automation. In some embodiments, the first automation and the third automation correspond to a common set of one or more devices. In some embodiments, the first automation and the third automation correspond to different devices. In some embodiments, in response to detecting the subject in the environment and in accordance with the determination that the second set of one or more criteria is satisfied, the computer system does not cause initiation of an automation (e.g., the first automation, the third automation, and/or any automation).

In some embodiments, in response to detecting the subject in the environment and in accordance with a determination that a third set of one or more criteria is satisfied, wherein the third set of one or more criteria includes a criterion that is satisfied when the subject is not authenticated with respect to a user account (e.g., the subject is not identified or authenticated or the subject is identified but not authenticated), the computer system forgoes initiation of an automation (e.g., as described above with respect to FIG. 13B) (e.g., the first automation, the fourth automation and/or any respective automation). In some embodiments, the third set of one or more criteria is different from the second set of one or more criteria and/or the first set of one or more criteria. In some embodiments, in response to detecting the subject and in accordance with the determination that the third set of one or more criteria is satisfied, the computer system performs the automation, a default automation, or another automation different from the automation. In some embodiments, the computer system or another computer system different from the computer system identifies the subject when the subject is not authenticated with respect to the user account.

In some embodiments, the automation is a respective automation. In some embodiments, in accordance with a determination that the subject is a first individual (e.g., 1312, 1324, and/or 1318), the respective automation is a fourth automation (e.g., a first set of one or more operations that are performed by a first set of one or more devices) (e.g., as described above with respect to FIGS. 13D and 13F). In some embodiments, in accordance with a determination that the subject is a second individual (e.g., 1312, 1324, and/or 1318), the respective automation is a fifth automation (e.g., a second set of one or more operations that are performed by the first set of one or more devices) that is different from the fourth automation (e.g., as described above with respect to FIGS. 13D and 13F) (e.g., the sixth automation involves different devices and/or operations). In some embodiments, the second individual is different from the first individual. In some embodiments, the fourth automation and the fifth automation are the same. In some embodiments, the fourth automation is preconfigured for the first individual and the fifth automation is preconfigured for the second individual. In some embodiments, the first individual and the second individual are registered with the computer system. In some embodiments, the first individual is registered with the computer system and the fourth automation is preconfigured for the first individual and the second individual is not registered with the computer system and the fifth automation is a default automation. In some embodiments, the same set of one or more devices performs the fourth automation and the fifth automation. In some embodiments, different sets of devices perform the fourth automation and the fifth automation.

In some embodiments, the computer system is in communication (e.g., wired communication and/or wireless communication) with (and/or includes) a first set of one or more devices (e.g., 1322, 1340, 1338, 1330, and/or 1304) (e.g., television, speaker, thermostat, blinds, radio, door, garage, tablet, and/or laptop) and a second set of one or more devices (e.g., 1322, 1340, 1338, 1330, and/or 1304) (e.g., television, speaker, thermostat, blinds, radio, door, garage, tablet, and/or laptop) different from the first set of one or more devices. In some embodiments, initiating the automation includes, causing the first set of one or more devices to perform a first set of one or more operations (e.g., power on lights, adjust a temperature setting of a thermostat, adjust a playback setting of one or more speakers, close a garage, and/or power on a television) (e.g., as described above with respect to FIGS. 13D, 13F and/or 13G). In some embodiments, initiating the automation includes, causing the second set of one or more device to perform a second set of one or more operations (e.g., as described above with respect to FIGS. 13D, 13F and/or 13G) (e.g., turn on lights, adjust a temperature setting of a thermostat, adjust a playback setting of one or more speakers, close a garage, and/or power on a television) different from the first set of one or more operations. In some embodiments, the first set of one or more operations and the second set of one or more operations are concurrently performed. In some embodiments, the first set of one or more operations and the second set of one or more operations are performed in a serial manner. In some embodiments, the first set of one or more operations includes a first operation included in the second set of one or more operations and does not include a second operation included in the second set of one or more operations. In some embodiments, the same set of one or more devices perform the first set of one or more operations and the second set of one or more operations. In some embodiments, the first set of one or more devices includes a first device included in the second set of one more devices and does not include a second device included in the second set of one or more devices or vice versa.

In some embodiments, the first set of one or more authentication techniques results in a greater level of authentication than the second set of authentication techniques (e.g., as described above with respect to FIG. 13G). In some embodiments, the first set of one or more authentication techniques includes more authentication techniques than the second set of authentication techniques. In some embodiments, the subject has a first authentication level when the subject is authenticated using the first set of one or more authentication techniques and the subject has a second authentication level that is less than the first authentication level when the subject is authenticated using the second set of authentication techniques.

In some embodiments, initiating the automation includes causing one or more devices (e.g., 1330) (e.g., a door, a smart lock, and/or a garage door) to secure (e.g. lock, prohibit access to, close a door, and/or block an entryway) one or more areas of one or more environments (e.g., as described above with respect to FIG. 13G) (e.g., a garage, a bedroom, a safe, kitchen, living room, and/or authorized area). In some embodiments, securing the one or more areas of the one or more environments includes locking one or more doors and/or closing one or more doors. In some embodiments, the one or more environments are positioned within a common environment. In some embodiments, initiating the automation includes causing the one or more devices to unsecure the one or more areas of the one or more environments. In some embodiments, prior to initiating the automation, the computer system requests a confirmation from the subject to secure or unsecure the one or more areas of the one or more environments.

In some embodiments, the subject is detected in a first portion (e.g., 1302A) (e.g., a living room, a bedroom, a basement, and/or a kitchen) of the environment (e.g., a home, a school, an office building, and/or an outdoor environment). In some embodiments, initiating the automation includes causing a set of one or more devices (e.g., 1330) to perform a set of one or more operations in a second portion (e.g., 1302B) (e.g., a living room, a bedroom, a basement, and/or a kitchen) of the environment (and not the first portion of the environment) different from the first portion of the environment. In some embodiments, initiating the automation includes causing the one or more devices to perform the one or more operations in the first portion and the second portion of the environment. In some embodiments, the second portion of the environment is based on a detected context (e.g., a context of the environment, a current time, a current temperature, a location of the subject, and/or a who is detected in the environment). In some embodiments, initiating the automation includes causing one or more devices to perform the one or more operations in the first portion of the environment and not the second portion of the environment.

In some embodiments, the automation is a first automation. In some embodiments, the first set of one or more criteria includes a criterion that is satisfied when a set of one or more devices (e.g., a garage door, one or more locks, one or more televisions, one or more speakers one or more lights mechanical equipment, and/or electrical equipment) satisfy a fourth set of one or more criteria (e.g., the set of one or more devices are in a first state, the set of one or more devices are in a state that occurs as a result of the first automation, a garage door is opened, a garage door is closed, one or more locks are in a locked state, one or more locks are in an unlocked state, one or more televisions are powered on, one or more televisions are powered off, one or more lights are powered on, one or more lights are powered off, one or more speakers are powered on and/or one or more speakers are powered). In some embodiments, the set of one or more devices are external to the computer system. In some embodiments, the first automation corresponds to (e.g., directed to, at a location of, related to, and/or associated with) and/or affects the set of one or more devices. In some embodiments, in response to detecting the subject in the environment and in accordance with a determination that the set of one or more devices do not satisfy the fourth set of one or more criteria, the computer system forgoes initiation of the first automation (e.g., as described above with respect to FIGS. 13D and 13F). In some embodiments, in response to detecting the subject in the environment and in accordance with the determination that second set of one or more criteria is satisfied and the set of one or more devices satisfy the fourth set of one or more criteria, the computer system initiates the first automation. In some embodiments, in response to detecting the subject in the environment and in accordance with a determination that the second set of one or more criteria is satisfied and the set of one or more devices do not satisfy the fourth set of one or more criteria, the computer system does not initiate the first automation. In some embodiments, after forgoing initiating the first automation and in accordance with a determination that the one or more devices satisfies the fourth set of one or more criteria, the computer system initiates the first automation.

In some embodiments, the fourth set of one or more criteria includes a criterion that is satisfied when the set of one or more devices has a first state (e.g., as described above with respect to FIGS. 13D and 13F) (e.g., a garage is opened or closed, a door is locked or unlocked, a door is opened or closed, and/or a television is powered on or powered off). In some embodiments, the fourth set of one or more criteria includes a criterion that is not satisfied when the set of one or more devices has a second state different from the first state.

In some embodiments, the subject is a first subject (e.g., 1318, 1324, and/or 1312). In some embodiments, after (and/or in conjunction and/or as part of) initiating the automation (e.g., and in accordance with a determination that the automation has been performed, is being performed, is being initiated, and/or has been initiated), the computer system causes a personal computer system (e.g., smart phone, smart watch, laptop, and/or tablet) of a second subject registered with the computer system (and/or the environment) to display an indication (e.g., textual indication and/or graphical indication) of reasoning for performing the automation (e.g., as described above with respect to FIG. 13D). In some embodiments, the computer system causes the personal computer system to display the indication for a duration of performance of the automation. In some embodiments, the computer system causes the personal computer system to display the indication for a predetermined period of time. In some embodiments, the personal computer system corresponds to a resident of the environment. In some embodiments, the second subject is the first subject. In some embodiments, the second subject is different from the first subject.

In some embodiments, the indication includes a description (e.g., a textual description and/or a graphical description) of one or more operations (e.g., adjusting a thermostat, powering on a device, locking a door, and/or adjusting a brightness of one or more lights) included in (and/or performed by or as a result of) the automation (e.g., as described above with respect to FIG. 13D). In some embodiments, the computer system causes the personal computer system to display the description of the one or more operations concurrently with an identity of the first subject.

In some embodiments, the indication includes a representation (e.g., a graphical representation and/or textual representation) of a time at which the automation is performed (e.g., as described above with respect to FIG. 13D) (e.g., initiated or completed). In some embodiments, the indication includes a representation of a time at which the automation will finish. In some embodiments, the indication includes a representation of a duration of the automation. In some embodiments, the computer system causes the personal computer system to display the description of the one or more operations concurrently with the representation of the time which the automation is initiated.

Note that details of the processes described above with respect to process 1400 (e.g., FIG. 14) are also applicable in an analogous manner to the processes described herein. For example, process 1400 optionally includes one or more of the characteristics of the various processes described herein with reference to process 1400. For example, the explanation of an automation of process 1100 can be output as part of initiating the automation of process 1400. For brevity, these details are not repeated herein.

In order to provide clarification, the aforementioned description has been explained using particular embodiments and examples. At least some of these particular embodiments and examples can be found in the accompanying figures. However, such embodiments and examples should not be construed as restricting the disclosure or as exhaustive unless explicitly indicated otherwise. Without going beyond this description, a person of ordinary skill in the art can make changes and/or alterations in light of the aforementioned description.

In some embodiments, one or more computer systems automatically produce content in response to a request for it. The content can be produced either off-device (e.g., by one or more nearby computer systems (such as accessible via a local network) and/or by one or more remote computers accessible (such as accessible via the internet)) or on-device (e.g., by a computer system at which the request is received). Text, audio, and/or visual elements (such as pictures, graphics, and/or video) are optionally included in the content.

In some embodiments, generative content refers to content generated by one or more artificial intelligence (AI) techniques (e.g., generative images, generative graphics, generative video, generative audio, and/or generative text). In such embodiment, an AI technique can generate the content in response to a stimulus that is given to it. In some embodiments, the AI technique incorporates one or more pre-processing techniques (e.g., adjustment to a user-provided prompt, development of a system-generated prompt, and/or AI model selection) before generating the content. In some embodiments, the AI technique incorporates one or more post-processing steps (e.g., passing the content to another AI technique, upscaling, downscaling, cropping, formatting, and/or adding or removing metadata) before the content is used for other purposes, such as being sent to another software process for additional processing or being presented to a user (e.g., visually or audibly).

One or more words (such as a spoken or written natural language prompt), one or more drawings, one or more images, and/or one or more videos can be included in a prompt for generating content. Examples of AI techniques include neural networks, transformer-based deep neural networks, large language models (LLMs), and generative pre-trained transformer models.

Although generative material is typically based on a prompt, it is created using the prompt as a starting point rather than being deterministically chosen from pre-generated content. In some embodiments, the prompt includes pre-existing content (such as text, audio, and/or visual content). For example, a prompt can ask for a block of text to be redone or summarized in a different tone. The result can be generative text that has been rewritten or summarized in the different tone. Similar to this, a prompt can ask for changes to visual content in order to include or exclude content that is specified by the prompt (e.g., deleting a feature that has been identified in visual content, adding a feature that is described in a prompt, altering a style of visual content, and/or producing additional visual elements that are based on visual content but are not located in the visual content). In some embodiments, the prompt includes or is used with a random or pseudo-random seed (e.g., content is generated using the random or pseudo-random seed as a starting point). For example, in order to create an image based on a diffusion model, a random noise pattern can be iteratively denoised on a basis of the prompt. Although this description has discussed particular kinds of AI techniques, it should be acknowledged that content can be generated by a wide range of AI techniques.

When gathering user data, organizations that share, collect, and/or use it should be transparent and/or have consent from users. Publicly accessible data can be used in certain techniques instead of in addition to user data. Data can be anonymized, aggregated, and/or processed in other ways to eliminate or restrict any individual identification in order to preserve user privacy. Entities that gather, distribute, and/or use such data in any way should have user consent before doing so and/or be transparent about the data collection process. Moreover, organizations in charge of user data, including but not restricted to data used in connection with AI techniques should make an effort to adhere to established privacy policies and/or privacy practices. When it comes to creating and/or training AI/ML systems, these organizations can adopt and continuously adhere to rules and procedures that are acknowledged as reaching or surpassing industry standards and legal requirements. While doing this, efforts should be made to guarantee that all privacy concerns and intellectual property rights are upheld. Practices for protecting training data, including private information, from abuse or exploitation should be incorporated into training. All phases of the creation, training, and application of AI/ML systems, including data collection, data preparation, model training, model evaluation, model deployment, and continuing monitoring and maintenance, should be covered by such policies and procedures. Accountability and transparency ought to be upheld at all times. Users should have easy access to such policies, which should be updated in response to changes in data collection and/or use. User information must be gathered for the entity's reasonable and lawful purposes and not shared or sold for purposes other than those purposes. Furthermore, any gathering and sharing must to be transparent with users and/or only after obtaining their informed consent. Such organizations should also think about taking any necessary actions to protect and secure access to such data and make sure that those who have access to it follow their privacy policies and procedures. Additionally, such organizations ought to submit to third-party assessment in order to attest, if necessary for transparency, that they follow generally recognized privacy policies and procedures. Policies and/or practices should also be customized to a specific use case, applicable laws and standards, jurisdiction-specific factors, and the precise type of data being collected and/or accessed.

In some embodiments, AI/ML systems might make use of models that have been trained (for example, through supervised or unsupervised learning) utilizing a variety of training data, including information gathered from a user device. Such utilization of user-gathered data can be restricted to tasks performed on the user's device. For instance, a model can be trained locally on the user's device, preventing any data from being transferred to a different device. For another example, a model can be trained on one or more devices (e.g., a server) in addition to the user device, but this can be done in a way that protects privacy, like multi-party computation, which can be done cryptographically by secret sharing data or in another way that prevents user data from leaking to the other devices.

In certain implementations, such as federated learning, a model can be kept on several devices or centrally on the user's device. Such decentralized storage can also be accomplished in a way that protects privacy, for example, by using cryptographic procedures that split each piece of data into shards that prevent the data from being reassembled or used by the user device alone or only in conjunction with another device or devices. In this way, a model can be trained and run using additional computational power of other devices, without exposing a user or device activity pattern. As a result, user-gathered data can be safeguarded. In certain implementations, a model can be trained by combining input from several devices in a way that protects privacy.

In some embodiments, the current disclosure assumes that information utilized by AI/ML systems can be kept completely distinct from platforms on which the AI/ML systems are installed, used to communicate with users, or used to process data. In these implementations, data used to train the AI/ML systems offline can be kept in restricted-access, secured datastores, and/or kept for no longer than is required for training. In certain implementations, the AI/ML systems can temporarily store data in a local memory cache while a user is interacting with them. The AI/ML systems'performance can be enhanced by using the local memory cache. However, after the user session is over, data kept in the local memory cache can be deleted to preserve user privacy. After processing, any temporary data caches utilized for online learning or inference can be quickly deleted. Secure communication and/or industry-standard encryption should be used for all data collection, transfer, and/or storage.

As previously mentioned, in some embodiments, methods like homomorphic encryption, secure hardware components, federated learning, differential privacy, and/or multi-party computation can be used to further protect personal data while the AI/ML systems are being trained and/or used. Changes in the underlying data distribution, such as idea drift or data skew, should be watched for in AI/ML systems as they can eventually impair their performance. In some embodiments, both online and offline training are used to train the AI/ML systems. While online training enables AI/ML systems to continuously adapt and/or improve, offline training can use carefully selected datasets to set baseline model performance. The current disclosure acknowledges how crucial it is to uphold stringent data governance procedures during this procedure in order to guarantee user privacy. In some embodiments, the AI/ML systems might be built with protections to ensure that they stay true to their initial goals even as they change in response to fresh data. Any significant adjustments to the way an AI/ML system collects and/or uses data can (and in certain situations should) be openly shared with the relevant parties. This can involve getting user consent for any changes to the way user data is gathered and/or used.

The current disclosure additionally considers examples where users can block or selectively restrict access to and/or use of data. In other words, the current disclosure assumes that components of software and/or hardware can be offered to restrict or stop data access. For certain services, for instance, the current technology should be set up to provide customers the option to “opt in” or “opt out” of taking part in data collecting at the time of service registration or at any point subsequently. As an additional illustration, current technology ought to be set up to let users choose not to supply specific data for AI/ML system training or for usage as input when the systems are in the inference stage. Another example is that current technology should be set up to give customers the option to restrict how long their data is kept or to completely forbid AI/ML systems from using their data. The current disclosure involves sending alerts regarding the access or use of personal information in addition to offering “opt in” and “opt out” options. A user can be reminded when the AI/ML systems produce outputs or make judgments based on their data, for example, or they can receive notifications when their data is being entered into the systems for training or inference.

The current disclosure acknowledges that, even when AI/ML systems are developed, constructed, and/or operated in accordance with industry best practices and standards, they should have clear limitations and/or oversight to reduce potential hazards. For instance, outputs that might be deemed inaccurate, damaging, offensive, and/or biased might be generated; these outputs might not accurately represent the views or stances of the organizations creating or implementing these systems. Additionally, in certain situations, mentions of third-party goods and/or services in the outputs should not be interpreted as affiliations or endorsements by the companies who supply the AI/ML systems. Human oversight and/or the capacity to override or fix incorrect or undesirable outputs can be maintained as a failsafe, and generated content can be checked for potentially unsuitable or dangerous material before being shown to users.

The current disclosure also takes into consideration that users of the AI/ML systems should not use the services in any way that violates, infringes upon, or misappropriates the rights of any other party. Additionally, the AI/ML systems should not be utilized for any illegal or unlawful conduct, nor should they be used to create any use cases or applications that would commit or assist in the commission of any criminal, tortious, or illegal act. The AI/ML systems must properly attribute content as needed and not infringe upon, violate, or misappropriate any copyrights, trademarks, rights of privacy and publicity, trade secrets, patents, or other property or legal rights of any party. Furthermore, no security, digital signing, digital rights management, content protection, verification, or authentication process should be hampered by AI/ML systems. Machine-generated outputs should not be mistakenly represented as human-generated by AI/ML systems.

Using and/or collecting data from several sources is one aspect of the technology mentioned above. Such information can be utilized to enhance a device's interactions with its surroundings, such as those with users. Personal information that can be used to uniquely identify an individual can be included in such data in certain situations. Demographic information, phone numbers, email addresses, location and/or location-related information, home, and work addresses, and/or any other identifying information can all be considered personal information. Users of the device can benefit from the use of such personal information. For instance, a user's personal data can be utilized to enhance the device's communication with the user. Within the parameters of the current disclosure, additional advantages can potentially arise from the usage of personal data.

One or more entities can need to handle personal data in order for it to be used. These organizations can be engaged in gathering, processing, revealing, moving, storing, or performing other tasks that facilitate the technologies covered here. Although it does not prevent it, the current disclosure assumes that all uses of personal identifiable data adhere to existing privacy rules and/or procedures of such entities. Generally speaking, such policies and practices must adhere to all relevant legislative regulations pertaining to data privacy and security, as well as reach or beyond widely accepted industry standards. For instance, businesses should obtain users' informed consent before collecting and using personal data, and they should only do so for appropriate and justifiable purposes. Furthermore, a user's personal information should never be sold, transferred, divulged, or used for purposes other than those that are reasonable and/or lawful.

There are a number of situations where personal data is unavailable, such as when a user decides not to disclose it. The user can, for instance, “opt out” of sharing such data or not specifically “opt in” during the registration process to refuse consent for the gathering and/or use of such data. Any number of other hardware and/or software components that prohibit the gathering and/or use of such data can also be used by the user. The current disclosure considers that implementations of the current technology can be used without such data, even though the usage of personal information can benefit a user by improving the device's performance. For instance, the device's functions can make use of non-personal data (for instance, in lieu of or in addition to personal data). Other methods involve drawing conclusions from data that does not contain personal information or from a small amount of personal information.

What is claimed is:

1. A method, comprising:
at a computer system that is in communication with one or more output devices:
receiving an indication that a set of one or more operations is performed based on a subject entering an environment; and
in response to receiving the indication that the set of one or more operations is performed based on the subject entering the environment:
in accordance with a determination that a first set of one or more criteria is satisfied, outputting, via the one or more output devices, an indication that includes a first explanation regarding performance of the set of one or more operations; and
in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

2. The method of claim 1, wherein the indication that includes the first explanation further includes an identification of the subject.

3. The method of claim 1, wherein the computer system is in communication with one or more display components, and wherein outputting the indication that includes the first explanation includes displaying, via the one or more display components, the indication that includes the first explanation, the method further comprising:
in response to receiving the indication that the set of one or more operations is performed based on the subject entering the environment, displaying, via the one or more display components, one or more indications of one or more activities performed in the environment.

4. The method of claim 3, wherein the one or more activities are determined to be performed by the subject.

5. The method of claim 3, wherein at least one activity of the one or more activities is determined to be performed by another subject different from the subject.

6. The method of claim 1, wherein the indication that includes the first explanation includes an icon corresponding to one or more accessories that performed the set of one or more operations.

7. The method of claim 1, wherein the computer system is in communication with one or more display components and one or more input devices, the method further comprising:
after outputting the indication that includes the first explanation, detecting, via the one or more input devices, an input corresponding to a request to view activity detected in the environment; and
in response to detecting the input corresponding to the request to view activity detected in the environment, displaying, via the one or more display components, the indication that includes the first explanation.

8. The method of claim 1, wherein outputting the indication includes outputting an identification of the subject.

9. The method of claim 1, wherein the computer system is in communication with one or more display components, and wherein outputting the indication includes displaying, via the one or more display components, the indication, the method further comprising:
while displaying the indication, displaying, via the one or more display components, one or more indications of one or more activities performed in the environment.

10. The method of claim 9, wherein the one or more activities are performed by the subject.

11. The method of claim 9, wherein at least one activity of the one or more activities is performed by another subject different from the subject.

12. The method of claim 1, wherein the indication includes an icon corresponding to one or more accessories that performed the set of one or more operations.

13. A non-transitory computer-readable storage medium storing one or more programs configured to be executed by one or more processors of a computer system that is in communication with one or more output devices, the one or more programs including instructions for:
receiving an indication that a set of one or more operations is performed based on a subject entering an environment; and
in response to receiving the indication that the set of one or more operations is performed based on the subject entering the environment:
in accordance with a determination that a first set of one or more criteria is satisfied, outputting, via the one or more output devices, an indication that includes a first explanation regarding performance of the set of one or more operations; and
in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.

14. A computer system configured to communicate with one or more output devices, the computer system comprising:
one or more processors; and
memory storing one or more programs configured to be executed by the one or more processors, the one or more programs including instructions for:
receiving an indication that a set of one or more operations is performed based on a subject entering an environment; and
in response to receiving the indication that the set of one or more operations is performed based on the subject entering the environment:
in accordance with a determination that a first set of one or more criteria is satisfied, outputting, via the one or more output devices, an indication that includes a first explanation regarding performance of the set of one or more operations; and
in accordance with a determination that a second set of one or more criteria is satisfied, outputting, via the one or more output devices, the indication that includes a second explanation regarding performance of the set of one or more operations, wherein the second explanation is different from the first explanation, and wherein the first set of one or more criteria is different from the second set of one or more criteria.
